(19) United States
(12) Patent Application Publication
(10) Pub. No.: US 2022/0306836 A1
(43) Pub. Date: Sep. 29, 2022

(54) PHOTOPERIODIC CONTROL OF PHYTOCHROME WITH MATERIALS

(71) Applicant: Lleaf Pty Ltd, Strathfield, New South Wales (AU)

(72) Inventor: Alexander FALBER, Strathfield, New South Wales (AU)

(21) Appl. No.: 17/431,076

(22) PCT Filed: Feb. 14, 2020
(86) PCT No.: PCT/AU2020/050124

§ 371 Date: Aug. 13, 2021

(30) Foreign Application Priority Data
Feb. 14, 2019 (AU) 2019900467

(51) Int. Cl. C08K 5/3437; A01G 7/04; C08J 5/18; C08K 5/00; C09B 5/62; C09K 11/06; F21V 9/45; G02B 5/30; H05B 33/14

(52) U.S. Cl. CPC C08K 5/3437; A01G 7/045; C08J 5/18; C08K 5/0041; C09B 5/62; C09K 11/06; F21V 9/45; G02B 5/30; H05B 33/14; C09K 2211/1014; C09K 2211/1022

(57) ABSTRACT

Disclosed herein are articles and devices, such as photo-selective films, which may be used to influence the growth of photosynthetic organisms. These article and devices may comprise one or more compounds of Formula (I) and/or Formula (II), along with one or more optional auxiliary dyes. Methods of controlling the growth of plants and for the manufacture of said articles and devices are also disclosed herein.

### CROSS-REFERENCE TO RELATED APPLICATIONS

The present application claims priority from Australian Provisional Patent Application No 2019900467 filed on 14 Feb. 2019, the contents of which are incorporated herein by reference in their entirety.

### TECHNICAL FIELD

The field of the invention relates to articles or devices such as photo-selective films for influencing the growth of plants or other photosynthetic organisms. Methods of controlling growth of plants and of manufacturing said articles are also disclosed herein.

### BACKGROUND

Photoperiodism is the reaction of plants to the length of day and certain types of wavelengths of light such red and far-red. Photoperiodism controls when plants switch from vegetative growth to flowering and/or fruiting and other growth patterns.

The phytochrome protein is a massive molecule (120 kilodaltons) attached to a bilin chromophore called phytochromobilin. This molecule has two different rotational isomers (FIG. 1, FIG. 2, FIG. 3), each with a different absorbance spectrum. The two forms interconvert freely especially when both red and far red light, as found in full sunlight, are available. In the shade, far red light dominates, causing the phytochromobilin to rapidly revert to the Pr form. In the dark (or shade), the chromophore slowly relaxes to the Pr form. The amount of time the chromophore is in each state will trigger the plant to display either the long or short day photoperiodic effect.

In the past, there have been some accounts of using luminescent sheeting to improve the overall growth rate and yield of plants and algae. These materials absorb lesser used wavelengths of light, i.e., green and yellow and convert them, by luminescence (fluorescence or phosphorescence) into certain longer wavelengths that promote growth, i.e., orange and red. This effectively targets the absorbance bands of chlorophyll and other pigments responsible for photosynthesis.

The prior art may disclose some films that contain a dye or pigment that absorbs a particular region of the solar spectrum and is, in some cases, are luminescent. The effect on plants is accomplished by the film altering the solar spectrum.

With regards to prior art that may deal with photo-selective (PSL) films describing both photosynthetic and photoperiodic effects, the selected dyes used in these studies are generally designed for photosynthetic effect. In almost all cases the lumiphore emits in the red near 615 nm to maximise emission near the absorbance bands of chlorophyll. Only a minor portion of the fluorescence is near 660 nm where phytochrome P660 strongly absorbs.¹⁻³

Arguably, the prior art does not maximise the fluorescence output of the photo-selective luminescent materials in terms of quantum yield for 660 nm phytochrome stimulation. The prior art may include examples of low quantum yield luminescent sheets in terms of the amount of light absorbed by the material compared to the amount of light that reaches the plants near 660 nm. The low quantum yields in the prior art may be due to one or a combination of the following:
Low quantum yield (QY) lumiphores are used such as phosphors are used that also have limited absorbance relying mainly on ultraviolet radiation.
The films are a flat sheet where there is no effective means of decoupling the fluorescence from the sheet towards the plants. Instead, the light is trapped by Total Internal Reflection (TIR) (see waveguides).
The luminescence is targeted towards chlorophyll absorbance (610-650 nm), rather than phytochrome to absorb from 660 nm-730 nm.

### SUMMARY

The present disclosure relates to an article or device, such as a polymer film dispersed with one or more dyes, such as a luminescent material, which acts to emit light frequencies that are detected by phytochrome and other proteins in organisms that control photoperiodism.

In a first aspect, disclosed herein is an article comprising at least one dye which targets at least one phytochrome in a plant.

In a second aspect is an article comprising; at least one dye of Formula (I) as defined herein; at least one dye of Formula (II) as defined herein; or a mixture thereof, optionally for targeting at least one phytochrome in a plant.

In a third aspect, disclosed herein is an array for enhancing plant growth, the array comprising one or more articles according to the first or second aspect.

In a fourth aspect, disclosed herein is a device comprising one or more articles according to the first or second aspect.

In a fifth aspect, disclosed herein is a greenhouse comprising one or more of the articles according to the first or second aspect, an array according to the third aspect, or a device according to the fourth aspect.

In a sixth aspect, disclosed herein is the use of one or more of the articles according to the first or second aspect, an array according to the third aspect, a device according to the fourth aspect, or a greenhouse according to the fifth aspect, for targeting phytochrome in one or more plants.

In a seventh aspect, disclosed herein is a method for enhancing plant growth, the method comprising a step of exposing one or more plants to light emitted from an article according to the first or second aspect, an array according to the third aspect, a device according to the fourth aspect, or by placing the one or more plants in a greenhouse according to the fifth aspect.

In an eighth aspect, disclosed herein is an article or device for delivering filtered light in a predetermined direction, the device comprising:
(a) a body comprising a sheet and a set of light directors coupled to the sheet, wherein each light director extends away from the sheet, wherein:
   (i) the body is transparent to transmit light there through and configured to filter a predetermined range of frequencies from the transmitted light;
   (ii) the set of light directors is configured to receive light and deliver a majority of the filtered light from the received light in the predetermined direction; and
   (iii) the predetermined direction is normal to a side of the sheet; and
(b) at least one dye which targets at least one phytochrome in a plant and/or at least one dye of Formula (I) as defined herein and/or at least one dye of Formula (II) as defined herein.

In a ninth aspect, disclosed herein is an article or device for filtering light and delivering the filtered light, the device comprising:
(a) a set of projecting portions and a sheet portion connecting the set of projecting portions, wherein:
   (i) the set of projecting portions and the sheet portion are transparent and comprise a dye to filter light travelling through the projecting portions;
   (ii) the sheet portion is configured to receive ambient incident light and deliver filtered light to the set of projecting portions; and
   (iii) each of the set of projecting portions comprise an angular offset with respect to the sheet portion to deliver a majority of the filtered light from the set of projecting portions in a predetermined direction; and
(b) at least one dye which targets at least one phytochrome in a plant and/or at least one dye of Formula (I) as defined herein and/or at least one dye of Formula (II) as defined herein.

In a tenth aspect, disclosed herein is a system comprising a plurality of articles and/or devices as disclosed herein.

Herein the term ‘phytochrome’ signifies the pigment system of photomorphogenesis. The system is arguably common to all potentially green plants, including algae, mosses and ferns. Phytochrome is composed of a complex chromoprotein present in the cytoplasm and has two interconvertible forms, phytochrome 660 (P660) with an absorption maximum in the red at 660 nm and phytochrome 730 (P730) with an absorption maximum in the far-red at 730 nm. P660 is converted by exposure to red light into P730. Conversely, P730 can be reconverted into P660 by exposure to far-red light.

Disclosed herein is an article or device which comprise at least one dye, for example at least one luminescent dye, for stimulating at least one phytochrome in a plant. Disclosed herein are articles, such as sheets, fabrics or films, which may employ one or more dyes. For example the article or device may comprise a dye that, when dispersed in a film or sheet of transmissive resin (for example polycarbonate), emits fluorescence having spectral maxima approximately centred at about 660 nm or about 730 nm, for example a spectral maxima in a range of about 640 nm to about 680 nm, or in a range of about 710 nm to about 750 nm. The purpose being to target phytochrome in plants. In this way, the photoperiodic effect may be maximised as it is prioritised over other growth considerations, unlike the prior art where it is arguably a secondary, or completely unintended, consideration.

A summary of the effects of red light and far-red light are shown in Table 1.

TABLE 1
Summary of effects on plants

| Red light effect | Far-red light effect |
|---|---|
| P₆₆₀ → P₇₃₀ | P₇₃₀ → P₆₆₀ |
| Stimulate germination of some | Inhibit germination of some |
| seeds, e.g. lettuce | seeds, e.g. lettuce |
| Induces formation of anthocyanins | Inhibits formation of anthocyanins |
| Stimulate flowering in long-day | Inhibits flowering in long-day |
| plants | plants |
| Inhibits flowering in short-day | Stimulates flowering in short-day |
| plants | plants |
| Elongation of internode is inhibited | Elongation of internode is promoted |
| Induces increase in leaf area | Prevents increase in leaf area. |
| Causes epicotyl hook to unbend | Maintains epicotyl hook bend |

In one embodiment the one or more dyes used in an article or device disclosed herein are high QY (70%-100%). In another embodiment one or more dyes are utilised which have a fluorescence that targets P660. In another embodiment one or more dyes are utilised which have a fluorescence that targets P730.

The use of a luminescent film with a dye that emits strongly near 730 nm is not encouraged in the art. The prior art states the concept of photoperiodic effects of various films is introduced but does not produce a luminescent sheet that is well designed for this application. In fact, the prior art is full examples of sheeting with additives that block light near 730 nm in order to reduce the shading effect of upper growth over lower growth.⁵⁻⁶

The current disclosure is directed to the use of one or more materials, for example dyes or other luminescent materials, for targeting phytochromes whose absorbance bands may or may not coincide with photosynthetic pigments, such as chlorophyll. For example, the red absorbing phytochrome P660, so named for its absorbance band at 660 nm, is somewhat red shifted to the major absorbance band of chlorophyll. The alternate form of P660 is P730 where the same chromophore exists in a different conformational state causing the absorbance maxima to shift to 730 nm, well beyond the absorbance bands of chlorophyll.

In cases where a dye or pigment, contained within an article or device defined herein, is luminescent, the luminescence generated adds to the overall effect of the article or device. In these cases, the effect on one or more plants is influenced by long wavelength light produced by the dye or pigment in addition to blocking shorter wavelengths.

The dyes disclosed herein may be fluorescent, phosphorescent, and/or electroluminescent. Combinations of fluorescent, phosphorescent and/or electroluminescent dyes may be used. The dyes may be coated on an article or device described herein and/or may be disposed in or contained in said article or device.

In most luminescent greenhouse films, red light is produced by the lumiphore. This is because plants are most positively affected by blue and red light for overall growth and for triggering light receptors. Blue is very difficult to produce with luminescence because UV light would have to be used as the light source. Sunlight generally has very little UV compared to the visible spectrum, and the media (glass or plastic) where the lumiphore is dispersed strongly absorbs UV. Hence luminescent greenhouse films are mostly used to produce red light by absorbing any one or a combination of shorter wavelengths.

The PSL films can either influence light absorption by targeting chlorophyll to enhance photosynthesis directly for generally more abundant growth or it can influence a light receptor in plants which controls specific growth patterns in the plant.

Disclosed herein is a dye or an article or device comprising a dye that absorbs near 660 nm and emits near 685 nm, for example in dilute solutions. When one or more of the dyes are dispersed at a certain concentration in an article or device, such as a sheet, re-absorption effects within the article or device (for example a sheet) can effectively red shift the fluorescence output to 730 nm as a great far red light source for stimulating P730. In some cases, the tail end of the absorbance and the beginning of the fluorescence spectra overlap somewhat. In a diluter solution this can make no difference. But in a thin sheet, the overlap can have a large effect where the fluorescence that lies within the reabsorption zone is heavily re-absorbed by the dye and then emitted as fluorescence that is of longer wavelength. The overall effect is that the emission spectra of the sheet ends up about 30 nm red-shifted compared to the dilute solution spectra which may be measured in a lab.

Disclosed herein are articles, such as PSL films, which are made to generate fluorescence that targets phytochrome P660 and/or P730. This can be used to elicit what is known as “short day” or “long day” growth patterns, such as flowering and fruit development, under 12 hours or close to 12 hour photoperiods. This is a feature that allows a grower to induce a photoperiodic effect when the normal solar spectrum would not be sufficient to trigger that effect. Previously reported films with growth inducing luminescence has only small amounts of long wavelength light that are not sufficient to have a photoperiodic effect.

In one embodiment, an article or device described herein uses high QY dyes used in sufficient concentration to cause red shifting of the fluorescence by allowing a higher degree of reabsorption effects within the article or device with increasing absorbance, in addition to generating strong fluorescence. In this way it may be possible to tune the fluorescence output of a single to any number of wavelengths by adjusting the concentration of the dye. In the prior art, red-shifting is arguably avoided or not addressed.

It will be appreciated that the embodiments of each aspect of the present disclosure may equally be applied to each other aspect, mutatis mutandis.

### REFERENCES

1. Destro, M.; Corte, D. D., How smart additives can improve productivity for rose growers? In International Conference on Greenhouse Technologies & the Market-Horticulture and Floriculture, Amsterdam, 2003
2. Novoplansky, A.; Sachs, T.; Cohen, D.; Bar, R.; Bodenheimer, J.; Reisfeld, R., Increasing plant productivity by changing the solar spectrum. Solar Energy Materials 1990, 21 (1), 17-23.
3. Patil, G. G.; Oi, R.; Gissinger, A.; Moe, R., Plant morphology is affected by light quality selective plastic films and alternating day and night temperature. Gartenbauwissenschaft 2001, 66 (2), 53-60.
5. Far-red Light Absorbing Photoselective Plastic Films Affect Growth and Flowering of Chrysanthemum Cultivars. HortScience 38 (2), 4.
6. Fletcher, J. M.; Tatsiopoulou, A.; Mpezamihigo, M.; Carew, J. G.; Henbest, R. G. C.; Hadley, P., Far-red light filtering by plastic film, greenhouse-cladding materials: effects on growth and flowering in Petunia and Impatiens. The Journal of Horticultural Science and Biotechnology 2005, 80 (3), 303-306.

### BRIEF DESCRIPTION OF DRAWINGS

Whilst it will be appreciated that a variety of embodiments of the invention may be utilised, in the following, we describe a number of examples of the invention with reference to the following drawings:

FIG. 1—Image of phytochrome showing the structure of phytochromobilin in two conformations P660 (Pr) and P730 (Pfr).

FIG. 2—Illustration of the interconversion of P660 and P730 (extracted from http://ib.bioninja.com.au/_Media/phytochrome_med.jpeg).

FIG. 3—Examples of an absorbance spectrum of the P660 (Pr) and P730 (Pfr) forms of phytochrome overlaid with spectrum of chlorophyll showing how phytochrome requires longer wavelength light than chlorophyll to be properly targeted.

FIG. 4—Synthesis of 1,6,7,12 tetrachloro 3,4 9,10 tetracarboxylic dianhydride perylene (Compound I).

FIG. 5—Synthesis of Compound II from Compound I.

FIG. 6—Exemplified synthesis and structure of Dye 1.

FIG. 7—UV/Vis spectroscopic analysis of Dye 1.

FIG. 8—MALDI-TOF MS spectrum for Dye 1.

FIG. 9—Exemplary synthesis for Compound III.

FIG. 10—Exemplified synthetic pathway for Dye 2.

FIG. 11—UV/Vis spectrum for Dye 2.

FIG. 12—¹H NMR Spectrum for Dye 2.

FIG. 13—MALDI-TOF MS spectrum for Dye 2.

FIG. 14—The cis and trans structure for the Dye 3 compounds.

FIG. 15—UV/Vis absorbance spectrum for Compound 2A.

FIG. 16—UV/Vis florescence spectrum for Compound 2A.

FIG. 17—A MALDI-TOF MS spectrum of Compound 2A.

FIG. 18—¹H NMR spectrum of Compound 3A.

FIG. 19—MALDI-TOF MS characterisation of Compound 3A.

FIG. 20—UV/Vis absorbance characterisation of Compound 3A.

FIG. 21—UV/Vis fluorescence characterisation of Compound 3A.

FIG. 22—The compounds of Dye 4.

FIG. 23—The compounds of Dye 5.

FIG. 24—Images A) and B) show polycarbonate sheets compounded with Dyes 1, 3 and 4.

FIG. 25—Spectral measurement under Dye 1 plastic film (solid line) compared to a normal solar spectrum (dashed line).

FIG. 26—Alternating Dye 3 plastics with Dye 4 plastics overlaid on top of Dye 3 plastics for additive “donor/acceptor” enhanced effect.

FIG. 27—Spectral measurement under Dye 1 plastic film (solid line) showing a filtering of light by the dye between 550-650 nm and an enhanced amount of light near 730 nm (dashed line).

FIG. 28—Image of Dye 1 plastics. The luminescence cannot be seen as the emissions occur beyond the red wavelength limits of the human eye.

FIG. 29—Diagram from each face that is perpendicular (0 degrees to normal) up to the critical angle for TIR.

FIG. 30—CAD drawing of protrusions for the moulding machine that were fitted to a male roller head.

FIG. 31—Illustration of the extractor geometry showing a depression, created when male roller protrusions press down into the sheet in the machine, which extracts light in one direction.

FIG. 32—Image A shows a moulding machine with two heads for feeding the sheet. Male head protrusions have not yet been installed; image B shows a moulding machine working, see male head has protrusions that create the luminescence extractor points on the sheet.

FIG. 33—Images A) and B) show two faces of the same strip of processed polycarbonate and the differences with TIR based on the structures.

FIG. 34—Images A) and B) show two sides of a single sheet where protrusions have been made on one side, with corresponding depressions on the other side.

FIG. 35—Images A), B) and C) show a cannabis indoor nursery, the inside of trial apparatus looking up at the light source shining downward through a film as defined herein, and trial apparatus from the outside showing light source shining exclusively into individual chambers, respectively.

FIG. 36—A comparison of cannabis growing trials with control samples and articles in the films as defined herein over a period of various days.

FIG. 37—Graphical results of bok choy trail with articles in the form of films as defined herein.

FIG. 38—Photos from a strawberry trial: the entire trial in image A); red treatment (R) showing the 50% and 100% coverage in image B; red layered with orange (RO) treatment showing the 50% and 100% coverage in image C); and blue (B) treatment of 50% in image D).

FIG. 39—Testing dyes disclosed herein for the growth of strawberries in Harvest 1 (image A) and Harvest 2 (Image B).

FIG. 40—Spectroscopic analysis of Dye 6.

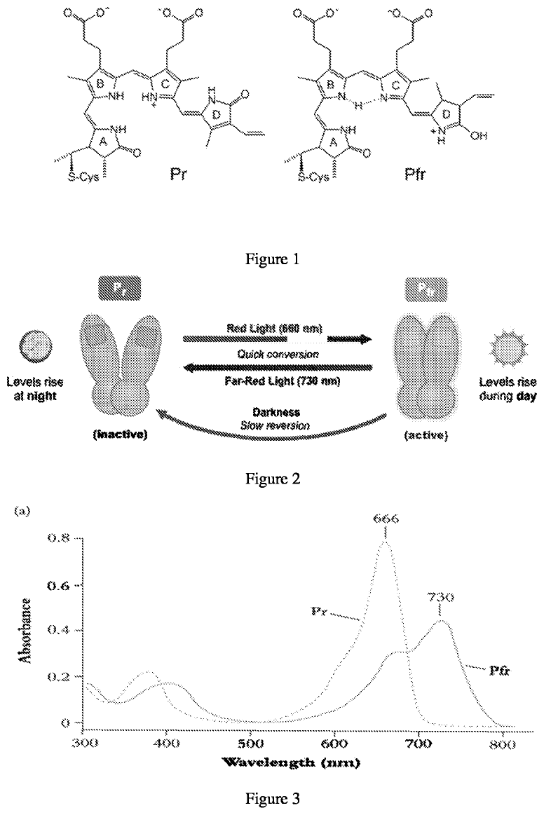

### DESCRIPTION OF EMBODIMENTS

### Definitions

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

The term “and/or”, e.g., “X and/or Y” is be understood to mean either “X and Y” or “X or Y” and provides explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition, although may include elements that do not materially affect properties.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Herein the term “about” encompasses a 10% tolerance in any value or values connected to the term.

The term “sheet” is to be understood as a flat element with small thickness relative to its length and width. The sheet may be elastic e.g. in shape of a foil or rather rigid, e.g. a glass pane, a panel or plate made of a transparent polymeric material. The sheet as such may also be formed into a three dimensional shape for example: cylindrical, spherical, conical, cubical, or pyramidal. The sheet can thus be for example in the form of a film, glazing for greenhouse or tunnel covers, a film or filament for shading nets and screens, mulch films, non-woven or moulded articles for the protection of young plants, a plate in front of an assimilation lamp or a tubular algae reactor.

“Plants” are to be considered any organism which exhibits photosynthetic abilities such as for example trees, herbs, bushes, grasses, vines, ferns, mosses, aquatic plants, macro-algae, micro-algae and cyanobacteria. The term greenhouse is to be understood as an at least partially enclosed environment in which plants are maintained. It encompasses thus also tunnels of plastic foil over agricultural crop or a tank for the growth of algae. Herein the term “organism” may be used interchangeably with “plant”.

Herein “low quantum yield (QY) lumiphores” may be regarded as lumiphores where the luminescence generated does not equate closely to the amount of light absorbed, thereby lowering the overall light intensity. A QY of 100% is where the luminescence (in terms of the number of photons of light) is equal to the amount of light absorbed by the lumiphore. In that case the total light intensity, in term of photon flux, is not changed, only the spectral quality. However, the total Watts of light energy will be decreased due to the lower frequency light that is produced in place if high frequency light, i.e. yellow light being converted to orange. To account for this, there is a small amount of heat that is given off.

Herein materials may be used that have a variable degree of transparency. The degree of transparency can range from 0-100% visible light transmission. Measured as % T for any given wavelength, the % T for a material may be at least 5%; at least 10%; at least 15%; at least 20%; at least 25%; at least 30%; at least 35%; at least 40%; at least 45%; at least 50%; at least 55%; at least 60%; at least 65%; at least 70%; at least 75%; at least 80%; at least 85%; at least 90%; or at least 95%.

Herein the terms “article” and “device” (or their plural terms), may be used interchangeably unless clear from context or specific commentary.

“Alkyl” means a straight chain or branched, noncyclic or cyclic, saturated aliphatic hydrocarbon. The alkyl group may contain from 1 to 24 carbon atoms. Representative saturated straight chain alkyls include methyl, ethyl, n-propyl, n-butyl, n-pentyl, n-hexyl, n-heptyl, n-octyl, n-nonyl, n-decane, n-undecane, n-dodecane and the like; while saturated branched alkyls include isopropyl, sec-butyl, isobutyl, tert-butyl, isopentyl, and the like. Representative saturated cyclic alkyls include cyclopropyl, cyclobutyl, cyclopentyl, cyclohexyl, and the like; while unsaturated cyclic alkyls include cyclopentenyl and cyclohexenyl, and the like. Each independent alkyl group may be substituted or unsubstituted.

“Alkenyl” means an alkyl, as defined above, containing at least one double bond between adjacent carbon atoms. The alkenyl group may contain from 2 to 24 carbon atoms. Representative straight chain and branched alkenyls include ethylenyl, propylenyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like. Each independent alkenyl group may be substituted or unsubstituted.

“Alkynyl” means any alkyl or alkenyl, as defined above, which additionally contains at least one triple bond between adjacent carbons. The alkynyl group may contain from 2 to 24 carbon atoms. Representative straight chain and branched alkynyls include acetylenyl, propynyl, 1-butynyl, 2-butynyl, 1-pentynyl, 2-pentynyl, 3-methyl-1-butynyl, and the like. Each independent alkynyl group may be substituted or unsubstituted.

The term “aryl” disclosed herein refers to a mono- or polycyclic aromatic hydrocarbon systems. The aryl systems may contain 3 to 22 carbon atoms, which can be optionally substituted. The term “aryl” also includes systems in which the aromatic cycle is part of a bi- or polycyclic saturated, partially unsaturated and/or aromatic system, such as where the aromatic cycle is fused to an aryl, cycloalkyl, heteroaryl or heterocyclyl group, including those defined herein via any desired and possible ring member of the aryl radical. Examples of suitable aryl radicals are phenyl, biphenyl, naphthyl, 1-naphthyl, 2-naphthyl and anthracenyl, but likewise indanyl, indenyl or 1,2,3,4-tetrahydronaphthyl. Each independent aryl group may be substituted or unsubstituted.

A “heteroaryl” group is an aryl ring system having one to four heteroatoms as ring atoms in a heteroaromatic ring system, wherein the remainder of the atoms are carbon atoms. In some embodiments, heteroaryl groups contain 3 to 6 ring atoms, and in others from 6 to 9 or even 6 to 10 atoms in the ring portions of the groups. Suitable heteroatoms include oxygen, sulfur and nitrogen. In certain embodiments, the heteroaryl ring system is monocyclic or bicyclic. Non-limiting examples include but are not limited to, groups such as pyrrolyl, pyrazolyl, imidazolyl, triazolyl, tetrazolyl, oxazolyl, isoxazolyl, benzisoxazolyl (e.g., benzo[d]isoxazolyl), thiazolyl, pyrolyl, pyridazinyl, pyrimidyl, pyrazinyl, thiophenyl, benzothiophenyl, furanyl, benzofuranyl, indolyl (e.g., indolyl-2-onyl or isoindolin-1-onyl), azaindolyl (pyrrolopyridyl or 1H-pyrrolo[2,3-b]pyridyl), indazolyl, benzimidazolyl (e.g., 1H-benzo[d]imidazolyl), imidazopyridyl (e.g., azabenzimidazolyl or 1H-imidazo[4,5-b]pyridyl), pyrazolopyridyl, triazolopyridyl, benzotriazolyl (e.g., 1H-benzo[d][1,2,3]triazolyl), benzoxazolyl (e.g., benzo[d]oxazolyl), benzothiazolyl, benzothiadiazolyl, isoxazolopyridyl, thianaphthalenyl, purinyl, xanthinyl, adeninyl, guaninyl, quinolinyl, isoquinolinyl (e.g., 3,4-dihydroisoquinolin-1(2H)-onyl), tetrahydroquinolinyl, quinoxalinyl, and quinazolinyl groups. Each independent hetereoaryl group may be substituted or unsubstituted.

A “heterocyclyl” is an aromatic (also referred to as heteroaryl) or non-aromatic cycloalkyl in which one to four of the ring carbon atoms are independently replaced with a heteroatom from the group consisting of O, S and N. In some embodiments, heterocyclyl groups include 3 to 10 ring members, whereas other such groups have 3 to 5, 3 to 6, or 3 to 8 ring members. Heterocyclyls can also be bonded to other groups at any ring atom (i.e., at any carbon atom or heteroatom of the heterocyclic ring). A heterocycloalkyl group can be substituted or unsubstituted. Heterocyclyl groups encompass unsaturated, partially saturated and saturated ring systems, such as, for example, imidazolyl, imidazolinyl and imidazolidinyl (e.g., imidazolidin-4-one or imidazolidin-2,4-dionyl) groups. The phrase heterocyclyl includes fused ring species, including those comprising fused aromatic and non-aromatic groups, such as, for example, 1-and 2-aminotetraline, benzotriazolyl (e.g., 1H-benzo[d][1,2,3]triazolyl), benzimidazolyl (e.g., 1H-benzo[d]imidazolyl), 2,3-dihydrobenzo[1,4]dioxinyl, and benzo[1,3]dioxolyl. The phrase also includes bridged polycyclic ring systems containing a heteroatom such as, but not limited to, quinuclidyl. Representative examples of a heterocyclyl group include, but are not limited to, aziridinyl, azetidinyl, azepanyl, oxetanyl, pyrrolidyl, imidazolidinyl (e.g., imidazolidin-4-onyl or imidazolidin-2,4-dionyl), pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, benzisoxazolyl (e.g., benzo[d]isoxazolyl), thiazolyl, thiazolinyl, isothiazolyl, thiadiazolyl, oxadiazolyl, piperidyl, piperazinyl (e.g., piperazin-2-onyl), morpholinyl, thiomorpholinyl, tetrahydropyranyl (e.g., tetrahydro-2H-pyranyl), tetrahydrothiopyranyl, oxathianyl, dioxyl, dithianyl, pyranyl, pyridyl, pyrimidyl, pyridazinyl, pyrazinyl, triazinyl, dihydropyridyl, dihydrodithiinyl, dihydrodithionyl, 1,4-dioxaspiro[4.5]decanyl, homopiperazinyl, quinuclidyl, indolyl (e.g., indolyl-2-onyl or isoindolin-1-onyl), indolinyl, isoindolyl, isoindolinyl, azaindolyl (pyrrolopyridyl or 1H-pyrrolo[2,3-b]pyridyl), indazolyl, indolizinyl, benzotriazolyl (e.g. 1H-benzo[d][1,2,3]triazolyl), benzimidazolyl (e.g., 1H-benzo[d]imidazolyl or 1H-benzo[d]imidazol-2(3H)-onyl), benzofuranyl, benzothiophenyl, benzothiazolyl, benzoxadiazolyl, benzoxazinyl, benzodithiinyl, benzoxathiinyl, benzothiazinyl, benzoxazolyl (i.e., benzo[d]oxazolyl), benzothiazolyl, benzothiadiazolyl, benzo[1,3]dioxolyl, pyrazolopyridyl (for example, 1H-pyrazolo[3,4-b]pyridyl, 1H-pyrazolo[4,3-b]pyridyl), imidazopyridyl (e.g., azabenzimidazolyl or 1H-imidazo[4,5-b]pyridyl), triazolopyridyl, isoxazolopyridyl, purinyl, xanthinyl, adeninyl, guaninyl, quinolinyl, isoquinolinyl (e.g., 3,4-dihydroisoquinolin-1(2H)-onyl), quinolizinyl, quinoxalinyl, quinazolinyl, cinnolinyl, phthalazinyl, naphthyridinyl, pteridinyl, thianaphthalenyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, tetrahydropyrimidin-2(1H)-one and tetrahydroquinolinyl groups. Representative non-aromatic heterocyclyl groups do not include fused ring species that comprise a fused aromatic group. Examples of non-aromatic heterocyclyl groups include aziridinyl, azetidinyl, azepanyl, pyrrolidyl, imidazolidinyl (e.g., imidazolidin-4-onyl or imidazolidin-2,4-dionyl), pyrazolidinyl, thiazolidinyl, tetrahydrothiophenyl, tetrahydrofuranyl, piperidyl, piperazinyl (e.g., piperazin-2-onyl), morpholinyl, thiomorpholinyl, tetrahydropyranyl (e.g., tetrahydro-2H-pyranyl), tetrahydrothiopyranyl, oxathianyl, dithianyl, 1,4-dioxaspiro[4.5]decanyl, homopiperazinyl, quinuclidyl, or tetrahydropyrimidin-2(1H)-one. Representative substituted heterocyclyl groups may be mono-substituted or substituted more than once, such as, but not limited to, pyridyl or morpholinyl groups, which are 2-, 3-, 4-, 5-, or 6-substituted, or disubstituted with various substituents such as those listed below. Each independent heterocyclyl group may be substituted or unsubstituted.

The term “unsubstituted” means that the corresponding radical, group or moiety has no substituents.

The term “optionally substituted” or “substituted” means that the corresponding radical, group or moiety may have one or more substituents, or has one or more substituents present. Where a radical has a plurality of substituents, and a selection of various substituents is specified, the substituents are selected independently of one another and do not need to be identical. When a radical, group or moiety is a substituted group, at least one hydrogen atom on the radical, group of moiety is replaced with a substituent. In the case of an oxo substituent (═O) two hydrogen atoms are replaced. In this regard, the optional substituents may include one or more substituents selected from, but not limited to: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, oxo, heterocycle, —OR^{X}, —NR^{X}R^{Y}, —NR^{X}C(═O)R^{y}, —NR^{X}SO₂R^{Y}, —C(═O)R^{X}, —C(═O)OR^{X}, —C(═O)NR^{X}R^{y}, —SO_{q}R^{X} and —SO_{q}NR^{X}R^{y}, wherein q is 0, 1 or 2, R^{X} and R^{y} are the same or different and independently selected from hydrogen, alkyl or heterocycle, and each of said alkyl and heterocycle substituents may be further substituted with one or more of oxo, halogen, —OH, —CN, alkyl, —OR^{X}, heterocycle, —NR^{x}R^{y}, —NR^{X}C(═O)R^{y}, —NR^{x}SO₂R^{Y}, —C(═O)R^{X}, —C(═O)OR^{X}, —C(═O)NR^{x}R^{y}, —SOR^{X} and —SONR^{X}R^{y}. The optional substituents themselves may be substituted by one or more substituents as defined in the aforementioned list.

“Halogen” or “halo” means fluorine, chlorine, bromine and iodine.

Herein, unless otherwise indicated, in the disclosed compounds [symbol] represents the presence of a single or double bond.

In the present specification, the structural formula of a compound may represent a certain isomer for convenience in some cases, but the present disclosure, unless otherwise indicated, includes all isomers, such as geometrical isomers, for example syn- and anti-isomers, optical isomers based on an asymmetrical carbon, stereoisomers, tautomers, and the like. In addition, a crystal polymorphism may be present for the compounds represented by the formula. It is noted that any crystal form, crystal form mixture, or anhydride or hydrate thereof is included in the scope of the present disclosure.

Herein, for example, the compounds of Formula (II) may exist in either the “syn” or the “anti” form. For example:

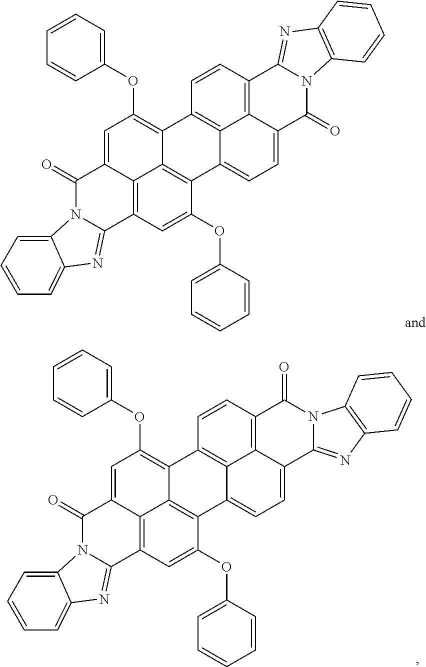 [SMILES: O=c1c2ccc3c4c(Oc5ccccc5)cc5c6c(cc(Oc7ccccc7)c(c7ccc(c2c73)c2nc3ccccc3n12)c46)c(=O)n1c2ccccc2nc51 ; O=c1c2ccc3c4c(Oc5ccccc5)cc5c(=O)n6c7ccccc7nc6c6cc(Oc7ccccc7)c(c7ccc(c2c37)c2nc3ccccc3n12)c4c56]

and syn isomers of the same compound, respectively.

“Tautomer” is one of two or more structural isomers that exist in equilibrium and is readily converted from one isomeric form to another. This conversion results in the formal migration of a hydrogen atom accompanied by a switch of adjacent conjugated double bonds. Tautomers exist as a mixture of a tautomeric set in solution. In solid form, usually one tautomer predominates. In solutions where tautomerisation is possible, a chemical equilibrium of the tautomers will be reached. The exact ratio of the tautomers depends on several factors, including temperature, solvent and pH. The concept of tautomers that are inter-convertible by tautomerisations is called tautomerism.

“Isomerism” means compounds that have identical molecular formulae but differ in the sequence of bonding of their atoms or in the arrangement of their atoms in space. Isomers that differ in the arrangement of their atoms in space are termed “stereoisomers”. Stereoisomers that are not mirror images of one another are termed “diastereoisomers”, and stereoisomers that are non-superimposable mirror images of each other are termed “enantiomers” or sometimes optical isomers. A mixture containing equal amounts of individual enantiomeric forms of opposite chirality is termed a “racemic mixture”.

Herein, C₁₂H₂₅ isomers may include, but are not limited to alkyl substituents derived from: (5R,6R)-5-methyl-6-methyldecane; 2,2,4,4,6-pentamethylheptane; 2,2,4,4-tetramethyl-6-methylheptane; 2,3,3,4,4,5-hexamethylhexane; 2,3,3,4,4-pentamethyl-5-methylhexane; 2,3,3,6-tetramethyloctane; 2,3,4,5,6-pentamethylheptane; 2,3,4,6-tetramethyloctane; 2,3,5,7-tetramethyloctane; 2,3,5-trimethyl-4-propan-2-ylhexane; 2,3,5-trimethylnonane; 2,4,6-trimethylnonane; 2,4,8-trimethylnonane; 2,4-dimethyldecane; 2-methylundecane; 3,4,5,6-tetramethyloctane; 3,4-dimethyl-4-propan-2-ylheptane; 3,4-dimethyldecane; 3-methylundecane; 4,5-diethyloctane; 4-ethyl-6-methylnonane; 4-methanidyl-5-propan-2-yloctane; 5-ethyl-3,4-dimethyloctane; 5-methyl-6-methyldecane; 6-ethyl-3-methylnonane; and/or dodecane,

A carbon atom bonded to four non-identical substituents is termed a “chiral centre”.

“Chiral isomer” means a compound with at least one chiral centre. Compounds with more than one chiral centre may exist either as an individual diastereomer or as a mixture of diastereomers, termed “diastereomeric mixture”. When one chiral centre is present, a stereoisomer may be characterised by the absolute configuration (R or S) of that chiral centre. Absolute configuration refers to the arrangement in space of the substituents attached to the chiral centre.

“Geometric isomer” means the diastereomers that owe their existence to hindered rotation about double bonds. These configurations are differentiated in their names by the prefixes cis and trans, or Z and E, which indicate that the groups are on the same or opposite side of the double bond in the molecule

Furthermore, the structures and other compounds discussed in this disclosure include all atropic isomers thereof. “Atropic isomers” are a type of stereoisomer in which the atoms of two isomers are arranged differently in space. Atropic isomers owe their existence to a restricted rotation caused by hindrance of rotation of large groups about a central bond.

Herein, “salts” includes both inorganic and organic acid addition salts and basic addition salts. Examples include, but are not limited to: metal salts (including: alkali metal salts, for example lithium, sodium or potassium salts; alkaline earth metal salts, for example calcium or magnesium salts; or zinc salts); organic amine salts (including triethylamine, pyridine, picoline, ethanolamine, triethanolamine, dicylohexylamine, or N,N′-dibenzylethylenediamine salts); inorganic acid salts (including hydrochloride, hydrobromide, phosphate, nitrate, carbonate, bicarbonate or sulphate salts); organic acid salts (including citrate, lactate, malonate, succinate, benzoate, ascorbate, α-ketoglutarate, α-glycerophosphate tartrate, maleate, hydroxymaleate, gluconate, oxalate, phenylacetate, salicylate, edetate, stearate, palmate, oleate, laurate, fumarate, mandelate, acetate, propanoate, butanoate, dichloroacetate, trifluoroacetate, oxalate, or formate salts); and/or sulfonate salts (including methanesulfonate, benzenesulfonate, or para-toluenesulfonate salts). Appropriate acid addition salts may be produced by utilising an acid, for example an acid selected from: hydrochloric acid, formic acid, propionic acid, glycolic acid, lactic acid, pyruvic acid, malonic acid, anthranilic acid, cinnamic acid, naphthalene sulfonic acid, sulfanilic acid, trifluoroacetic acid, methansulfonic acid, benzenesulfonic acid, p-toluenesulfonic acid, fumaric acid, maleic acid, succinic acid, acetic acid, citric acid, tartaric acid, carbonic acid, phosphoric acid, oxalic acid, dichloroacetic acid, and mixture thereof. Appropriate base addition salts can be produced by utilising a base, for example a base selected from: sodium hydroxide, potassium hydroxide, choline hydroxide, mono-, di- and tri-alkyl and aryl amines (for example triethylamine, diisopropyl amine, methyl amin, dimethyla mine, pyridine, picoline, dicyclohexylamin, N,N′-dibezylethylenediamin, and the like), sodium carbonate, and mixtures thereof.

### Dyes

Herein an article or device may comprise one or more dyes. The one or more dyes may be luminescent, for example, one or more fluorescent, phosphorescent or electroluminescent dyes.

In one embodiment the article or device comprises one dye, for example one fluorescent dye.

In one embodiment the article or device comprises two or more different dyes, for example two or more different fluorescent dyes.

In one embodiment the article or device comprises one or more dyes, for example the article or device may comprise one or more dyes that fluoresce, and emit a wavelength in a range of about 600 nm to about 700 nm. Exemplary ranges or values include, but are not limited to: about 610 nm to about 700 nm; about 620 nm to about 700 nm; about 630 nm to about 700 nm; about 640 nm to about 700 nm; about 650 nm to about 700 nm; about 660 nm to about 700 nm; about 670 nm to about 700 nm; about 680 nm to about 700 nm; about 690 nm to about 700 nm; about 600 nm to about 690 nm; about 600 nm to about 680 nm; about 600 nm to about 670 nm; about 600 nm to about 660 nm; about 600 nm to about 650 nm; about 600 nm to about 640 nm; about 600 nm to about 630 nm; about 600 nm to about 620 nm; about 600 nm to about 610 nm; at least about 600 nm; at least about 605 nm; at least about 610 nm; at least about 615 nm; at least about 620 nm; at least about 625 nm; at least about 630 nm; at least about 635 nm; at least about 640 nm; at least about 645 nm; at least about 650 nm; at least about 655 nm; at least about 660 nm; at least about 665 nm; at least about 670 nm; at least about 675 nm; at least about 680 nm; at least about 685 nm; at least about 690 nm; at least about 695 nm; at least about 700 nm; or mixtures thereof.

In one embodiment the article or device comprises one or more dyes, for example the article or device may comprise one or more dyes that fluoresce, and emit a wavelength in a range of about 700 nm to about 800 nm. Exemplary ranges or values include, but are not limited to: about 700 nm to about 800 nm; about 710 nm to about 800 nm; about 720 nm to about 800 nm; about 730 nm to about 800 nm; about 740 nm to about 800 nm; about 750 nm to about 800 nm; about 760 nm to about 800 nm; about 770 nm to about 800 nm; about 780 nm to about 800 nm; about 790 nm to about 800 nm; about 700 nm to about 790 nm; about 700 nm to about 780 nm; about 700 nm to about 770 nm; about 700 nm to about 760 nm; about 700 nm to about 750 nm; about 700 nm to about 740 nm; about 700 nm to about 730 nm; about 700 nm to about 720 nm; about 700 nm to about 710 nm; at least about 700 nm; at least about 705 nm; at least about 710 nm; at least about 715 nm; at least about 720 nm; at least about 725 nm; at least about 730 nm; at least about 735 nm; at least about 740 nm; at least about 745 nm; at least about 750 nm; at least about 755 nm; at least about 760 nm; at least about 765 nm; at least about 770 nm; at least about 775 nm; at least about 780 nm; at least about 785 nm; at least about 790 nm; at least about 795 nm; at least about 800 nm; or mixtures thereof.

In one embodiment the article or device comprises one or more dyes that fluoresces and emits a wavelength in a range of about 600 nm to about 700 nm and one or more dyes that fluoresces and emits a wavelength in a range of about 700 nm to about 800 nm.

In another embodiment the article or device comprises one or more dyes that absorb light in a range of about 250 nm to about 600 nm (for example for a P660 dye), or in a range of about 250 nm to 730 nm (for example for a P730 dye). Exemplary ranges include, but are not limited to: about 260 to about 730 nm; about 270 to about 730 nm; about 280 to about 730 nm; about 290 to about 730 nm; about 300 to about 730 nm; about 310 to about 730 nm; about 320 to about 730 nm; about 330 to about 730 nm; about 340 to about 730 nm; about 350 to about 730 nm; about 360 to about 730 nm; about 370 to about 730 nm; about 380 to about 730 nm; about 390 to about 730 nm; about 400 to about 730 nm; about 410 to about 730 nm; about 420 to about 730 nm; about 430 to about 730 nm; about 440 to about 730 nm; about 450 to about 730 nm; about 460 to about 730 nm; about 470 to about 730 nm; about 480 to about 730 nm; about 490 to about 730 nm; about 500 to about 730 nm; about 510 to about 730 nm; about 520 to about 730 nm; about 530 to about 730 nm; about 540 to about 730 nm; about 550 to about 730 nm; about 560 to about 730 nm; about 570 to about 730 nm; about 580 to about 730 nm; about 590 to about 730 nm; about 600 to about 730 nm; about 610 to about 730 nm; about 620 to about 730 nm; about 630 to about 730 nm; about 640 to about 730 nm; about 650 to about 730 nm; about 660 to about 730 nm; about 670 to about 730 nm; about 680 to about 730 nm; about 690 to about 730 nm; about 700 to about 730 nm; about 710 to about 730 nm; about 720 to about 730 nm; about 250 nm to about 690 nm; about 250 nm to about 680 nm; about 250 nm to about 670 nm; about 250 nm to about 660 nm; about 250 nm to about 650 nm; about 250 nm to about 640 nm; about 250 nm to about 630 nm; about 250 nm to about 620 nm; about 250 nm to about 610 nm; about 250 nm to about 600 nm; about 250 nm to about 590 nm; about 250 nm to about 580 nm; about 250 nm to about 570 nm; about 250 nm to about 560 nm; about 250 nm to about 550 nm; about 250 nm to about 540 nm; about 250 nm to about 530 nm; about 250 nm to about 520 nm; about 250 nm to about 510 nm; about 250 nm to about 500 nm; about 250 nm to about 490 nm; about 250 nm to about 480 nm; about 250 nm to about 470 nm; about 250 nm to about 460 nm; about 250 nm to about 450 nm; about 250 nm to about 440 nm; about 250 nm to about 430 nm; about 250 nm to about 420 nm; about 250 nm to about 410 nm; about 250 nm to about 400 nm; about 250 nm to about 390 nm; about 250 nm to about 380 nm; about 250 nm to about 370 nm; about 250 nm to about 360 nm; about 250 nm to about 350 nm; about 250 nm to about 340 nm; about 250 nm to about 330 nm; about 250 nm to about 320 nm; about 250 nm to about 310 nm; about 250 nm to about 300 nm; about 250 nm to about 290 nm; about 250 nm to about 280 nm; about 250 nm to about 270 nm; about 250 nm to about 260 nm; or mixtures thereof.

In one embodiment the article or device described herein utilises one or more fluorescent dyes with a high quantum efficiency to create as much of the desired wavelength or wavelengths as possible. In addition, a user of the article or device can have a significant effect on the plants without absorbing too much of light directed to the article, for example without absorbing too much light in the solar spectrum.

Examples of dyes that could be used include perylene type dyes. In one embodiment, an article or device described herein may comprise a luminescent material. The luminescent material may be any inorganic luminescent compound. In one embodiment, the inorganic luminescent compound may comprise a rare-earth doped inorganic crystal or a doped zinc sulphide. In another embodiment, the luminescent material may be any organic luminescent compound. In yet another embodiment, the luminescent material may comprise a quantum dot. In one embodiment, the luminescent material may be any organometallic luminescent compound.

The luminescent material may be, for example, a commercially available luminescent pigment or luminescent dye. Examples of the luminescent (phosphorescent) material used include, but are not limited to, calcium sulfate phosphors (host crystal: CaS; activator: Bi); zinc sulfate phosphors (host crystal: ZnS; activator: Cu, e.g. “GSS” manufactured by Nemoto & Co., Ltd.); strontium aluminate or calcium aluminate phosphors (host crystal: strontium aluminate or calcium aluminate; activator: Eu, Dy, Nd, or the like; e.g. VGS-FAP or VGS3-FAP series manufactured by Visionglow International Pty Ltd; LumiNova R G-300 series, BG-300 series, and V-300 series, manufactured by Nemoto & Co., Ltd.: “ULTRA GLOW series NP-2810, NP-2820, and NP-2830, manufactured by Nichia Corporation: “R-bright” B and YG, manufactured by Lead Co., Ltd.: “Chemibright Pow der G-40-C, G-100-B, G-100-C, GB-80-B, and B-50-B, manufactured by Lumica Corporation); phosphors containing CaSrS, as a host crystal, and Bi, as an activator, and phosphors containing CaS, as a host crystal, and Eu or Tm, as an activator. Examples of suitable phosphorescent materials also include yttrium aluminium garnet (YAG, YA130), terbium aluminium garnet (TAG, Tb Al—O.), and g. which can emit a yellow light having a wavelength in the range of 530 to 590 nm. Examples of the luminescent (fluorescent) material used include, but are not limited to, Rhodamine B, Rhodamine 6G, Rhodamine S, Eosine, Basic yellow HG, Brilliant sulfoflavine FF, Thioflavine, and Fluorescein. Examples of suitable fluorescent materials also include stilbene, benzooxazole, 9-oxo-xanthene, N-methyl-1,8-naphthyl-imide, 3-(4-chlorophenyl)pyrazoline, pyrazoline, imidazole, 1,2,4-triazole, oxazolidine-2-one, 1.8-naphthyl-imide, 4,4′-bis(2-methoxystyryl)-1,1′-biphenyl, 4,4′-bis(2-(1-pyrenyl)ethenyl)-1,1′-biphenyl, 4,4′-bis(2-(9-phenanthrenyl) ethenyl)-1,1′-biphenyl, 4,4′-bis(2-(9-anthracenyl)ethenyl)-1, 1′-biphenyl, 4,4′-bis(2-(1-anthraquinonyl)ethenyl)-1,1′-biphenyl, 4,4′-bis(2-(2-fluorenyl)ethenyl)-1,1′-biphenyl, 1,4-bis(2-cyanostyryl)benzene, 1,4-bis(2-benzoxazoly) naphthalene, 2.5-bis(5-tertbutyl-2-benzoxazolyl)thiophene, 2.5-bis(2-benzoxazolyl)thiophene, 4.4-bis(benzoxazoyl)stilbene, 4,4′-bis(5-methyl-2-benzoxazolyl)stilbene, 1,2-bis(5-methyl-2-benzoxazolyl)ethylene, ethyl 5,6-benzocoumarin 3-carboxylate, 3-phenyl-5,6-benzocoumarin, N-methyl-4,5-diethoxy-18-naphthyl-imide, N-methyl-4-methoxy-1.8-naphthyl-imide, 3-(4-chlorophenyl)-1,5-diphenyl-2-pyrazoline, 3-(4-chlorophenyl)-1-phenyl-pyrazole, 4-methyl-7-diethylaminocoumarin, 1-(p-methanesulfo nylphenyl)-3-(p-chlorophenyl)-2-pyrazoline, 1-(p-sulfonamidophenyl)-3-(p-chlorophenyl)-2-pyrazoline, pyrene, numerous derivatives of perylenes and any combination thereof. The fluorescent materials listed above may substantially completely absorb light over the entire UV, visible and near IR range, and subsequently re-emit it as longer wave length light with very high brightness.

Any lighting source that emits light of a wavelength that is suitable for energising the luminescent material may be used as an energy source. The source may be, for example, the Sun, an incandescent device, a halogen device, or a fluorescent device. The device may be fluorescent such as bulb, globe or tube. In some embodiments, light is derived from sunlight.

In one embodiment the dye may be based on perylene type dyes. For example perylene type dyes that have a fluorescence spectral maximum wavelength at 625 nm or longer.

In one embodiment bis phenoxy and tetra phenoxy perylenes having extended imidazole type groups from the 3,4 and 9,10 positions including, but not limited to, benzimidazole, naphthyl imidazole and anthraquinone imidazole, may be used.

In one embodiment, an article or device described herein comprises at least one 1,6,7,12 tetra (4′-dodecyl phenoxy) perylene. Examples of phenoxy perylene dyes which could be used include, but are not limited to the dyes disclosed in H. Quante, et al, Chem. Mater, 9, 495-500, 1997, the contents of which are incorporated herein by reference.

Herein the article or device may comprise one or more dyes which a compound of Formula (I), Formula (II), or a mixture thereof. In one embodiment the article or device comprises one or more dyes which is/are compound(s) of Formula (I). In another embodiment the article the article or device comprises one or more dyes which is/are compound(s) of Formula (II).

In one embodiment an article or device described herein comprises a compound of Formula (I):

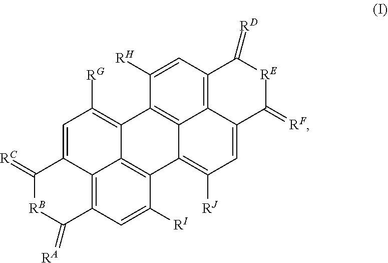

or an isomer or salt thereof, wherein:
either:
   (i) R^{A} is O, R^{B} is N, R^{C} is N, and R^{B} and R^{C} are joined by a

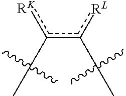

group to form a substituted imidazole group; or
(ii) R^{C} is O, R^{A} is N, R^{B} is N, and R^{A} and R^{B} are joined by a

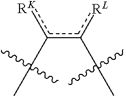

group to form a substituted imidazole group;
either:
   (i) R^{D} is O, R^{E} is N, R^{F} is N, and R^{E} and R^{F} are joined by a

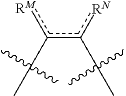

group to form a substituted imidazole group; or
(ii) R^{F} is O, R^{E} is N, R^{D} is N, and R^{D} and R^{E} are joined by

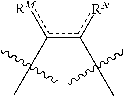

a group to form a substituted imidazole group;
R^{K} and R_{L}:
   (i) are joined to form an optionally substituted monocyclic aromatic ring; or
   (ii) are joined to form an optionally substituted polycyclic aromatic group;
R^{M} and R^{N}:
   (i) are joined to form an optionally substituted monocyclic aromatic ring; or
   (ii) are joined to form an optionally substituted polycyclic aromatic group;
at least one of R^{G}, R^{H}, R^{I} and R^{J} is:

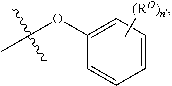

bromine, or chlorine, with the other substituents being hydrogen;
each R^{O} is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.

In one embodiment, in compounds of Formula (I), R^{A} is O, R^{B} is N, R^{C} is N and R^{B} and R^{C} are joined by a by a

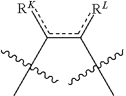

group to form a substituted imidazole group, for example a

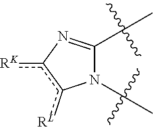

group.

In one embodiment, in compounds of Formula (I), R^{A} is N, R^{B} is N, R^{C} is O and R^{B} and R^{A} are joined by a by a

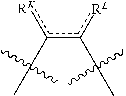

group to form a substituted imidazole group, for example a

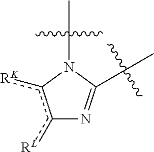

group.

In one embodiment, in compounds of Formula (I), R^{D} is O, R^{E} is N, R^{F} is N and R^{E} and R^{F} are joined by a by a

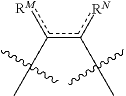

group to form a substituted imidazole group, for example a

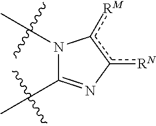

group.

In one embodiment in compounds of Formula (I), R^{F} is O, R^{E} is N, R^{D} is N and R^{E} and R^{D} are joined by a by a

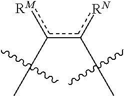

group to form a substituted imidazole group, for example a

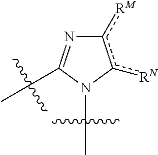

group.

In one embodiment, at least one of R^{G}, R^{H}, R^{I} and R^{J} is chlorine, whilst the others are hydrogen. In another embodiment at least two of R^{G}, R^{H}, R^{I} and R^{J} are chlorine, whilst the others are hydrogen. In another embodiment at least three of R^{G}, R^{H}, R^{I} and R^{J} are chlorine, whilst the other is hydrogen. In another embodiment each of R^{G}, R^{H}, R^{I} and R^{J} is chlorine.

In one embodiment, at least one of R^{G}, R^{H}, R^{I} and R^{J} is bromine, whilst the others are hydrogen. In another embodiment at least two of R^{G}, R^{H}, R^{I} and R^{J} are bromine, whilst the others are hydrogen. In another embodiment at least three of R^{G}, R^{H}, R^{I} and R^{J} are bromine, whilst the other is hydrogen. In another embodiment each of R^{G}, R^{H}, R^{I} and R^{J} is bromine.

In one embodiment, at least one of R^{G}, R^{H}, R^{I} and R^{J} is

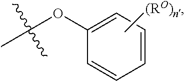

whilst the others are hydrogen. In another embodiment at least two of R^{G}, R^{H}, R^{I} and R^{J} are

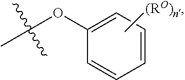

whilst the others are hydrogen. In another embodiment at least three of R^{G}R^{H}, R^{I} and R^{J} are

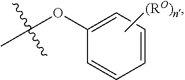

whilst the other is hydrogen. In another embodiment each of R^{G}, R^{H}, R^{I} and R^{J} is

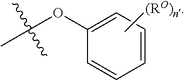

In these embodiments, R^{O} and n′ are as defined herein.

The compound of Formula (I) may exist as two geometric isomers, a syn isomer and an anti-isomer.

In one embodiment the compound of Formula (I) is a compound of Formula (I-A):

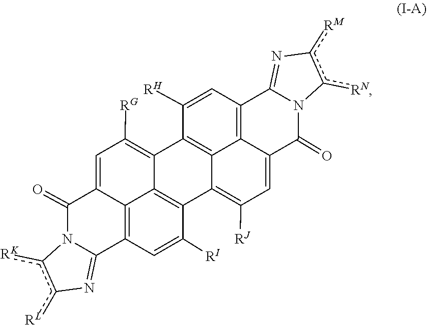

or an isomer or salt thereof, wherein:
R^{K} and R^{L}:
   (i) are joined to form an optionally substituted monocyclic aromatic ring; or
   (ii) are joined to form an optionally substituted polycyclic aromatic group;
R^{M} and R^{N}:
   (i) are joined to form an optionally substituted monocyclic aromatic ring; or
   (ii) are joined to form an optionally substituted polycyclic aromatic group;
at least one of R^{G}, R^{H}, R^{I} and R^{J} is:

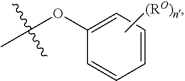

bromine or chlorine, with the other substituents being hydrogen;
each R₀ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.

In one embodiment the compound of Formula (I) is a compound of Formula (I-B):

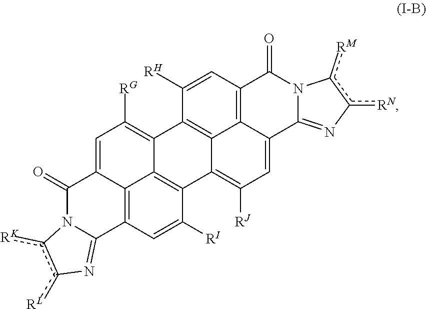

or an isomer or salt thereof, wherein:
R^{K} and R^{L}:
   (i) are joined to form an optionally substituted monocyclic aromatic ring; or
   (ii) are joined to form an optionally substituted polycyclic aromatic group;
R^{M} and R^{N}:
   (i) are joined to form an optionally substituted monocyclic aromatic ring; or
   (ii) are joined to form an optionally substituted polycyclic aromatic group;
at least one of R^{G}, R^{H}, R^{I} and R^{J} is:

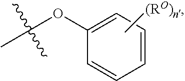

bromine or chlorine, with the other substituents being hydrogen;
each R^{O} is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.

The substituted imidazole ring may be:

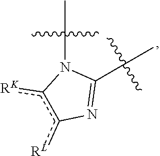

where

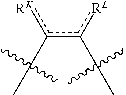

is as defined herein.

The substituted imidazole ring may be:

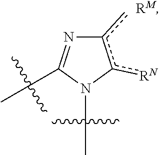

where

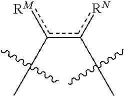

is as defined herein.

In one embodiment the compound of Formula (I) is a compound of Formula (I-A).

In one embodiment the compound of Formula (I) is a compound of Formula (I-B).

In one embodiment R^{K} and R^{L}, and/or R^{M} and R^{N} are joined to form an optionally substituted monocyclic aromatic ring.

In one embodiment R^{K} and R^{L}, and/or R^{M} and R^{N} are joined to form an optionally substituted polycyclic aromatic group.

In one embodiment: R^{K} and R^{L} are joined to form an optionally substituted monocyclic aromatic ring; and R^{M} and R^{N} are joined to form an optionally substituted monocyclic aromatic ring.

In one embodiment: R^{K} and R^{L} are joined to form an optionally substituted polycyclic aromatic group; and R^{M} and R^{N} are joined to form an optionally substituted polycyclic aromatic group.

In one embodiment: R^{K} and R^{L} are joined to form a monocyclic aromatic ring which is unsubstituted; and R^{M} and R^{N} are joined to form a monocyclic aromatic ring which is unsubstituted. In another embodiment: R^{K} and R^{L} are joined to form a monocyclic aromatic ring which is substituted; and R^{M} and R^{N} are joined to form a monocyclic aromatic ring which is substituted.

In one embodiment: R^{K} and R^{L} are joined to form a polycyclic aromatic group which is unsubstituted; and R^{M} and R^{N} are joined to form a polycyclic aromatic group which is unsubstituted. In another embodiment: R^{K} and R^{L} are joined to form a polycyclic aromatic group which is substituted; and R^{M} and R^{N} are joined to form a polycyclic aromatic group which is substituted.

The polycyclic aromatic group may comprise 2, 3, 4, 5 or 6 fused ring systems, wherein each ring is optionally substituted.

In one embodiment the optionally substituted monocyclic aromatic ring or optionally substituted polycyclic aromatic group formed by R^{K} and R^{L} is the same as the optionally substituted monocyclic aromatic ring or the optionally substituted polycyclic aromatic group formed by R^{M} and R^{N}.

Examples of monocyclic aromatic rings and polycyclic aromatic groups which may optionally be substituted in Formula (I) or Formula (II) includes, but is not limited to: phenyl, naphthalene, anthracene, phenanthrene, tetracene, chrysene, triphenylene, pyrene, pentacene, benzo[a]pyrene, and dibenz[a,h]anthracene rings, or mixtures thereof.

Other examples of monocyclic aromatic rings and polycyclic aromatic groups which may optionally be substituted in Formula (I) or Formula (II) includes, but is not limited to any one of:

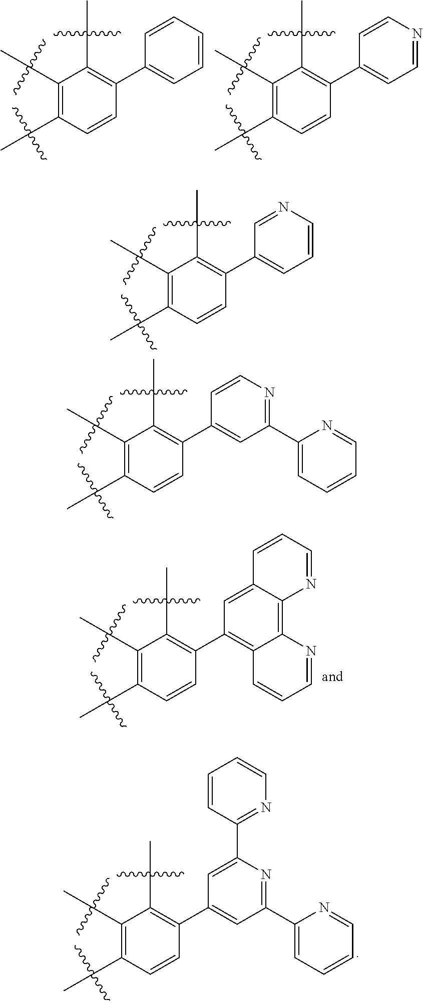

In one embodiment, the monocyclic aromatic ring or polycyclic aromatic group in Formula (I) or Formula (II) may be selected from, but not limited to, optionally substituted:

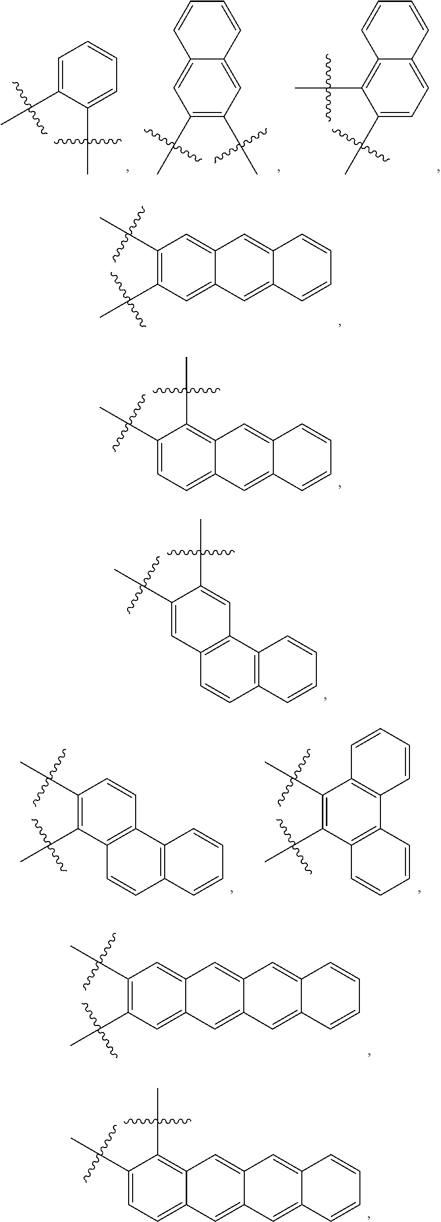

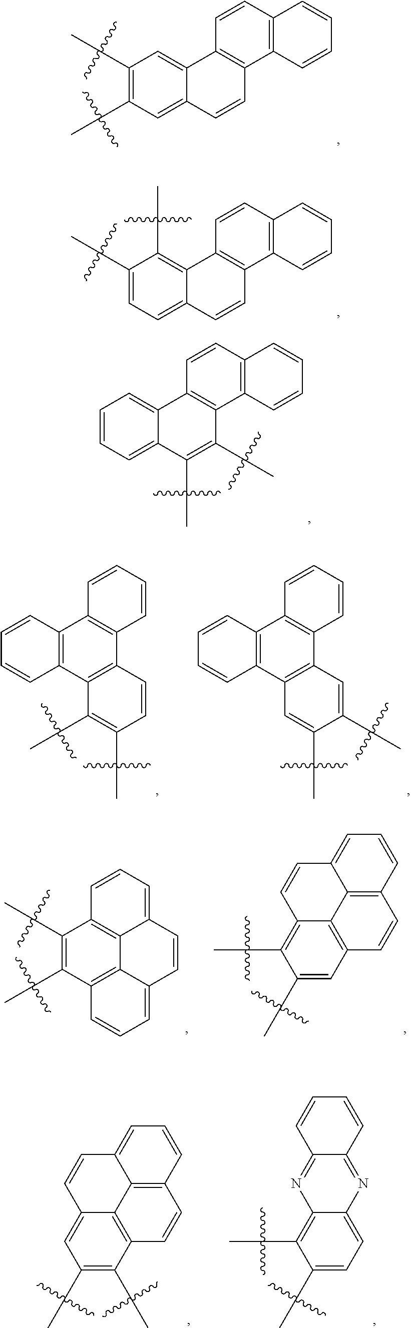

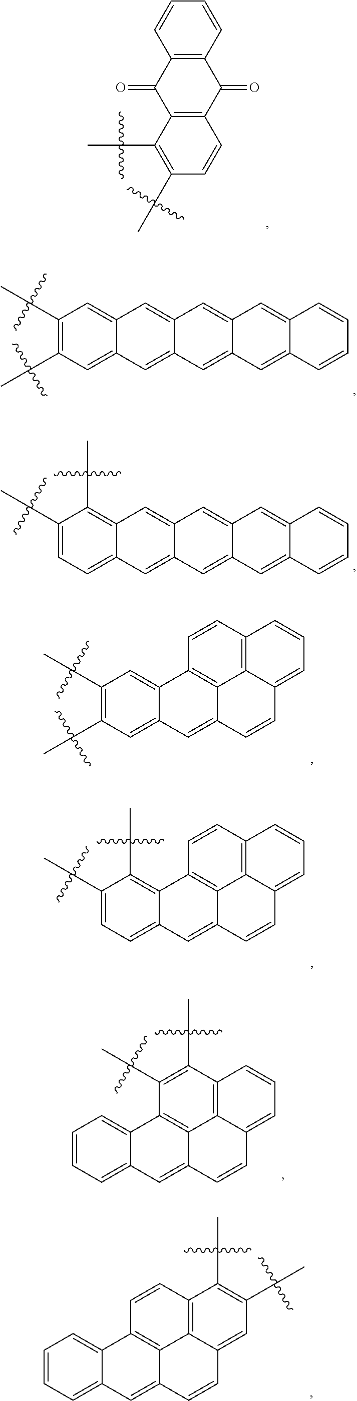

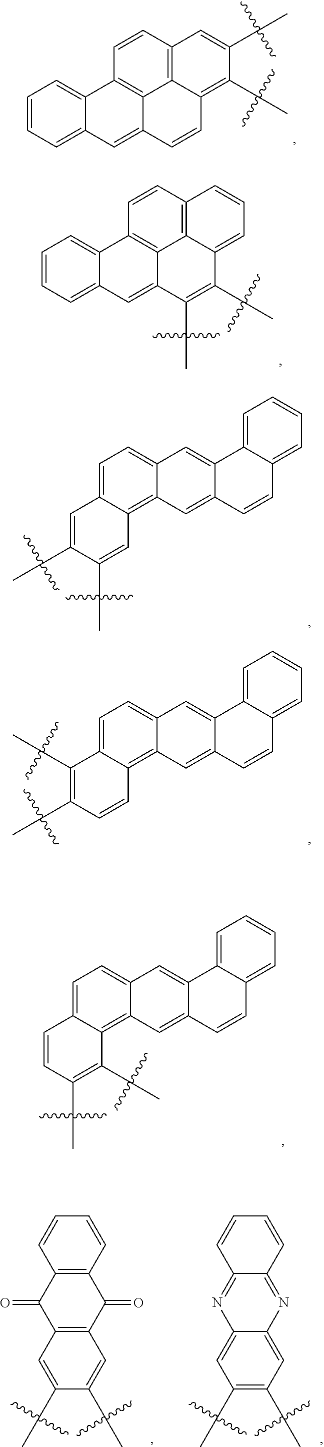

or mixtures thereof.

In another embodiment, the monocyclic aromatic ring or polycyclic aromatic group in Formula (I) or Formula (II) may be selected from, but not limited to, optionally substituted:

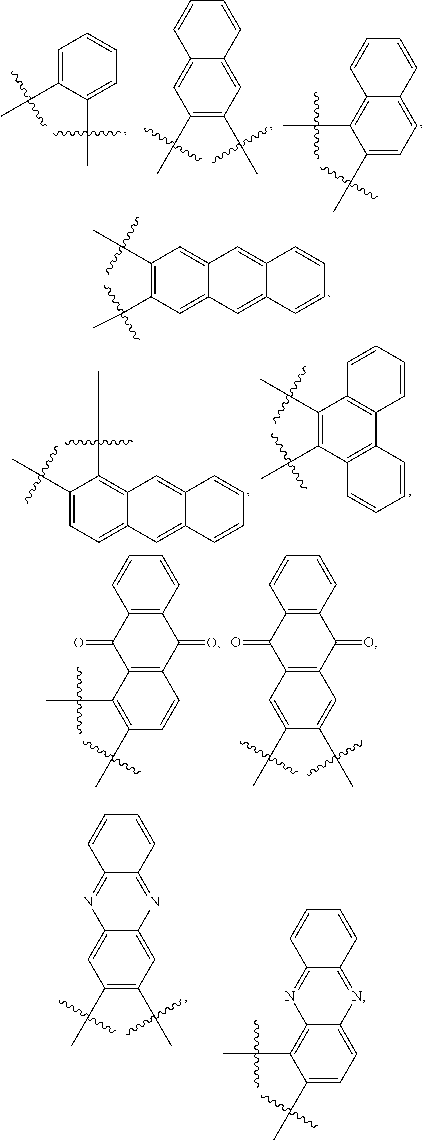

or mixtures thereof.

In yet another embodiment, the monocyclic aromatic ring in Formula (I) or Formula (II) is optionally substituted:

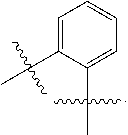 [SMILES: *c1ccccc1*]

In yet another embodiment, the polycyclic aromatic group in Formula (I) or Formula (II) is optionally substituted:

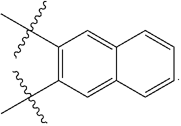 [SMILES: *c1cc2ccccc2cc1*]

In yet another embodiment, the polycyclic aromatic group in Formula (I) or Formula (II) may be selected from, but not limited to, optionally substituted:

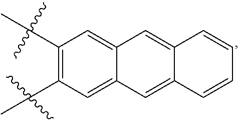 [SMILES: *c1cc2cc3ccccc3cc2cc1*]

for example

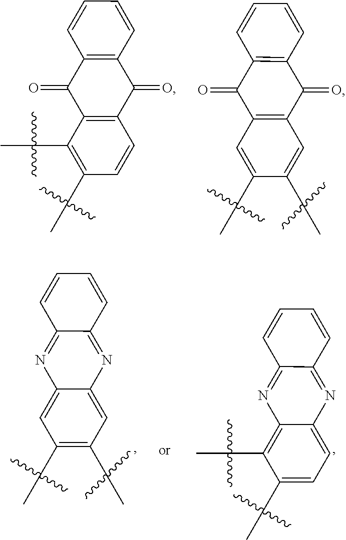

Herein, R^{A} may be O or N. In one embodiment R^{A} is O. In another embodiment R^{A} is N.

Herein R^{B} may be N.

Herein, R^{C} may be O or N. In one embodiment R^{C} is O. In another embodiment R^{C} is N.

Herein, R^{D} may be O or N. In one embodiment R^{D} is O. In another embodiment R^{D} is N.

Herein R^{E} may be N.

Herein, R^{F} may be O or N. In one embodiment R^{F} is O. In another embodiment R^{F} is N.

For each

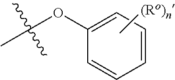

group, each R^{O} group may be an optionally substituted: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene. For example, R^{O} may be an optionally substituted C₁-C₁₂ branched or straight chain alkyl group. R^{O} may be an optionally substituted tert-butyl group and/or a C₁₂ straight chain alkyl group, or a C₁₂H₂₅ isomer.

In addition, each R^{O} may be selected from, but not limited to an optionally substituted: aryl, heteroaryl, pyridine, bipyridine, terpyridine or phenanthroline group.

In one embodiment one or more R^{O} groups is an optionally substituted alkyl group.

In another embodiment one or more R^{O} groups are an optionally substituted perylene. Examples of optionally substituted perylenes include those disclosed in: WO 2015/024064 A1, ChemPhysChem, 2011, 12, 595-608; J. AM. CHEM SOC., 2004, 126, 8284-8294; Eur. J. Org. Chem., 2008, 4559-4562; J. Mater. Chem., 2010, 20, 3814-3826; Angew Chem Int Ed, 2002, 41(11), 1900; and Chem. Eur. J., 2004, 10, 1398-1414, the content of each is incorporated by reference.

Integer n′ may be selected from 0, 1, 2, 3, 4 or 5. In one embodiment n′ is 0. In another embodiment n′ is 1. In yet another embodiment, n′ is 2. In yet another embodiment, n′ is 3

When n′ is 2 or greater, each R^{O} group may be the same or different.

In one embodiment an article or device described herein comprises one or more compounds of Formula (II):

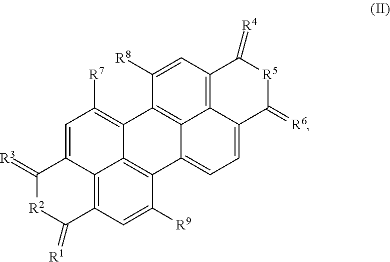

or an isomer or salt thereof, wherein:
either:
   (i) R¹ is O, R² is N, R³ is N, and R² and R³ are joined by a

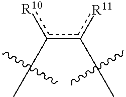

group to form a substituted imidazole group; or
(ii) R³ is O, R² is N, R¹ is N, and R¹ and R² are joined by a

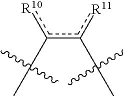

group to form a substituted imidazole group;
either:
   (i) R⁴ is O, R⁵ is N, R⁶ is N, and R⁵ and R⁶ are joined by a

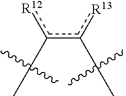

group to form a substituted imidazole group; or
(ii) R⁶ is O, R⁵ is N, R⁴ is N, and R⁴ and R⁵ are joined by a

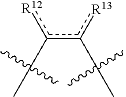

group to form a substituted imidazole group;
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

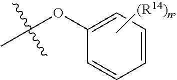

chlorine or bromine, with the proviso that one of R⁷ or R⁸ is

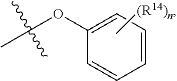

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment, in compounds of Formula (II), R¹ is O, R² is N, R³ is N and R² and R³ are joined by a by a

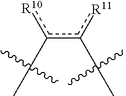

group to form a substituted imidazole group, for example a

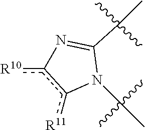

group.

In one embodiment, in compounds of Formula (II), R¹ is N, R² is N, R³ is O and R² and R¹ are joined by a by a

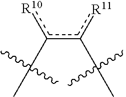

group to form a substituted imidazole group, for example a

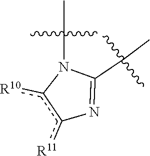

group.

In one embodiment, in compounds of Formula (II), R⁴ is O, R⁵ is N, R⁶ is N and R⁵ and R⁶ are joined by a by a

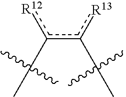

group to form a substituted imidazole group, for example a

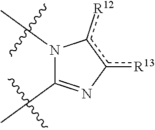

group.

In one embodiment, in compounds of Formula (II), R⁶ is O, R⁵ is N, R⁴ is N and R⁵ and R⁴ are joined by a by a

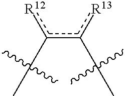

group to form a substituted imidazole group, for example a

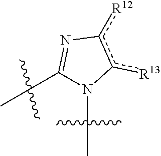

group.

The compound of Formula (II) can exist as two geometric isomer a syn isomer and an anti isomer.

In one embodiment the compound of Formula (II) is a compound of Formula (II-A):

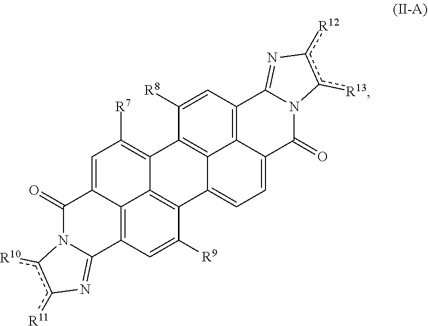

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

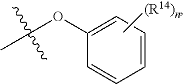

chlorine or bromine, with the proviso that one of R⁷ or R⁸ is

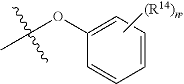

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-A1):

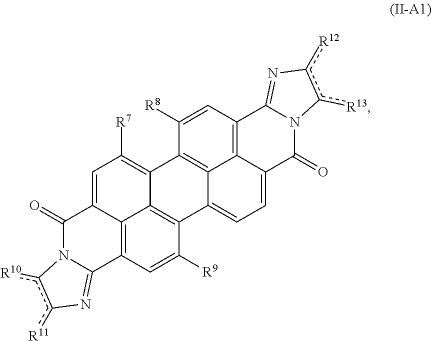

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

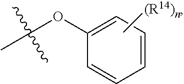

with the proviso that one of R⁷ or R⁸ is

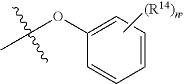

and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-A2):

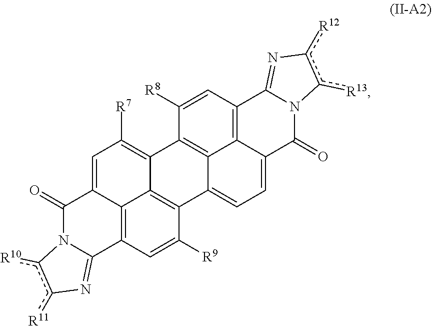

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is chlorine or bromine, with the proviso that that one of R⁷ and R⁸ is bromine or chlorine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-B):

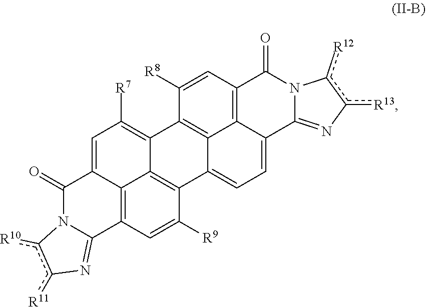

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

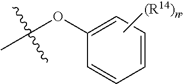

chlorine or bromine, with the proviso that one of R⁷ or R⁸ is

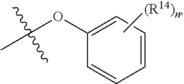

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-B1):

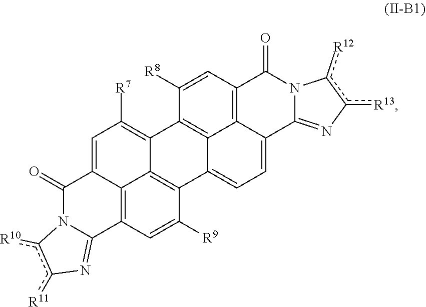

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

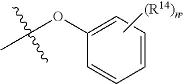

with the proviso that one of R⁷ or R⁸ is

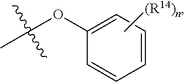

and the other is hydrogen
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-B2):

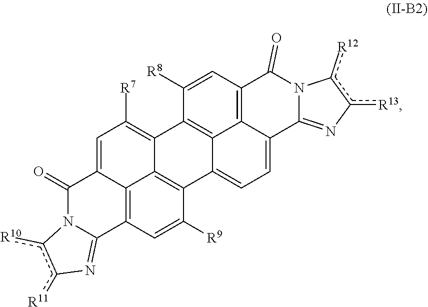

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is chlorine or bromine, with the proviso that that one of R⁷ and R⁸ is bromine or chlorine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-C):

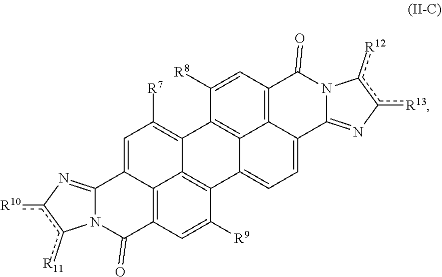

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

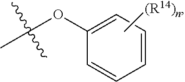

chlorine or bromine, with the proviso that one of R⁷ or R⁸ is

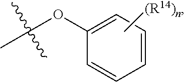

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-C1):

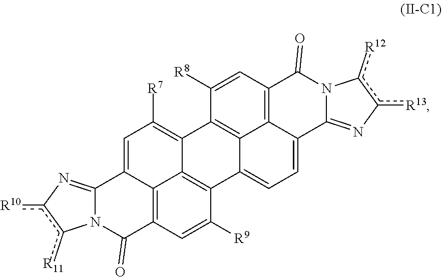

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

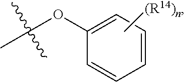

with the proviso that one of R⁷ or R⁸ is

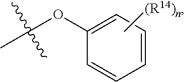

and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-C2):

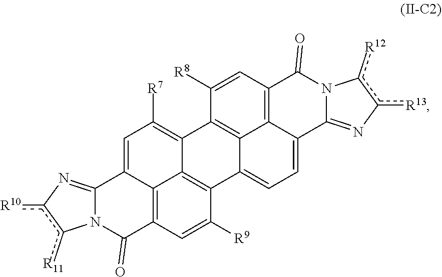

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is chlorine or bromine, with the proviso that that one of R⁷ and R⁸ is bromine or chlorine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-D):

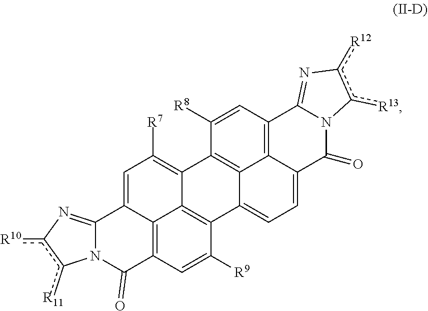

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

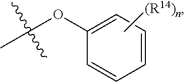

chlorine or bromine, with the proviso that one of R⁷ or R⁸ is

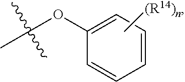

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-D1):

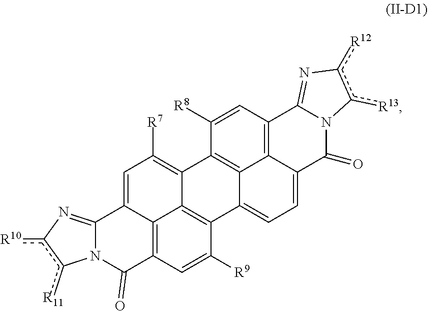

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is

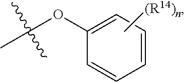

with the proviso that one of R⁷ or R⁸ is

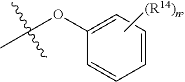

and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-D2):

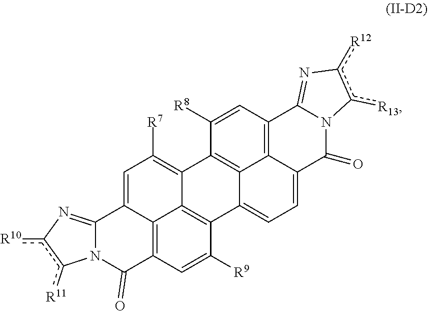

or an isomer or salt thereof, wherein:
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is chlorine or bromine, with the proviso that that one of R⁷ and R⁸ is bromine or chlorine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

In one embodiment the compound of Formula (II) is a compound of Formula (II-A). In one embodiment the compound of Formula (II) is a compound of Formula (II-A1). In one embodiment the compound of Formula (II) is a compound of Formula (II-A2).

In one embodiment the compound of Formula (II) is a compound of Formula (II-B). In one embodiment the compound of Formula (II) is a compound of Formula (II-B1). In one embodiment the compound of Formula (II) is a compound of Formula (II-B2).

In one embodiment the compound of Formula (II) is a compound of Formula (II-C). In one embodiment the compound of Formula (II) is a compound of Formula (II-C1). In one embodiment the compound of Formula (II) is a compound of Formula (II-C2).

In one embodiment the compound of Formula (II) is a compound of Formula (II-D). In one embodiment the compound of Formula (II) is a compound of Formula (II-D1). In one embodiment the compound of Formula (II) is a compound of Formula (II-D2).

In one embodiment R¹⁰ and R¹¹, and/or R¹² and R¹³ are joined to form an optionally substituted monocyclic aromatic ring.

In one embodiment R¹⁰ and R¹¹, and/or R¹² and R¹³ are joined to form an optionally substituted polycyclic aromatic group.

In one embodiment: R¹⁰ and R¹¹ are joined to form an optionally substituted monocyclic aromatic ring; and R¹² and R¹³ are joined to form an optionally substituted monocyclic aromatic ring. In one embodiment these monocyclic aromatic rings are unsubstituted. In another embodiment these monocyclic aromatic rings are each substituted.

In one embodiment: R¹⁰ and R¹¹ are joined to form an optionally substituted polycyclic aromatic group; and R¹² and R¹³ are joined to form an optionally substituted polycyclic aromatic group. In one embodiment these polycyclic aromatic groups are unsubstituted. In another embodiment these polycyclic aromatic groups are each substituted.

The polycyclic aromatic group may comprise 2, 3, 4, 5 or 6 fused ring systems, wherein each ring is optionally substituted.

In one embodiment the optionally substituted monocyclic aromatic ring or optionally substituted polycyclic aromatic group formed by R¹⁰ and R¹¹ is the same as the optionally substituted monocyclic aromatic ring or the optionally substituted polycyclic aromatic group formed by R¹² and R¹³.

For compounds of Formula (II), (II-A), (II-B), (II-C) or (II-D), two of R⁷, R⁸ and R⁹ may be

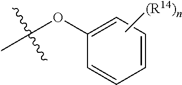

and the remaining group is hydrogen.

Herein, R¹ may be O or N. In one embodiment R¹ is O. In another embodiment R¹ is N.

Herein, R² may be N.

Herein, R³ may be O or N. In one embodiment R³ is O. In another embodiment R³ is N.

Herein, R⁴ may be O or N. In one embodiment R⁴ is O. In another embodiment R⁴ is N.

Herein, R⁵ may be N.

Herein, R⁶ may be O or N. In one embodiment R⁶ is O. In another embodiment R¹⁶ is N.

R⁷ and R⁹ may both be

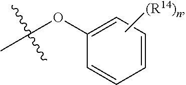

whilst R⁸ is hydrogen.

R⁸ and R⁹ may both be

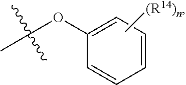

whilst R⁷ is hydrogen.

For compounds of Formula (II), (II-A), (II-B), (II-C) or (II-D), two of R⁷, R⁸ and R⁹ may be bromine or chlorine, and the remaining group is hydrogen.

R⁷ and R⁹ may both be bromine, whilst R⁸ is hydrogen.

R⁸ and R⁹ may both be bromine, whilst R⁷ is hydrogen.

R⁷ and R⁹ may both be chlorine, whilst R⁸ is hydrogen.

R⁸ and R⁹ may both be chlorine, whilst R⁷ is hydrogen.

Each R¹⁴ group may be an optionally substituted: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene. For example, R¹⁴ may be an optionally substituted C₁-C₁₂ branched and/or straight chain alkyl group. R¹⁴ may be an optionally substituted tert-butyl group, C₁₂ straight chain alkyl group and/or a C₁₂H₂₅ isomer.

In addition, each R¹⁴ may be selected from, but not limited to an optionally substituted appended: aryl, heteroaryl, pyridine, bipyridine, terpyridine or phenanthroline group.

Herein, each R^{O} or R¹⁴ may be selected from:

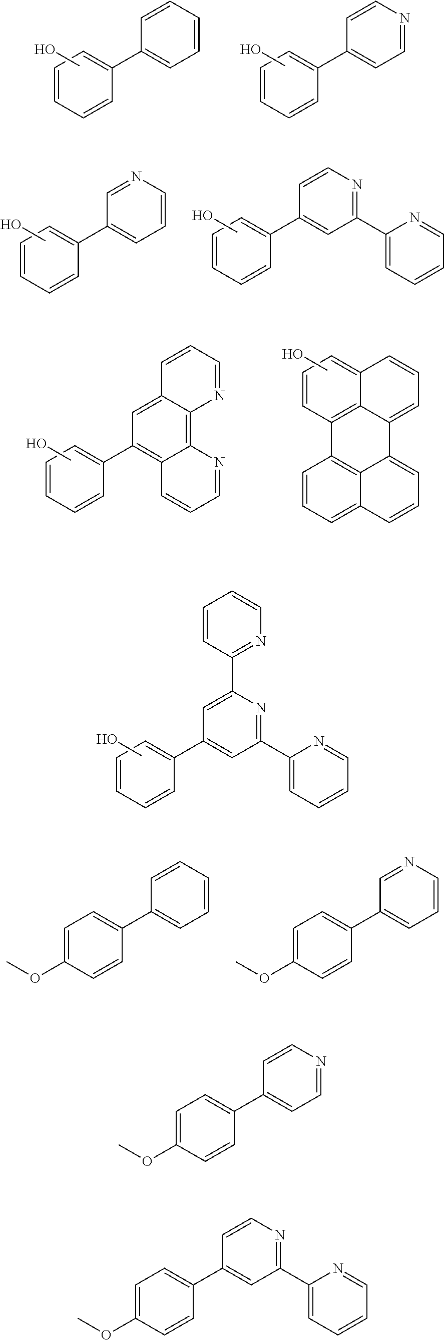

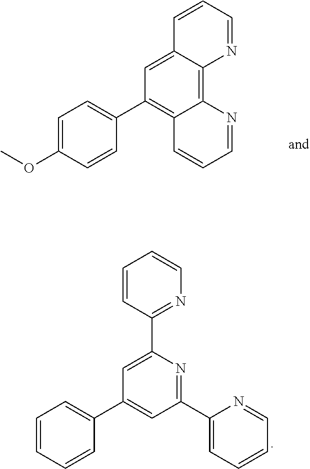 [SMILES: COc1ccc(-c2cc3cccnc3c3ncccc23)cc1 ; c1ccc(-c2cc(-c3ccccn3)nc(-c3ccccn3)c2)cc1]

In one embodiment R¹⁴ is an optionally substituted alkyl group.

In another embodiment R¹⁴ is an optionally substituted perylene. Examples of optionally substituted perylenes include those disclosed in: WO 2015/024064 A1, ChemPhysChem, 2011, 12, 595-608; J. Am. Chem. Soc., 2004, 126, 8284-8294; Eur. J. Org. Chem., 2008, 4559-4562; J. Mater. Chem., 2010, 20, 3814-3826; Angew Chem Int Ed, 2002, 41(11), 1900; and Chem. Eur. J., 2004, 10, 1398-1414, the content of each is incorporated by reference.

Integer “n” may be selected from 0, 1, 2, 3, 4 or 5. In one embodiment n is 0. In another embodiment n is 1. In yet another embodiment, n is 2. In yet another embodiment, n is 3.

When n is 2 or greater, each R¹⁴ group may be the same or different.

Examples of compounds of Formula (II), (II-A), (II-B), (II-C) or (II-D) include compounds where R⁷, R⁸, R⁹, and the combinations of: R¹⁰ and R¹¹; and R¹² and R¹³, are limited to the following optionally substituted substituents in Table 2:

TABLE 2
Exemplified substituents

| R¹⁰ and R¹¹ | R¹² and R¹³ | R⁷ | R⁸ | R⁹ |
|---|---|---|---|---|
| 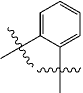 [SMILES: *c1ccccc1*] | 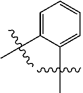 [SMILES: *c1ccccc1*] | 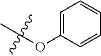 [SMILES: *Oc1ccccc1] | H | 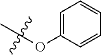 [SMILES: *Oc1ccccc1] |
| 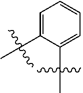 [SMILES: *c1ccccc1*] | 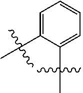 [SMILES: *c1ccccc1*] | H | 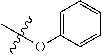 [SMILES: *Oc1ccccc1] | 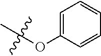 [SMILES: *Oc1ccccc1] |
| 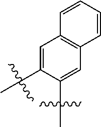 [SMILES: *c1cc2ccccc2cc1*] | 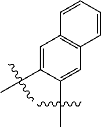 [SMILES: *c1cc2ccccc2cc1*] | 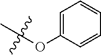 [SMILES: *Oc1ccccc1] | H | 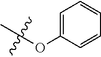 [SMILES: *Oc1ccccc1] |
| 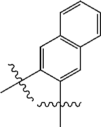 [SMILES: *c1cc2ccccc2cc1*] | 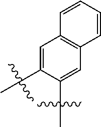 [SMILES: *c1cc2ccccc2cc1*] | H | 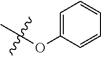 [SMILES: *Oc1ccccc1] | 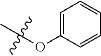 [SMILES: *Oc1ccccc1] |
| 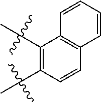 [SMILES: *c1ccc2ccccc2c1*] | 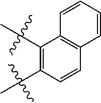 [SMILES: *c1ccc2ccccc2c1*] | 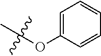 [SMILES: *Oc1ccccc1] | H | 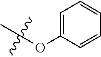 [SMILES: *Oc1ccccc1] |
| 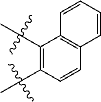 [SMILES: *c1ccc2ccccc2c1*] | 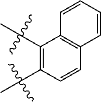 [SMILES: *c1ccc2ccccc2c1*] | H | 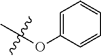 [SMILES: *Oc1ccccc1] | 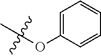 [SMILES: *Oc1ccccc1] |
| 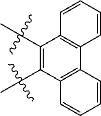 [SMILES: *c1c(*)c2ccccc2c2ccccc12] | 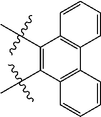 [SMILES: *c1c(*)c2ccccc2c2ccccc12] | 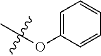 [SMILES: *Oc1ccccc1] | H | 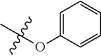 [SMILES: *Oc1ccccc1] |
| 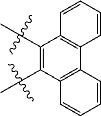 [SMILES: *c1c(*)c2ccccc2c2ccccc12] | 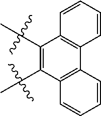 [SMILES: *c1c(*)c2ccccc2c2ccccc12] | H | 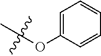 [SMILES: *Oc1ccccc1] | 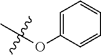 [SMILES: *Oc1ccccc1] |
| 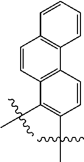 [SMILES: *c1ccc2c(ccc3ccccc32)c1*] | 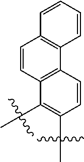 [SMILES: *c1ccc2c(ccc3ccccc32)c1*] | 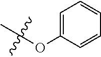 [SMILES: *Oc1ccccc1] | H | 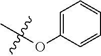 [SMILES: *Oc1ccccc1] |
| 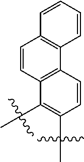 [SMILES: *c1ccc2c(ccc3ccccc32)c1*] | 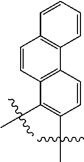 [SMILES: *c1ccc2c(ccc3ccccc32)c1*] | H | 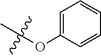 [SMILES: *Oc1ccccc1] | 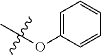 [SMILES: *Oc1ccccc1] |
| 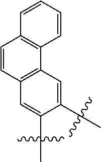 [SMILES: *c1cc2ccc3ccccc3c2cc1*] | 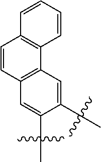 [SMILES: *c1cc2ccc3ccccc3c2cc1*] | 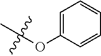 [SMILES: *Oc1ccccc1] | H | 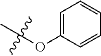 [SMILES: *Oc1ccccc1] |
| 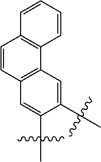 [SMILES: *c1cc2ccc3ccccc3c2cc1*] | 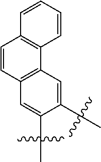 [SMILES: *c1cc2ccc3ccccc3c2cc1*] | H | 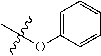 [SMILES: *Oc1ccccc1] | 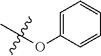 [SMILES: *Oc1ccccc1] |
| 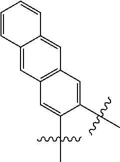 [SMILES: *c1cc2cc3ccccc3cc2cc1*] | 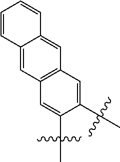 [SMILES: *c1cc2cc3ccccc3cc2cc1*] | 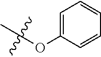 [SMILES: *Oc1ccccc1] | H | 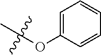 [SMILES: *Oc1ccccc1] |
| 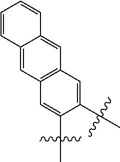 [SMILES: *c1cc2cc3ccccc3cc2cc1*] | 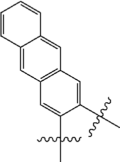 [SMILES: *c1cc2cc3ccccc3cc2cc1*] | H | 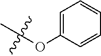 [SMILES: *Oc1ccccc1] | 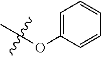 [SMILES: *Oc1ccccc1] |
| 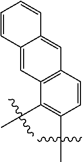 [SMILES: *c1ccc2cc3ccccc3cc2c1*] | 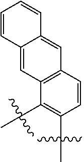 [SMILES: *c1ccc2cc3ccccc3cc2c1*] | 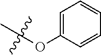 [SMILES: *Oc1ccccc1] | H | 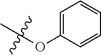 [SMILES: *Oc1ccccc1] |
| 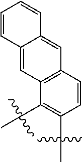 [SMILES: *c1ccc2cc3ccccc3cc2c1*] | 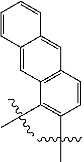 [SMILES: *c1ccc2cc3ccccc3cc2c1*] | H | 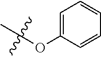 [SMILES: *Oc1ccccc1] | 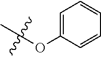 [SMILES: *Oc1ccccc1] |
| 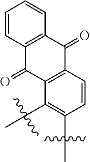 [SMILES: *c1ccc2c(c1*)C(=O)c1ccccc1C2=O] | 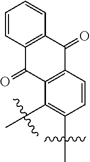 [SMILES: *c1ccc2c(c1*)C(=O)c1ccccc1C2=O] | 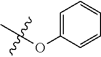 [SMILES: *Oc1ccccc1] | H | 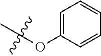 [SMILES: *Oc1ccccc1] |
| 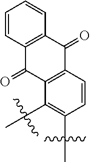 [SMILES: *c1ccc2c(c1*)C(=O)c1ccccc1C2=O] | 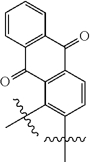 [SMILES: *c1ccc2c(c1*)C(=O)c1ccccc1C2=O] | H | 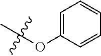 [SMILES: *Oc1ccccc1] | 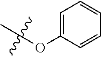 [SMILES: *Oc1ccccc1] |
| 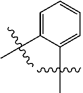 [SMILES: *c1ccccc1*] | 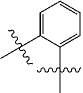 [SMILES: *c1ccccc1*] | 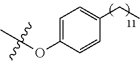 | H | 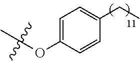 |
| 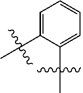 [SMILES: *c1ccccc1*] | 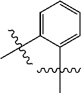 [SMILES: *c1ccccc1*] | H | 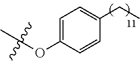 | 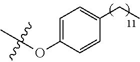 |
| 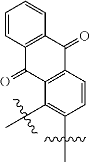 [SMILES: *c1ccc2c(c1*)C(=O)c1ccccc1C2=O] | 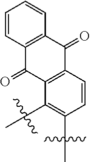 [SMILES: *c1ccc2c(c1*)C(=O)c1ccccc1C2=O] | 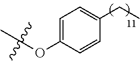 | H | 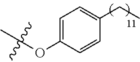 |
| 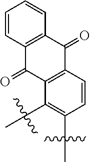 [SMILES: *c1ccc2c(c1*)C(=O)c1ccccc1C2=O] | 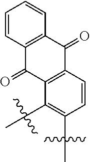 [SMILES: *c1ccc2c(c1*)C(=O)c1ccccc1C2=O] | H | 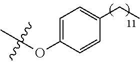 | 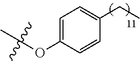 |
| 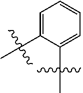 [SMILES: *c1ccccc1*] | 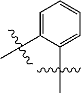 [SMILES: *c1ccccc1*] | 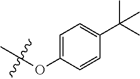 [SMILES: *Oc1ccc(C(C)(C)C)cc1] | H | 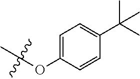 [SMILES: *Oc1ccc(C(C)(C)C)cc1] |
| 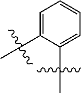 [SMILES: *c1ccccc1*] | 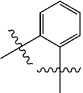 [SMILES: *c1ccccc1*] | H | 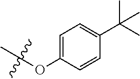 [SMILES: *Oc1ccc(C(C)(C)C)cc1] | 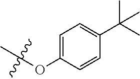 [SMILES: *Oc1ccc(C(C)(C)C)cc1] |
| 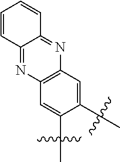 [SMILES: *c1cc2nc3ccccc3nc2cc1*] | 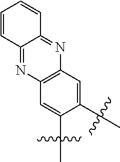 [SMILES: *c1cc2nc3ccccc3nc2cc1*] | 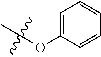 [SMILES: *Oc1ccccc1] | H | 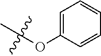 [SMILES: *Oc1ccccc1] |
| 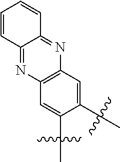 [SMILES: *c1cc2nc3ccccc3nc2cc1*] | 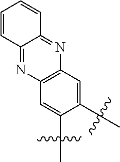 [SMILES: *c1cc2nc3ccccc3nc2cc1*] | H | 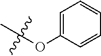 [SMILES: *Oc1ccccc1] | 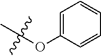 [SMILES: *Oc1ccccc1] |
| 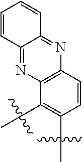 [SMILES: *c1ccc2nc3ccccc3nc2c1*] | 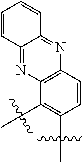 [SMILES: *c1ccc2nc3ccccc3nc2c1*] | 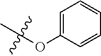 [SMILES: *Oc1ccccc1] | H | 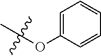 [SMILES: *Oc1ccccc1] |
| 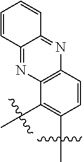 [SMILES: *c1ccc2nc3ccccc3nc2c1*] | 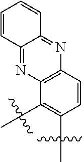 [SMILES: *c1ccc2nc3ccccc3nc2c1*] | H | 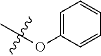 [SMILES: *Oc1ccccc1] | 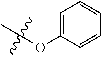 [SMILES: *Oc1ccccc1] |

Examples of compounds of Formula (II), (II-A), (II-B), (II-C) or (II-D) include compounds where R⁷, R⁸, R⁹, and the combinations of: R¹⁰ and R¹¹; and R¹² and R¹³, are limited to the following optionally substituted substituents in Table 3:

TABLE 3
Exemplified substituents

| R¹⁰ and R¹¹ | R¹² and R¹³ | R⁷ | R⁸ | R⁹ |
|---|---|---|---|---|
| 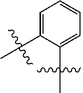 [SMILES: *c1ccccc1*] | 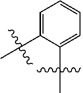 [SMILES: *c1ccccc1*] | Br | H | Br |
| 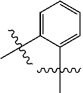 [SMILES: *c1ccccc1*] | 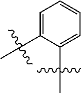 [SMILES: *c1ccccc1*] | H | Br | Br |
| 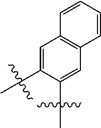 [SMILES: *c1cc2ccccc2cc1*] | 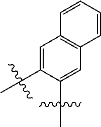 [SMILES: *c1cc2ccccc2cc1*] | Br | H | Br |
| 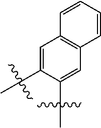 [SMILES: *c1cc2ccccc2cc1*] | 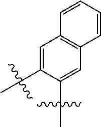 [SMILES: *c1cc2ccccc2cc1*] | H | Br | Br |
| 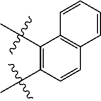 [SMILES: *c1ccc2ccccc2c1*] | 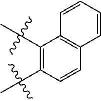 [SMILES: *c1ccc2ccccc2c1*] | Br | H | Br |
| 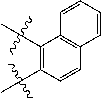 [SMILES: *c1ccc2ccccc2c1*] | 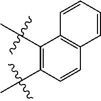 [SMILES: *c1ccc2ccccc2c1*] | H | Br | Br |
| 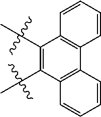 [SMILES: *c1c(*)c2ccccc2c2ccccc12] | 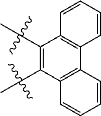 [SMILES: *c1c(*)c2ccccc2c2ccccc12] | Br | H | Br |
| 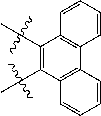 [SMILES: *c1c(*)c2ccccc2c2ccccc12] | 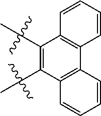 [SMILES: *c1c(*)c2ccccc2c2ccccc12] | H | Br | Br |
| 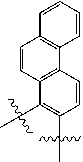 [SMILES: *c1ccc2c(ccc3ccccc32)c1*] | 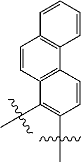 [SMILES: *c1ccc2c(ccc3ccccc32)c1*] | Br | H | Br |
| 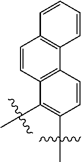 [SMILES: *c1ccc2c(ccc3ccccc32)c1*] | 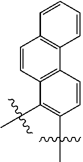 [SMILES: *c1ccc2c(ccc3ccccc32)c1*] | H | Br | Br |
| 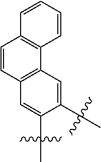 [SMILES: *c1cc2ccc3ccccc3c2cc1*] | 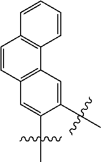 [SMILES: *c1cc2ccc3ccccc3c2cc1*] | Br | H | Br |
| 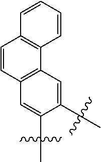 [SMILES: *c1cc2ccc3ccccc3c2cc1*] | 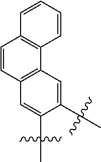 [SMILES: *c1cc2ccc3ccccc3c2cc1*] | H | Br | Br |
| 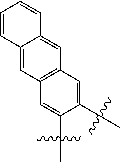 [SMILES: *c1cc2cc3ccccc3cc2cc1*] | 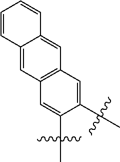 [SMILES: *c1cc2cc3ccccc3cc2cc1*] | Br | H | Br |
| 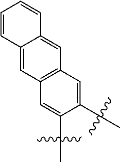 [SMILES: *c1cc2cc3ccccc3cc2cc1*] | 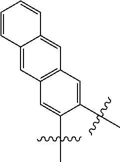 [SMILES: *c1cc2cc3ccccc3cc2cc1*] | H | Br | Br |
| 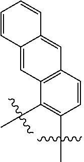 [SMILES: *c1ccc2cc3ccccc3cc2c1*] | 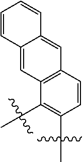 [SMILES: *c1ccc2cc3ccccc3cc2c1*] | Br | H | Br |
| 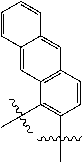 [SMILES: *c1ccc2cc3ccccc3cc2c1*] | 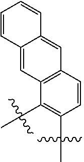 [SMILES: *c1ccc2cc3ccccc3cc2c1*] | H | Br | Br |
| 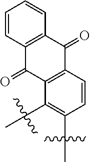 [SMILES: *c1ccc2c(c1*)C(=O)c1ccccc1C2=O] | 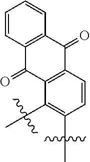 [SMILES: *c1ccc2c(c1*)C(=O)c1ccccc1C2=O] | Br | H | Br |
| 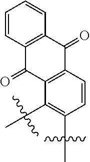 [SMILES: *c1ccc2c(c1*)C(=O)c1ccccc1C2=O] | 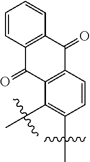 [SMILES: *c1ccc2c(c1*)C(=O)c1ccccc1C2=O] | H | Br | Br |
| 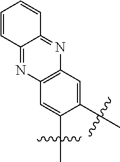 [SMILES: *c1cc2nc3ccccc3nc2cc1*] | 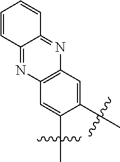 [SMILES: *c1cc2nc3ccccc3nc2cc1*] | Br | H | Br |
| 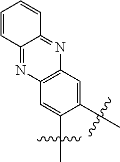 [SMILES: *c1cc2nc3ccccc3nc2cc1*] | 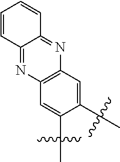 [SMILES: *c1cc2nc3ccccc3nc2cc1*] | H | Br | Br |
| 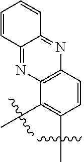 [SMILES: *c1ccc2nc3ccccc3nc2c1*] | 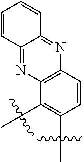 [SMILES: *c1ccc2nc3ccccc3nc2c1*] | Br | H | Br |
| 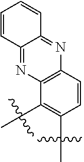 [SMILES: *c1ccc2nc3ccccc3nc2c1*] | 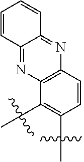 [SMILES: *c1ccc2nc3ccccc3nc2c1*] | H | Br | Br |
| 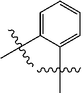 [SMILES: *c1ccccc1*] | 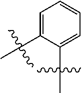 [SMILES: *c1ccccc1*] | H | 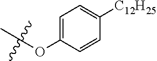 | 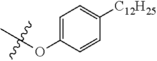 |
| 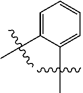 [SMILES: *c1ccccc1*] | 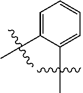 [SMILES: *c1ccccc1*] | 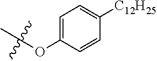 | H | 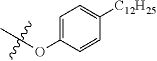 |

Alternative compounds in Table 3 are where the Br substituents are replaced with Cl substituents.

A compound of a compound of: Formula (I), Formula (I-A), Formula (I-B), Formula (II), Formula (II-A), Formula (II-A1), Formula (II-A2), Formula (II-B), Formula (II-B1), Formula (II-B2), Formula (II-C), Formula (II-C1), Formula (II-C2), Formula (II-D), Formula (II-D1), and/or Formula (II-D2), may have a purity in a range of about 85 to about 95%. Alternatively a compound of: Formula (I), Formula (I-A), Formula (I-B), Formula (II), Formula (II-A), Formula (II-A1), Formula (II-A2), Formula (II-B), Formula (II-B1), Formula (II-B2), Formula (II-C), Formula (II-C1), Formula (II-C2), Formula (II-D), Formula (II-D1), and/or Formula (II-D2), may have a purity of: at least 95%, at least 96%, at least 97%, at least 98% or a purity of greater than 98%.

In another embodiment, an article or device described herein may have more than one type of dye, for example one or more auxiliary dyes with shorter wavelength absorbance and/or fluorescence to generate fluorescence that is absorbed by other dyes described herein, for example one or more perylene based dyes. This may help to shift a greater proportion of an incident light source, e.g., an artificial light source or solar, to have wavelengths that are well absorbed by one or more of the other dyes, which may be low energy dyes, to enhance the amount of fluorescence the low energy dyes can produce. Low energy dyes may be dyes having a lower absorption frequency, lower luminescence emission maxima and/or a longer wavelength. This can create a “donor/acceptor “relationship between different types of dye present in an article and/or device. The donor dyes can be dispersed within the same sheet as the acceptor dyes or they can be in a separate layer of film that is placed above or below the acceptor sheet.

Examples of auxiliary dyes include, but are not limited to any dye, or mixture thereof selected from the following group:

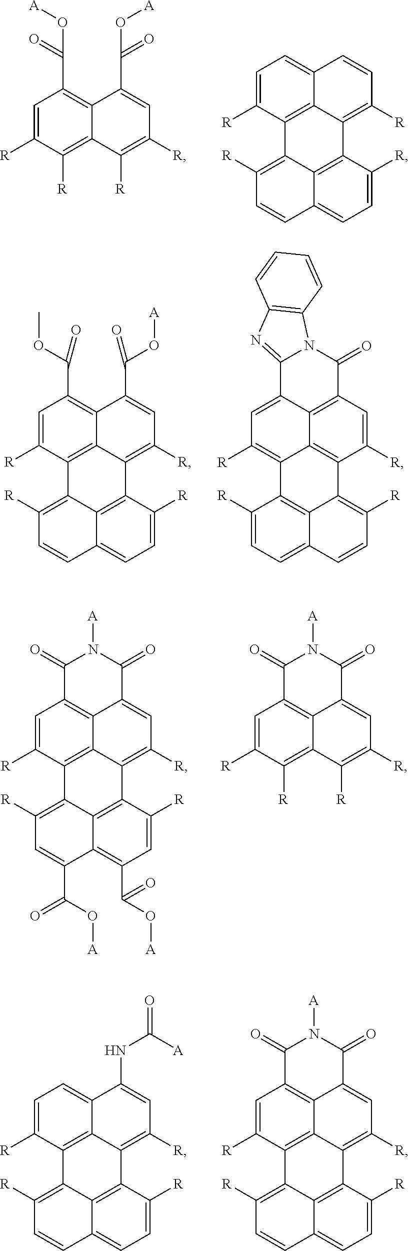

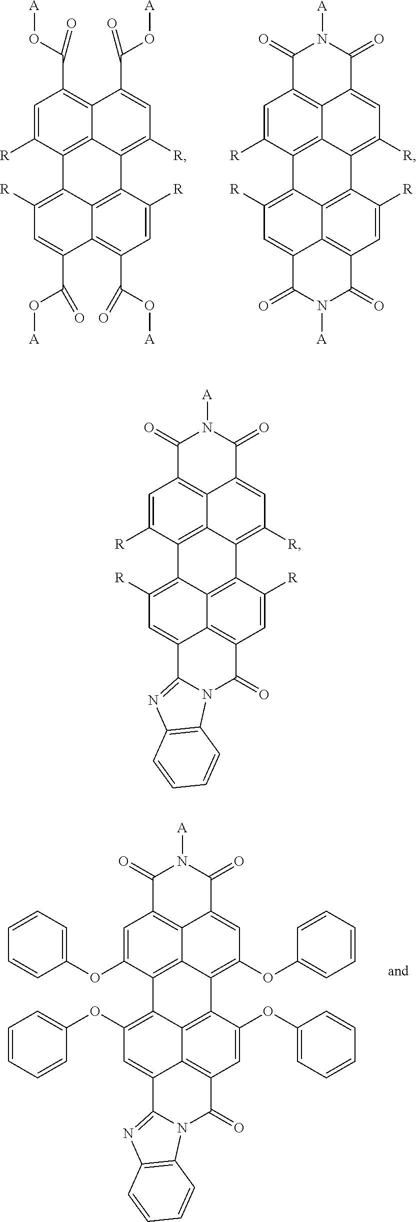

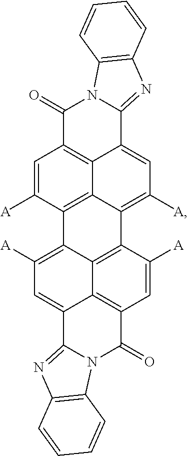

or salts thereof,
wherein in each compound:
R is selected from hydrogen, chlorine, an optionally substituted alkyl, an unsubstituted phenoxy group or a substituted phenoxy group; and
A is selected from hydrogen, optionally substituted alkyl, optionally substituted aryl, optionally substituted hetereoaryl or optionally substituted heterocycle.

In one embodiment each R group is hydrogen.

In another embodiment each R group is chlorine.

In another embodiment each R group is an unsubstituted phenoxy.

In another embodiment each R group is a substituted phenoxy.

In another embodiment each R group which is a phenoxy or substituted phenoxy group may be a

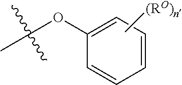

group as defined herein.

In one embodiment each R group is

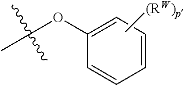

and each R^{W} is optionally a tert-butyl group (for example a 4-tert-butyl group), or a dodecyl group (for example a 4-dodecyl group), or an isomer of C₁₂H₂₅. Herein, p′ may be 0, 1, 2, 3, 4 or 5.

In one embodiment each A group is hydrogen.

In another embodiment each A group is an optionally substituted alkyl.

In another embodiment each A group is an optionally substituted aryl

In another embodiment each A group is an optionally substituted heteroaryl.

In another embodiment each A group is an optionally substituted heterocycle.

In the auxiliary dyes, each A group which is a phenoxy or substituted phenoxy group may be a

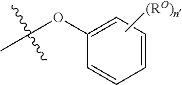

group as defined herein.

In one embodiment each A group is

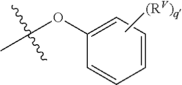

and each R^{V} is optionally a tert-butyl group (for example a 4-tert-butyl group), or a dodecyl group (for example a 4-dodecyl group), or an isomer of C₁₂H₂₅. Herein, q′ may be 0, 1, 2, 3, 4 or 5.

The auxiliary dye may be a compound of Formula (III):

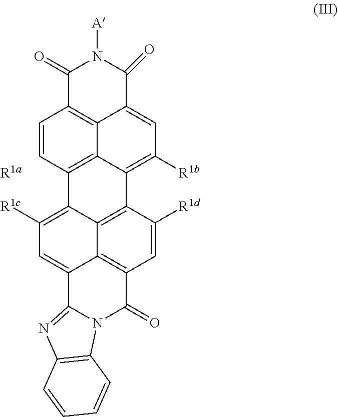

wherein:
R^{1a}, R^{1b}, R^{1c} and R^{1d} are each independently: hydrogen, chlorine, bromine, phenoxy, or substituted phenoxy, with the proviso that at least two of R^{1a}, R^{1b}, R^{1c} and R^{1d} are hydrogen; and
A′ is selected from hydrogen, optionally substituted alkyl, optionally substituted aryl, optionally substituted hetereoaryl or optionally substituted heterocycle.

In one embodiment A′ is hydrogen.

In another embodiment A′ is an optionally substituted alkyl.

In another embodiment A′ is an optionally substituted aryl

In another embodiment A′ is an optionally substituted heteroaryl.

In one embodiment one or more of R^{1a}, R^{1b}, R^{1c} and/or R^{1d} may be

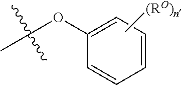

as defined herein.

In another embodiment one or more of R^{1a}, R^{1b}, R^{1c} and/or R^{1d} may be

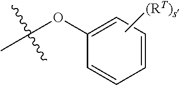

and each R^{T} is optionally a tert-butyl group (for example a 4-tert-butyl group), or a dodecyl group (for example a 4-dodecyl group), or an isomer of C₁₂H₂₅. Herein, s′ may be 0, 1, 2, 3, 4 or 5.

In another embodiment the auxiliary dye may be a compound of Formula (I) selected from a compound in Table 4:

TABLE 4
Exemplary auxiliary dyes

| R^{K} and R^{L} | R^{M} and R^{N} | R^{G} | R^{H} | R^{I} | R^{J} |
|---|---|---|---|---|---|
| 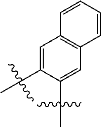 [SMILES: *c1cc2ccccc2cc1*] | 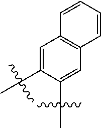 [SMILES: *c1cc2ccccc2cc1*] | 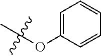 [SMILES: *Oc1ccccc1] | 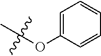 [SMILES: *Oc1ccccc1] | 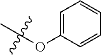 [SMILES: *Oc1ccccc1] | 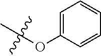 [SMILES: *Oc1ccccc1] |
| 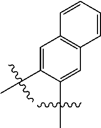 [SMILES: *c1cc2ccccc2cc1*] | 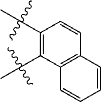 [SMILES: *c1ccc2ccccc2c1*] | 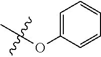 [SMILES: *Oc1ccccc1] | 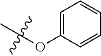 [SMILES: *Oc1ccccc1] | 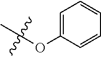 [SMILES: *Oc1ccccc1] | 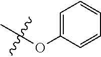 [SMILES: *Oc1ccccc1] |
| 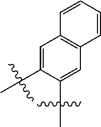 [SMILES: *c1cc2ccccc2cc1*] | 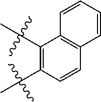 [SMILES: *c1ccc2ccccc2c1*] | 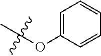 [SMILES: *Oc1ccccc1] | 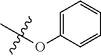 [SMILES: *Oc1ccccc1] | 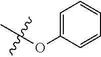 [SMILES: *Oc1ccccc1] | 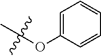 [SMILES: *Oc1ccccc1] |
| 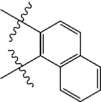 [SMILES: *c1ccc2ccccc2c1*] | 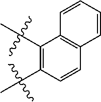 [SMILES: *c1ccc2ccccc2c1*] | 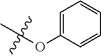 [SMILES: *Oc1ccccc1] | 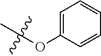 [SMILES: *Oc1ccccc1] | 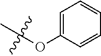 [SMILES: *Oc1ccccc1] | 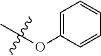 [SMILES: *Oc1ccccc1] |
| 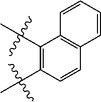 [SMILES: *c1ccc2ccccc2c1*] | 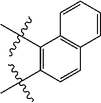 [SMILES: *c1ccc2ccccc2c1*] | 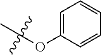 [SMILES: *Oc1ccccc1] | 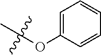 [SMILES: *Oc1ccccc1] | 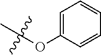 [SMILES: *Oc1ccccc1] | 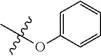 [SMILES: *Oc1ccccc1] |
| 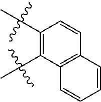 [SMILES: *c1ccc2ccccc2c1*] | 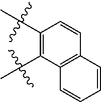 [SMILES: *c1ccc2ccccc2c1*] | 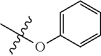 [SMILES: *Oc1ccccc1] | 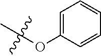 [SMILES: *Oc1ccccc1] | 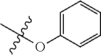 [SMILES: *Oc1ccccc1] | 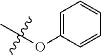 [SMILES: *Oc1ccccc1] |
| 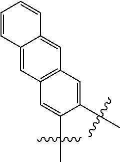 [SMILES: *c1cc2cc3ccccc3cc2cc1*] | 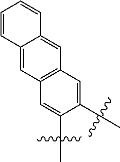 [SMILES: *c1cc2cc3ccccc3cc2cc1*] | 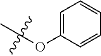 [SMILES: *Oc1ccccc1] | 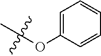 [SMILES: *Oc1ccccc1] | 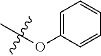 [SMILES: *Oc1ccccc1] | 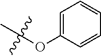 [SMILES: *Oc1ccccc1] |
| 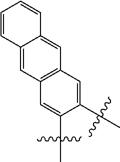 [SMILES: *c1cc2cc3ccccc3cc2cc1*] | 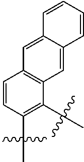 [SMILES: *c1ccc2cc3ccccc3cc2c1*] | 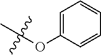 [SMILES: *Oc1ccccc1] | 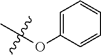 [SMILES: *Oc1ccccc1] | 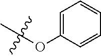 [SMILES: *Oc1ccccc1] | 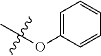 [SMILES: *Oc1ccccc1] |
| 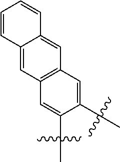 [SMILES: *c1cc2cc3ccccc3cc2cc1*] | 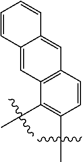 [SMILES: *c1ccc2cc3ccccc3cc2c1*] | 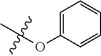 [SMILES: *Oc1ccccc1] | 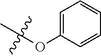 [SMILES: *Oc1ccccc1] | 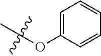 [SMILES: *Oc1ccccc1] | 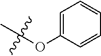 [SMILES: *Oc1ccccc1] |
| 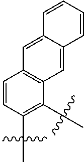 [SMILES: *c1ccc2cc3ccccc3cc2c1*] | 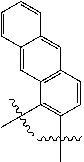 [SMILES: *c1ccc2cc3ccccc3cc2c1*] | 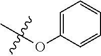 [SMILES: *Oc1ccccc1] | 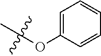 [SMILES: *Oc1ccccc1] | 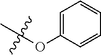 [SMILES: *Oc1ccccc1] | 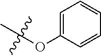 [SMILES: *Oc1ccccc1] |
| 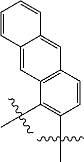 [SMILES: *c1ccc2cc3ccccc3cc2c1*] | 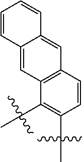 [SMILES: *c1ccc2cc3ccccc3cc2c1*] | 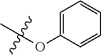 [SMILES: *Oc1ccccc1] | 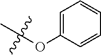 [SMILES: *Oc1ccccc1] | 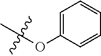 [SMILES: *Oc1ccccc1] | 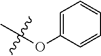 [SMILES: *Oc1ccccc1] |
| 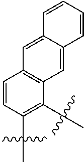 [SMILES: *c1ccc2cc3ccccc3cc2c1*] | 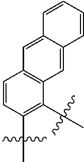 [SMILES: *c1ccc2cc3ccccc3cc2c1*] | 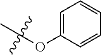 [SMILES: *Oc1ccccc1] | 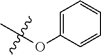 [SMILES: *Oc1ccccc1] | 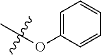 [SMILES: *Oc1ccccc1] | 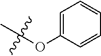 [SMILES: *Oc1ccccc1] |
| 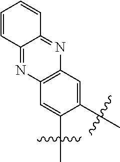 [SMILES: *c1cc2nc3ccccc3nc2cc1*] | 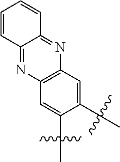 [SMILES: *c1cc2nc3ccccc3nc2cc1*] | 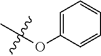 [SMILES: *Oc1ccccc1] | 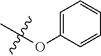 [SMILES: *Oc1ccccc1] | 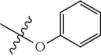 [SMILES: *Oc1ccccc1] | 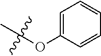 [SMILES: *Oc1ccccc1] |
| 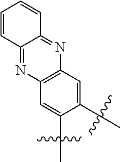 [SMILES: *c1cc2nc3ccccc3nc2cc1*] | 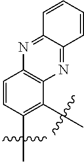 [SMILES: *c1ccc2nc3ccccc3nc2c1*] | 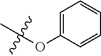 [SMILES: *Oc1ccccc1] | 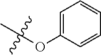 [SMILES: *Oc1ccccc1] | 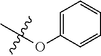 [SMILES: *Oc1ccccc1] | 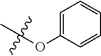 [SMILES: *Oc1ccccc1] |
| 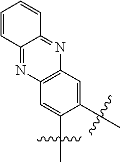 [SMILES: *c1cc2nc3ccccc3nc2cc1*] | 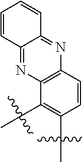 [SMILES: *c1ccc2nc3ccccc3nc2c1*] | 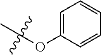 [SMILES: *Oc1ccccc1] | 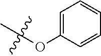 [SMILES: *Oc1ccccc1] | 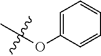 [SMILES: *Oc1ccccc1] | 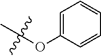 [SMILES: *Oc1ccccc1] |
| 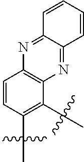 [SMILES: *c1ccc2nc3ccccc3nc2c1*] | 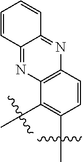 [SMILES: *c1ccc2nc3ccccc3nc2c1*] | 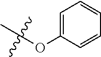 [SMILES: *Oc1ccccc1] | 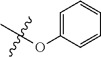 [SMILES: *Oc1ccccc1] | 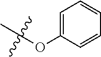 [SMILES: *Oc1ccccc1] | 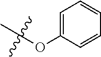 [SMILES: *Oc1ccccc1] |
| 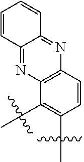 [SMILES: *c1ccc2nc3ccccc3nc2c1*] | 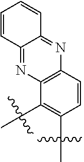 [SMILES: *c1ccc2nc3ccccc3nc2c1*] | 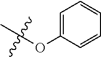 [SMILES: *Oc1ccccc1] | 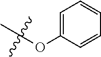 [SMILES: *Oc1ccccc1] | 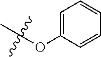 [SMILES: *Oc1ccccc1] | 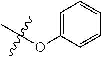 [SMILES: *Oc1ccccc1] |
| 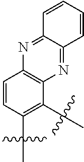 [SMILES: *c1ccc2nc3ccccc3nc2c1*] | 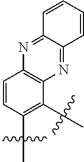 [SMILES: *c1ccc2nc3ccccc3nc2c1*] | 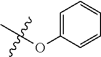 [SMILES: *Oc1ccccc1] | 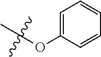 [SMILES: *Oc1ccccc1] | 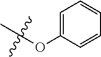 [SMILES: *Oc1ccccc1] | 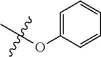 [SMILES: *Oc1ccccc1] |
| 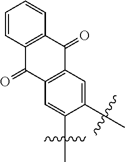 [SMILES: *c1cc2c(cc1*)C(=O)c1ccccc1C2=O] | 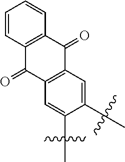 [SMILES: *c1cc2c(cc1*)C(=O)c1ccccc1C2=O] | 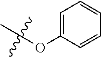 [SMILES: *Oc1ccccc1] | 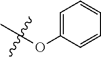 [SMILES: *Oc1ccccc1] | 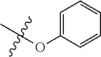 [SMILES: *Oc1ccccc1] | 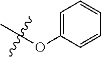 [SMILES: *Oc1ccccc1] |
| 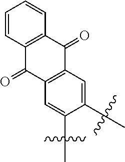 [SMILES: *c1cc2c(cc1*)C(=O)c1ccccc1C2=O] | 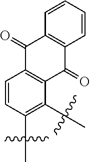 [SMILES: *c1ccc2c(c1*)C(=O)c1ccccc1C2=O] | 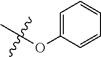 [SMILES: *Oc1ccccc1] | 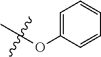 [SMILES: *Oc1ccccc1] | 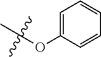 [SMILES: *Oc1ccccc1] | 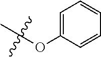 [SMILES: *Oc1ccccc1] |
| 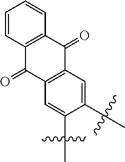 [SMILES: *c1cc2c(cc1*)C(=O)c1ccccc1C2=O] | 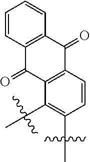 [SMILES: *c1ccc2c(c1*)C(=O)c1ccccc1C2=O] | 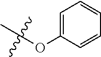 [SMILES: *Oc1ccccc1] | 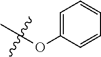 [SMILES: *Oc1ccccc1] | 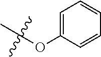 [SMILES: *Oc1ccccc1] | 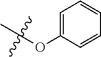 [SMILES: *Oc1ccccc1] |
| 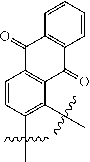 [SMILES: *c1ccc2c(c1*)C(=O)c1ccccc1C2=O] | 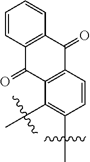 [SMILES: *c1ccc2c(c1*)C(=O)c1ccccc1C2=O] | 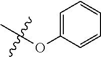 [SMILES: *Oc1ccccc1] | 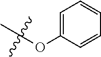 [SMILES: *Oc1ccccc1] | 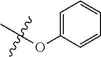 [SMILES: *Oc1ccccc1] | 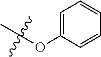 [SMILES: *Oc1ccccc1] |

In one embodiment at least one auxiliary dye may be present which is a compound of Formula (IVa) or Formula (IVb):

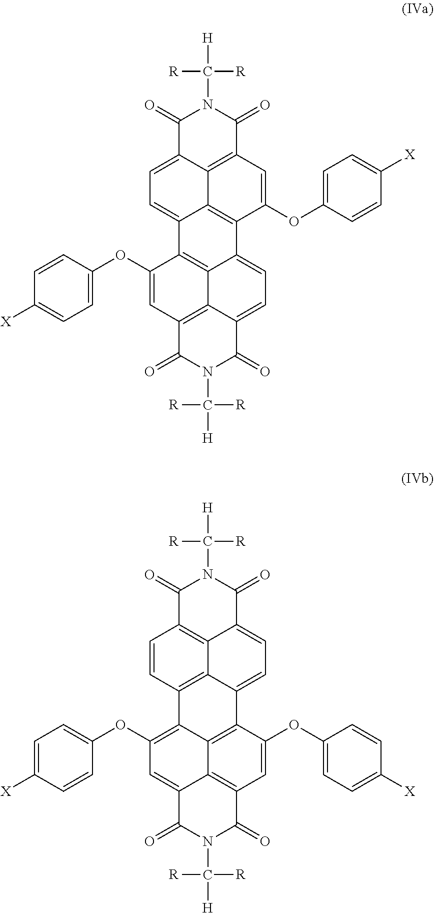

wherein in Formula (IVa) or (IVb):

each X is an optionally substituted alkyl group (for example an optionally substituted tert-butyl group or an optionally substituted straight of branched C₁₂ group, for example a C₁₂H₂₅ isomer); and

each R is independently an optionally substituted alkyl group.

In one embodiment at least one auxiliary dye may be present which is a compound of Formula (V):

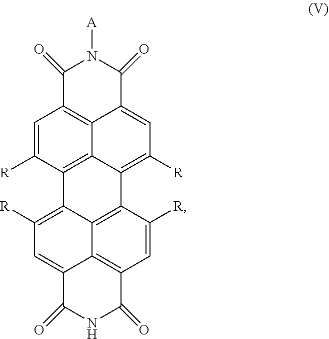

wherein in Formula (V):
each A is an optionally substituted alkyl group (for example a C1-10 alkyl chain, such as a C₈ chain); and
each R is an optionally substituted phenoxy group, for example a phenoxy group substituted by one or more optionally substituted alkyl groups, for example

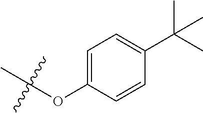 [SMILES: *Oc1ccc(C(C)(C)C)cc1]

In one embodiment the auxiliary dye are in the form of salts, for example sodium or potassium salts.

Herein “dye” or “dyes” may refer to one or more compounds selected from: Formula (I), Formula (I-A), Formula (I-B), Formula (II), Formula (II-A), Formula (II-A1), Formula (II-A2), Formula (II-B), Formula (II-B1), Formula (II-B2), Formula (II-C), Formula (II-C1), Formula (II-C2), Formula (II-D), Formula (II-D1), Formula (II-D2), and mixtures thereof.

### Articles

Disclosed herein is an article which may be in the form of a luminescent article. The article may comprise a luminescent subcomponent, e.g. a dye or one or more pigments, for example the article may be designed to diffuse luminescence generated within the article to project the red light or far-red light onto the intended receiver, e.g. a plant. The diffusion may prevent TIR from potentially trapping approximately a portion of the luminescence, for example about 75% of the luminescence within the article itself.

When light is trapped and guided within an article, for example a polymer article of consistent thickness, lacking any light absorbing or diffusing elements or characteristics, and having smooth surfaces, the resulting article is known as a waveguide or light guide. The present invention includes articles that have one or more of either variation in article thickness, surface defects or light diffusing elements that help to disrupt TIR and, thus prevent the creation of a luminescent light guide or waveguide. Herein an article may be characterised as a luminescent diffusive article.

The diffusion of the luminescence can be achieved by disruption of guided light in a number of ways, included, but not limited to:
(a) Moulded impressions such conical impressions that create variation in film thickness where luminescence is decoupled from the article as the material gets thinner.
(b) Surface defects such as textured surface(s) that may disrupt even reflection of light within the article and cause the luminescence to be decoupled from the article.
(c) Inclusion of colourless, transmissive particles within the article, that do not contain luminescent dye, having a different refractive index than the primary material of which the article is composed. Such particles may disrupt the pathway of luminescence being reflected internally and cause the luminescence to be decoupled from the article.
(d) An article with no diffusing elements or varied thickness could become a diffusive article if one face were coated in a white polymer or paint such that the luminescence would be emitted completely from the opposite face. Such an article would be best utilised below the plants absorbing light from above and emitting luminescence upwards towards the plants.

The methods described above can be engineered, as known by those skilled in the art, to cause decoupling of light primarily from one face of the article or equally from both faces of the article isotropically.

Disclosed herein is an article or device comprising one or more dyes. In another embodiment the article or device comprises one or more dyes that fluoresce. In one embodiment, at least one surface of an article comprises at least one dye.

Also disclosed herein is an article comprising at least one dye which targets at least one phytochrome in a plant. For example the phytochrome may be the P660 form or the P730 form.

Also disclosed herein is an article or device that is capable of stimulating at least one of:
P660 and/or the conversion thereof, and
P730 and/or the conversion thereof,
   in an organism.

Also disclosed herein is an article or device comprising at least one dye, for example a luminescent dye, wherein at least one dye emits fluorescence at a wave length:
in a range of about 640 nm to about 680 nm; or
in a range of about 710 nm to about 750 nm.

Also disclosed herein is an article or device comprising at least one dye, for example a luminescent dye which absorbs light at a wavelength:
in a range of about 250 nm to about 600 nm; or
in a range of about 250 nm to about 730 nm

In one embodiment, the article or device stimulates one or both of:
P660; and
P730,
   in an organism, for example a plant.

In one embodiment, the article comprises one or more dye compounds, for example, at least one compound of: Formula (I), Formula (I-A), Formula (I-B), Formula (II), Formula (II-A), Formula (II-A1), Formula (II-A2), Formula (II-B), Formula (II-B1), Formula (II-B2), Formula (II-C), Formula (II-C1), Formula (II-C2), Formula (II-D), Formula (II-D1), or Formula (II-D2) and/or an auxiliary dye, and mixtures thereof. Each of the one or more dyes and/or auxiliary dyes may be present in the same or different amounts. For example, one or more of the dyes and/or auxiliary dyes may be present in an amount independently selected from: at least about 1% w/w; at least about 2% w/w; at least about 3% w/w; at least about 4% w/w; at least about 5% w/w; at least about 6% w/w; at least about 7% w/w; at least about 8% w/w; at least about 9% w/w; at least about 10% w/w; at least about 11% w/w; at least about 12% w/w; at least about 13% w/w; at least about 14% w/w; at least about 15% w/w; at least about 16% w/w; at least about 17% w/w; at least about 18% w/w; at least about 19% w/w; at least about 20% w/w; at least about 21% w/w; at least about 22% w/w; at least about 23% w/w; at least about 24% w/w; at least about 25% w/w; at least about 26% w/w; at least about 27% w/w; at least about 28% w/w; at least about 29% w/w; at least about 30% w/w; at least about 31% w/w; at least about 32% w/w; at least about 33% w/w; at least about 34% w/w; at least about 35% w/w; at least about 36% w/w; at least about 37% w/w; at least about 38% w/w; at least about 39% w/w; at least about 40% w/w; at least about 41% w/w; at least about 42% w/w; at least about 43% w/w; at least about 44% w/w; at least about 45% w/w; at least about 46% w/w; at least about 47% w/w; at least about 48% w/w; at least about 49% w/w; and/or at least about 50% w/w.

In one embodiment the article, which may be in the form of a sheet, with a material, for example a compound that produces luminescence at or near about 660 nm, for example in a range of about 640 nm to about 680 nm, or any other range as disclosed herein.

In another embodiment the article, which may be in the form of a sheet, with a material, for example a compound that produces luminescence at or near about 730 nm, for example in a range of about 710 nm to about 750 nm, or any other range as disclosed herein.

In one embodiment the article or device is a film or sheet which is transparent enough to enable sufficient growth in a plant, and preferably also changing the spectrum sufficiently to have the desired effect. This value can be the measure of two factors:
(i) the actual concentration of one or more dye in the film or sheet, and the thickness of the film or sheet; and
(ii) the portion of the space over the plants that is covered by the film or sheet from 0%-100%. The sheet or film could be staggered in strips of any width to allow a partial coverage of the space above the plants to allow a certain proportion of sunlight to reach the plants unaffected by the film or sheet.
   These two parameters may change with varied plants, and geographic regions.

The application and desired effect is also a big consideration. For example, conversion of red light to far red light could decrease the plants vegetative growth capacity for the benefit of inducing early fruiting or flowering, or increasing the yield of fruit.

Materials which may be used to construct the articles described herein include, but are not limited to inorganic materials such as glass or polymeric materials. Examples of polymeric materials which can be used include, but are not limited to: polycarbonate, polymethylmethacrylate, polypropylene, polyethylene, polyamide, polyacrylamide, polyvinylchloride or copolymers or any combinations thereof. The article or device may comprise a dielectric material. The dielectric material may comprise a polymer, glass and/or quartz. In one embodiment, the polymer comprises acrylate or polycarbonate. In one embodiment, the polymer is polymethyl methacrylate or polycarbonate. In one embodiment, the polymer is polymethyl methacrylate. In one embodiment, one or more dyes disclosed herein are disposed in a polymer. In another embodiment, the one or more dyes are coated on a polymer substrate. The polymer may comprise: an acrylic, a urethane; an ester; a methacrylate; a thiophene; a co-polymer of any bond conjugated polymer; a light transparent polymer; a low ultra violet absorbent polymer; a heat conducting polymer; an electrically conducting polymer; and mixtures thereof. In another embodiment, the polymer may be: aniline based; pyrrole based; acetylene based; or furan based.

In another embodiment, the polymer may comprise polyurethane, polyester, polyamide, polyurea, polycarbonate, polymethyl methacrylate or mixtures thereof. The constituent monomers in the polymers of the present disclosure may be methacrylate-based, carbonate-based, acrylamide-based, methacrylamide-based, styrene-based monomers and mixtures thereof.

Constituent monomers of the vinyl polymers that may be used, for example to form at least part of the article and/or device, include: acrylic esters, e.g., methyl acrylate, ethyl acrylate, n-propyl acrylate, isopropyl acrylate, n-butyl acrylate, isobutyl acrylate, sec-butyl acrylate, tert-butyl acrylate, amyl acrylate, hexyl acrylate, 2-ethylhexyl acrylate, octyl acrylate, tert-octyl acrylate, 2-chloroethyl acrylate, 2-bromoethyl acrylate, 4-chlorobutyl acrylate, cyanoethyl acrylate, 2-acetoxyethyl acrylate, dimethylaminoethyl acrylate, benzyl acrylate, methoxybenzyl acrylate, 2-chlorocyclohexyl acrylate, cyclohexyl acrylate, furfuryl acrylate, tetrahydrofurfuryl acrylate, phenyl acrylate, 5-hydroxypentyl acrylate, 2-methoxyethyl acrylate, 3-methoxybutyl acrylate, 2-ethoxybutyl acrylate, 2-ethoxyethyl acrylate, 2-isopropoxy acrylate, 2-butoxyethyl acrylate, 2-(2-methoxyethoxy)ethyl acrylate, 2-(2-methoxyethoxy)ethyl acrylate, 2-(2-butoxyethoxy) ethyl acrylate, ω-methoxypolyethylene glycol acrylate (addition mol number: 9), 1-bromo-2-methoxyethyl acrylate, and 1,1-dichloro-2-ethoxyethyl acrylate.

In addition, one or more of the following monomers can be used, for example to form at least part of the article and/or device: methacrylic esters, e.g., methyl methacrylate, ethyl methacrylate, n-propyl methacrylate, isopropyl methacrylate, n-butyl methacrylate, isobutyl methacrylate, sec-butylmethacrylate, tert-butylmethacrylate, amylmethacrylate, hexylmethacrylate, cyclohexylmethacrylate, benzyl methacrylate, chlorobenzyl methacrylate, octyl methacrylate, stearylmethacrylate, sulfopropylmethacrylate, N-ethyl-N-phenylaminoethyl methacrylate, 2-(3-phenylpropyloxy)ethyl methacrylate, dimethylaminophenoxyethyl methacrylate, furfuryl methacrylate, tetrahydrofurfuryl methacrylate, phenyl methacrylate, cresyl methacrylate, naphthyl methacrylate, 2-hydroxyethyl methacrylate, 4-hydroxybutyl methacrylate, triethylene glycol monomethacrylate, dipropylene glycol monomethacrylate, 2-methoxyethyl methacrylate, 3-methoxybutyl methacrylate, 2-acetoxyethyl methacrylate, 2-acetoacetoxyethyl methacrylate, 2-ethoxyethyl methacrylate, 2-isopropoxyethyl methacrylate, 2-butoxyethyl methacrylate, 2-(2-methoxyethoxy)ethyl methacrylate, 2-(2-ethoxyethoxy)ethyl methacrylate, 2-(2-butoxyethoxy)ethyl methacrylate, w-methoxypolyethylene glycol methacrylate (addition mol number: 6), acryl methacrylate, and methacrylic acid dimethylaminoethylmethyl chloride salt, or mixtures thereof, vinylesters, e.g., vinylacetate, vinyl propionate, vinyl butyrate, vinyl isobutyrate, vinyl caproate, vinyl chloroacetate, vinylmethoxy acetate, vinylphenyl acetate, vinyl benzoate, and vinyl salicylate; acrylamides, e.g., acrylamide, methylacrylamide, ethylacrylamide, propylacrylamide, isopropylacrylamide, n-butylacrylamide, sec-butylacrylamide, tert-butylacrylamide, cyclohexylacrylamide, benzylacrylamide, hydroxymethylacrylamide, methoxyethylacrylamide, dimethylaminoethylacrylamide, phenylacrylamide, dimethylacrylamide, diethylacrylamide, β-cyanoethylacrylamide, N-(2-acetoacetoxyethyl)acrylamide, and diacetoneacrylamide, and mixtures thereof; methacrylamides, e.g., methacrylamide, methylmethacrylamide, ethylmethacrylamide, propylmethacrylamide, isopropylmethacrylamide, n-butylmethacrylamide, sec-butylmethacrylamide, tert-butylmethacrylamide, cyclohexylmethacrylamide, benzylmethacrylamide, hydroxymethacrylamide, chlorobenzylmethacrylamide, octylmethacrylamide, stearylmethacrylamide, sulfopropylmethacrylamide, N-ethyl-N-phenylaminoethylmethacrylamide, 2-(3-phenylpropyloxy)ethylmethacrylamide, dimethylaminophenoxyethylmethacrylamide, furfurylmethacrylamide, tetrahydrofurfurylmethacrylamide, phenylmethacrylamide, cresylmethacrylamide, naphthylmethacrylamide, 2-hydroxyethylmethacrylamide. 4-hydroxybutylmethacrylamide, triethylene glycol monomethacrylamide, dipropylene glycol monomethacrylamide, 2-methoxyethylmethacrylamide, 3-methoxybutylmethacrylamide, 2-acetoxyethylmethacrylamide, 2-acetoacetoxyethylmethacrylamide, 2-ethoxyethylmethacrylamide, 2-isopropoxyethylmethacrylamide, 2-butoxyethylmethacrylamide, 2-(2-methoxyethoxy) ethylmethacrylamide, 2-(2-ethoxyethoxy) ethylmethacrylamide, 2-(2-butoxyethoxy) ethylmethacrylamide, w-methoxypolyethylene glycol methacrylamide (addition mol number: 6), acrylmethacrylamide, dimethylaminomethacrylamide, diethylaminomethacrylamide, B-cyanoethylmethacrylamide, and N-(2-acetoacetoxyethyl)methacrylamide, and mixtures therof; olefins, e.g., dicyclopentadiene, ethylene, propylene, 1-butene, 1-pentene, vinyl chloride, vinylidene chloride, isoprene, chloroprene, butadiene, and 2,3-dimethylbutadiene, or mixtures thereof; styrenes, e.g., styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, and vinylbenzoic acid methyl ester, and mixtures thereof; vinyl ethers, e.g., methylvinyl ether, butylvinyl ether, hexylvinyl ether, methoxyethylvinyl ether and dimethylaminoethylvinyl ether, or mixtures thereof; or other examples such as e.g., butyl crotonate, hexyl crotonate, dibutyl itaconate, dimethyl maleate, dibutyl maleate, dimethyl fumarate, dibutyl fumarate, methyl vinyl ketone, phenyl vinyl ketone, methoxyethyl vinyl ketone, glycidyl acrylate, glycidyl methacrylate, N-vinyloxazolidone, N-vinylpyrrolidone, acrylonitrile, methacrylonitrile, methylene moronnitrile, and vinylidene; and mixtures thereof.

Two or more monomers may be used as co-monomers with each other according to purposes (e.g., improvement of hardness, flexibility, tensile strength and light fastness), thereby producing co-polymers.

In one embodiment the article or device comprises polycarbonate, polyethylene, or a mixture thereof.

The materials used in the construction of the articles and/or device, as defined herein may further comprise, in addition to at least one dye as defined herein, further compounds. These further compounds include, but are not limited to: UV absorbers and/or hindered amine light stabilizers. Said materials may also comprise flame retarders, UV stabilizers, thermal stabilizers, anti-oxidants, plasticizers, fillers, air pockets, light scatters, titanium oxide, or mixtures thereof.

In one embodiment the article or device in the form of a sheet or film, with a thickness in a range of about 0.2 mm to about 2 mm. The sheet or film may have a thickness in a range of: about 0.2 mm to about 2 mm; about 0.3 mm to about 2 mm; about 0.4 mm to about 2 mm; about 0.5 mm to about 2 mm; about 0.6 mm to about 2 mm; about 0.7 mm to about 2 mm; about 0.8 mm to about 2 mm; about 0.9 mm to about 2 mm; about 1 mm to about 2 mm; about 1.2 mm to about 2 mm; about 1.4 mm to about 2 mm; about 1.6 mm to about 2 mm; or about 1.8 mm to about 2 mm; or a value of at least about 0.2 mm; at least about 0.3 mm; at least about 0.4 mm; at least about 0.5 mm; at least about 0.6 mm; at least about 0.7 mm; at least about 0.8 mm; at least about 0.9 mm; or at least about 1 mm; at least about 1.2 mm; at least about 1.4 mm; at least about 1.6 mm; at least about 1.8 mm; or at least about 2 mm.

The concentration of the one or more dyes may depend on a number of factors, for example the thickness of a film comprising one or more dyes and/or the desired dye strength. In one embodiment the article or device in the form of a sheet or film, wherein the at least one dye is present in a concentration in a range of about 50 to 200 parts per million. The sheet or film may have one or more dyes and/or auxiliary dyes present in an amount of: at least about 50 parts per million; at least about 55 parts per million; at least about 60 parts per million; at least about 65 parts per million; at least about 70 parts per million; at least about 75 parts per million; at least about 80 parts per million; at least about 85 parts per million; at least about 90 parts per million; at least about 95 parts per million; at least about 100 parts per million; at least about 105 parts per million; at least about 110 parts per million; at least about 115 parts per million; at least about 120 parts per million; at least about 125 parts per million; at least about 130 parts per million; at least about 135 parts per million; at least about 140 parts per million; at least about 145 parts per million; at least about 150 parts per million; at least about 155 parts per million; at least about 160 parts per million; at least about 165 parts per million; at least about 170 parts per million; at least about 175 parts per million; at least about 180 parts per million; at least about 185 parts per million; at least about 190 parts per million; at least about 195 parts per million; or at least about 200 parts per million.

In one embodiment the article or device can be adapted to include an additional layer or coating like for example: an anti-fouling coating, anti-fogging coating, anti-reflection coatings, anti-glare coatings, colour reflecting/absorbing layers, an infra-red filter, or a mixture thereof.

### Device

Herein a device may be any means by which the article described above can be deployed in a given application. The device may comprise one or more articles as described herein.

In one form the device could be a supporting framework to suspend one or more articles described herein in a desired orientation, for example a preferred orientation relative to one or more plants. The device may hold the article directly above the plants, at some angle to the side of the plants or even below the plants to capture light that would normally reach the ground unused.

In another embodiment, the device may be complex. For example, a framework that has the ability to adjust the orientation of one or more articles to be either parallel with the ground or at increasing angles up to being perpendicular with the ground. Such a device may be configured to track the movement of the sun across the sky. Varied orientation of the article by operation of the device may also alter the degree off effect the article has on the plants where some range of angles may cause the article to have a greater effect on the plants than others.

Another example of a device could be slats or fins on a series of vents in the roof of a greenhouse that allow air to escape to be trapped as a means of controlling airflow. Airflow control in a greenhouse would affect carbon dioxide levels, oxygen levels, temperature and humidity. Such a device may be utilised in or on Smart Farming systems that include automated, climate-controlled greenhouses. If the vents are comprised of the luminescent article, then the effect of the article on the plants could be controlled by the opening and closing of the vents.

In the case where the article is a flexible sheet that can be rolled onto a spool, the device may be a system where the article is drawn across the ceiling of a greenhouse or any plant growth facility by use of tracks and/or pulleys and cables. The article could then be respooled to change for a different coloured article or to have no article effecting the plants at all. This can be a manual driven system, electrically driven or fully automated.

In another example, the device may move the actual plants to a different location that is influenced by different coloured articles.

In another example, the article may be situated in a position that prevents workers from accessing the plants. A device that comprises the article may be built to move the article in order to give workers access to the plants and then return to its original position.

Another device that comprises the article may be one that includes a self-cleaning, or other maintenance, system for the article which may accumulate dust a debris that would diminish its benefits. Such a device could be an aspect of any of the devices listed above.

Another device would be any variation of previously described devices that includes a method by which to remove an old article that has exceeded its life span of effectiveness and replace it with a new article. Such a device would include a permanent infrastructure with the ability to frequently exchange the article

In one example the device may be in the form of a retractable roller, e.g. a motorised roller which may be utilised to adjust the positions of one or more articles as described here, for example during different times of the day, or a static device comprising at least one article as described herein.

In one embodiment an article described herein is a component of a device as defined herein.

### Article/Device Structure

Disclosed herein is an article or device comprising at least one dye as defined herein.

Disclosed herein is an article or device comprising at least one luminescent dye, wherein at least one luminescent dye emits fluorescence at a wave length:
in a range of about 640 nm to about 680 nm; or
in a range of about 710 nm to about 750 nm.

Disclosed herein is an article or device comprising at least one luminescent dye, wherein at least one luminescent dye absorbs light at a wave length:
in a range of about 250 nm to about 600 nm; or
in a range of about 250 nm to about 730 nm.

The article or device may be in the form of a film, fabric or a sheet. Other forms include a tunnel shape, canopy or dome.

The article may be a fabric. One or more dyes as defined herein could be dispersed into a polymer (as described herein, for example a polyester), which is used as a synthetic fibre or in the production of a synthetic fibre. Exemplary polymers include PET (polyethylene terephthalate). In one form the article could take the form of a translucent, luminescent cloth.

In one embodiment the film or sheet can be applied to a surface, for example a glass surface, to adapt the properties of the surface to which the film or sheet is applied.

In one embodiment one or more surfaces on an article or device described herein has been modified to change the surface structure. For example one or more surfaces may comprise etching (either random or defined), and/or a randomly roughed surface, due to modifications from coarse sanding or texturing. These changes to the surface could be applied during extrusion of the article.

In one embodiment the article (for example in the form of a film), has at least one face etched with a roughing pattern to disrupt and diffuse fluorescence generated by one or more dyes (and optionally one or more auxiliary dyes), within the article, so the fluorescence will be decoupled from the article and emitted. For example, towards plant growth.

In another embodiment, to achieve effective decoupling of fluorescence from the an article, such as a film, diffusive particles may be introduced, for example when one or more dyes are compounded into a polymer matrix. These particles, when added in the compounding and extrusion of the article may cause effective decoupling of the fluorescence. For example, even when both surfaces of a plastic film are smooth.

Herein the films may have a width of about 250 mm to about 1000 mm. Wider films may be produced for larger installations and/or higher ceilings. The width can be nominated to be suitable for the required needs, for example shipping and/or ease of installation.

The articles (for example films) described herein may be placed against or just below the ceiling of a greenhouse. However, the articles may also be suspended further below the ceiling and just above one or more plants.

For indoor growth, the articles may be placed along the walls and ceiling to absorb light that strikes the walls and ceilings and produce fluorescence. For example, walls that are white may provide an effective reflective backing for the articles to redirect the fluorescent light, for example towards the centre of a room.

An article may be placed directly in front of the light sources for an indoor grow room if temperatures of the light fixtures do not cause damage to the articles.

In another embodiment, one or more surfaces may comprise one or more types of dispersive particles, for example dispersive particles including, but not limited to: silica, alumina or titania and combinations thereof.

In another embodiment one or more protrusions, for example conical shaped protrusions can be added to one or more surfaces of the article. In another embodiment, a moulding machine with a myriad of pointed protrusions can create a surface of extruded conical shapes across the face of the film. The presence of protrusions may allow for the fluorescence to be extracted from each protrusion in a single direction rather than having the fluorescence extracted in 360 degrees where 50% of the fluorescence is emitted towards the sky, (e.g., not towards one or more plants) and is lost.

In one embodiment the article or device may comprise at least one of: an indentation, a projection, a protrusion, a fissure, a crack, a protuberance, a boss, a knob, a lump, a hump, a lug, a peg, a prong, a rib, a ridge, a groove, a trough, a channel, a corrugation, a lip, a sawtooth, a ramp, a wedge, a texture, or a mixture thereof, or may be a three dimensional prism such as pyramidal, cuboid, or any other three-dimensional prism derived from a sphere, a hemisphere, a segment, a circle, an ellipse, a triangle, a square, a parallelogram, a pentagon, a hexagon, a heptagon, an octagon and so on. The article or device may be formed by a point indentation, or a cross-shaped indentation.

In one embodiment the article or device is in the form of a sheet. In a further embodiment the sheet is manufactured with a pattern or etching on one face of the article. Preferably the pattern or etching decoupled the fluorescence from the sheet to maximise the output towards one or more plants.

Disclosed herein is an article for delivering filtered light in a predetermined direction, the article comprising: a body comprising a sheet and a set of light directors coupled to the sheet, wherein each light director extends away from the sheet, wherein: (i) the body is transparent to transmit light there through and configured to filter a predetermined range of frequencies from the transmitted light; (ii) the set of light directors is configured to receive light and deliver a majority of the filtered light from the received light in the predetermined direction; and (iii) the predetermined direction is normal to a side of the sheet. In one embodiment the article also comprises at least one dye which targets at least one phytochrome in a plant. In another example the article comprises one or more dyes as defined herein.

Also disclosed herein is an article for filtering light and delivering the filtered light, the article comprising a set of projecting portions and a sheet portion connecting the set of projecting portions, wherein: (i) the set of projecting portions and the sheet portion are transparent and comprise a dye to filter light travelling through the projecting portions; (ii) the sheet portion is configured to receive ambient incident light and deliver filtered light to the set of projecting portions; and (iii) each of the set of projecting portions comprise an angular offset with respect to the sheet portion to deliver a majority of the filtered light from the set of projecting portions in a predetermined direction. In one embodiment the article or device comprises at least one dye which targets at least one phytochrome in a plant. In another example the article comprises one or more dyes as defined herein.

Also disclosed herein is a device for delivering filtered light in a predetermined direction, the device comprising a body comprising a sheet and a set of light directors coupled to the sheet, wherein each light director extends away from the sheet, wherein: (i) the body is transparent to transmit light there through and configured to filter a predetermined range of frequencies from the transmitted light; (ii) and the set of light directors is configured to receive light and deliver a majority of the filtered light from the received light in the predetermined direction; and (iii) the predetermined direction is normal to a side of the sheet. In one embodiment the device also comprises at least one dye which targets at least one phytochrome in a plant. In another example the device comprises one or more dyes as defined herein.

Also disclosed herein is a device for filtering light and delivering the filtered light, the device comprising a set of projecting portions and a sheet portion connecting the set of projecting portions, wherein: (i) the set of projecting portions and the sheet portion are transparent and comprise a dye to filter light travelling through the projecting portions; (ii) the sheet portion is configured to receive ambient incident light and deliver filtered light to the set of projecting portions; and (iii) each of the set of projecting portions comprise an angular offset with respect to the sheet portion to deliver a majority of the filtered light from the set of projecting portions in a predetermined direction. In one embodiment the device also comprises at least one dye which targets at least one phytochrome in a plant. In another example the device comprises one or more dyes as defined herein.

In one embodiment in a device or article as described herein, the body comprises at least one dye to filter the predetermined range of frequencies.

In one embodiment in a device or article as described herein, the device further comprises, for example in the body, at least one dye, for example a luminescent dye, that emits fluorescence at a wave length:
in a range of about 640 nm to about 680 nm; or
in a range of about 710 nm to about 750 nm.

In one embodiment in a device or article as described herein, the device further comprises, for example in the body, at least one of the luminescent dyes absorbs light:
in a range of about 250 nm to about 600 nm; or
in a range of about 250 nm to about 730 nm.

In one embodiment in a device or article as described herein stimulates at least one of:
P660; and
P730,
   in an organism, for example a plant

In one embodiment in a device or article as described herein, the device comprises at least one florescent perylene type dye.

In one embodiment in a device or article as described herein, the device and/or article comprises at least one compound selected from: Formula (I), Formula (I-A), Formula (I-B), Formula (II), Formula (II-A), Formula (II-A1), Formula (II-A2), Formula (II-B), Formula (II-B1), Formula (II-B2), Formula (II-C), Formula (II-C1), Formula (II-C2), Formula (II-D), Formula (II-D1), or Formula (II-D2) and/or an auxiliary dyes (as defined herein), and mixtures thereof.

In one embodiment in a device or article as described herein, each light director and the sheet are integrally formed from a flat sheet.

In one embodiment in a device or article as described herein, the sheet is convex towards the predetermined direction.

In one embodiment in a device or article as described herein, the mean thickness of each light director is smaller than the thickness of the sheet.

In one embodiment in a device or article as described herein, the thickness of each light director decreases in the predetermined direction to progressively increase angles of incidence within the light director in the predetermined direction.

In one embodiment in a device or article as described herein, the set of light directors further comprising a plurality of frustoconical protrusions.

In one embodiment in a device or article as described herein, each of the set of light directors are identically shaped.

In one embodiment in a device or article as described herein, the set of light directors are at least partially arranged in rows and/or columns.

In one embodiment in a device or article as described herein the set of light directors comprise one or more protrusions at an angle of: about 10, about 20, about 30, about 40, about 40, about 50, about 60, about 70, or about 80 degrees to the sheet, or a mixture thereof.

In one embodiment in a device or article as described herein, at least one light director comprises an opening at a distal end of the light director.

In one embodiment in a device or article as described herein, the set of light directors are arranged in a periodic pattern along at least part of the article or the device.

### Arrays and Systems

Disclosed herein is an array for enhancing plant growth, the array comprising one or more articles and/or devices as defined herein.

In one embodiment the array comprises one or more articles as defined herein in the form of, but not limited to: sheet, film, strip, a fabric (such as a polyester fabric) comprising a polymer yarn which is infused with one or more dyes described herein.

In one embodiment the article is a film or strip comprising one or more dyes as defined herein. In another embodiment the film or strip further comprises at least one auxiliary dye. In yet another embodiment, a plurality of films and/or strips may be used. For example, when two or more dyes are used together, these dyes may be present in separate films and or strips. These films and/or strips could be overlaid or placed in alternating films and/or strips.

In yet another embodiment, blending a plurality of dyes in the same film could save costs and be and be a more effective method to have the dyes interact.

In yet another embodiment, a plurality of dyes could be covalently linked to form dimer and/or trimer complexes. Where present, one or more auxiliary dyes could absorb light and transfer the energy of its excited state through Forster Resonance Energy Transfer to one or more dyes to generate a desired fluorescence.

Also disclosed herein is a system comprising a plurality of devices or articles as defined herein.

In one embodiment, the a system as described herein comprises a plurality of devices or articles as described herein, each of which is configured to deliver filtered light in the predetermined direction towards one or more plants located in a predetermined direction.

In another embodiment, an array or system as described herein, is able to or is used to stimulate at least one of:
P660; and
P730,
   in an organism.

### Methods of Synthesis

Disclosed herein is a method of synthesising an article or device as defined herein.

One or more dyes may be added to an article or device described herein using any method known in the art. One or more dyes may be compounded in resin. This can be done where the product is at the correct concentration for sheet extrusion, or a “master-batch” can be produced that is a highly concentrated compounded resin that can be diluted with clear resin to make it up to the correct concentration.

In one embodiment the method comprises the following steps:
dye selection and synthesis;
dye compounding and extrusion into the article, for example a sheet;
optional surface modification of the article or device (for example a sheet) sheet to extract the fluorescence towards the plants by disruption of TIR occurring within the sheet; and
distributing the article or device in the vicinity of one or more plants, for example by suspending the article or device above the one or more plants.

The suspension of one or more articles above one or more plants can alter the spectrum of emitted light for a desired photoperiodic effect.

### Applications and Uses

In its broadest form, a general application of the articles defined herein is to filter sunlight or artificial light used to grow plants, algae, coral or other photosynthetic growth that naturally respond to varied length of day (hours of illumination) to give rise to a photoperiodic effect.

In one basic application an article, such as a sheet or film, could be suspended above one or more plants and/or or used as the ceiling of a greenhouse. Alternatively an article or device described herein could be used as vertically hanging sheets or films between rows of plants. In addition, films, sheets or fabrics could be wrapped around individual plants or even just the budding portion of a branch of a plant to cause the flowers or fruit to be produced.

In one embodiment the articles or arrays described herein use the sun as a light source. However, artificial light sources may utilised in their own right or in conjunction with light emitted by the sun. Examples of artificial light sources include, but are not limited to: lamps like a low pressure sodium lamp, a high pressure sodium lamp, a high pressure mercury lamp, xenon lamp, fluorescent lamp or a high pressure metal halide lamp, standard incandescent light bulbs, tungsten filament, combustion lamps, gas lighting, or Light Emitting Diodes (LEDs). In another embodiment the light source can be positioned outside or within a structure comprising an array or article or device as defined herein, for example outside or within a greenhouse.

Disclosed herein is a greenhouse comprising one or more of the articles, devices and/or arrays as defined herein.

Also disclosed herein is the use of an article or device as defined herein, an array as defined herein, or a greenhouse as defined herein, for targeting phytochrome in plants.

Also disclosed herein is a method for enhancing plant growth, the method comprising a step of exposing one or more plants to light, for example fluorescence, emitted from an article or device as defined herein, or an array as defined herein.

Use of an article or device disclosed herein may result in an overall growth rate for one or more plants. This may not always be the desired outcome. In some cases, growth rates may remain the same or go down, nevertheless, the measure of the effectiveness of the technology disclosed herein is how well it targeted the phytochrome to trigger a desired response. For example, a grower may wish to have their plants flower earlier in the year even if the overall growth rate of the plant stalks is reduced in the process.

In another embodiment the article or device, for example an article or device in the form of a sheet, acts to stimulate phytochromes that control photoperiodism in plants. In a preferred embodiment, this allows control over such processes, including but not limited to: vegetative growth, flowering, fruiting, and ripening of fruits. In addition an article or device described herein could be used to stimulate the production of runners and/or the propagation of seedlings from a “mother” plant.

Herein “plants” or “organism” may include, but is not limited to:
Short day plants, for example, those plants requiring the equilibrium between the P660 and P730 form of phytochrome to be shifted more towards the P660 form by absorption far red light or longer dark periods (night), in order to elicit flowering, fruiting or both. Examples of short day plants include: Kenaf, Marijuana (Cannabis), chrysanthemum and poinsettia, Cotton, Jowar (Sorghum bicolor), Green Gram (Mung bean, Vigna radiata), Soybeans, kalanchoe, onion, some species of strawberries, viola, or a mixture thereof.
Long day plants, for example, those plants requiring the equilibrium between the P660 and P730 form of phytochrome to be shifted more towards the P730 form by absorption red light or shorter dark periods (night), in order to elicit flowering, fruiting or both. Some long day plants include: dill, spinach, foxglove, lettuce, petunia, sedum, hibiscus, carnation, henbane, oat, pea, barley, lettuce, wheat, and mixtures thereof.
Other plants that are day neutral plants, not requiring photoperiodism may also benefit as a result of increased red light lending itself to photosynthesis via absorption by chlorophyll. Such plants include: tomatoes, sunflower, pea plants, common bean, maize and dandelions

In addition, algae may also benefit. Examples are multiple forms of macro algae (seaweed), chlorella, spirulina, dunaliella salina and many others.

In one embodiment an article, device or array defined herein, could be used for terrestrial plants. In another embodiment the articles or arrays could be used to grow algae, coral and stimulate other plants in aquatic environments. For example an article, device or array could be used to maintain aquarium lighting or to grow biomass for photobioreactors.

In yet another embodiment, the article, device or array defined herein, could be adapted for solar energy production where solar cells with higher absorbance or higher photon to electrical conversion efficiencies occur at longer wavelength light. In yet another embodiment, the articles could be used in the form of films and used to convert solar energy to wavelengths that are converted to electricity with higher efficiency.

The articles, devices and/or arrays described herein, could also be used for aesthetic use in windows, skylights or ceiling to give a more pleasing light colour or as a tool in colour therapy.

The articles or arrays described herein may also be useful for photography or videography in creating unique light filters.

In one embodiment an article, device or array described herein could induce one or more of the following actions in a plant:
stimulate germination in one or more seeds;
induce formation of anthocyanins;
stimulate flowering in long-day plants;
inhibits flowering in short-day plants;
elongation of internode inhibition;
induces increase in leaf area;
cause an epicotyl hook to unbend;
inhibit germination of one or more seeds;
inhibits formation of anthocyanins;
inhibit flowering in long-day plants;
stimulates flowering in short-day plants;
promote elongation of internode;
prevent increase in leaf area; and/or
maintain epicotyl hook bend.

### Example Embodiments

1. An article comprising at least one dye which targets at least one phytochrome in a plant.
2. The article of example embodiment 1, wherein the article comprises at least one dye which is a luminescent dye.
3. The article according to example embodiment 1 or example embodiment 2, wherein the article comprises at least one dye which is a perylene type dye.
3. An article capable of targeting at least one phytochrome in a plant, the article comprising at least one dye of Formula (I):

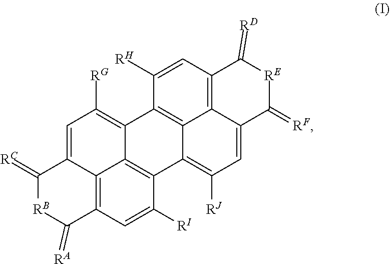

or a salt thereof, wherein:
either:
   (i) R^{A} is O, R^{B} is N, R^{C} is N, and R^{B} and R^{C} are joined by a

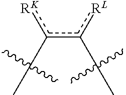

group to form a substituted imidazole group; or
(ii) R^{C} is O, R^{A} is N, R^{B} is N, and R^{A} and R^{B} are joined by a

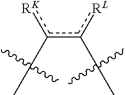

group to form a substituted imidazole group;
either:
   (i) R^{D} is O, R^{E} is N, R^{F} is N, and R^{E} and R^{F} are joined by a

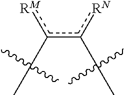

group to form a substituted imidazole group; or
(ii) R^{F} is O, R^{E} is N, R^{D} is N, and R^{D} and R^{E} are joined by a

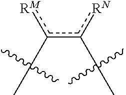

group to form a substituted imidazole group;
R^{K} and R^{L}:
   (i) are joined to form an optionally substituted monocyclic aromatic ring; or
   (ii) are joined to form an optionally substituted polycyclic aromatic group;
R^{M} and R^{N}:
   (i) are joined to form an optionally substituted monocyclic aromatic ring; or
   (ii) are joined to form an optionally substituted polycyclic aromatic group;
at least one of R^{G}, R^{H}, R^{I} and R^{J} is

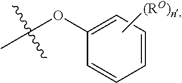

bromine, or chlorine, with the other substituents being hydrogen;
each R^{O} is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.
   4. An article capable of targeting at least phytochrome in a plant, the article comprising at least one dye of Formula (II):

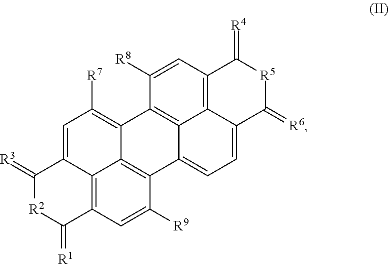

or a salt thereof, wherein:
either:
   (i) R¹ is O, R² is N, R³ is N, and R² and R³ are joined by a

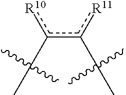

group to form a substituted imidazole group; or
(ii) R³ is O, R² is N, R¹ is N, and R¹ and R² are joined by a

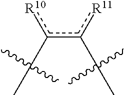

group to form a substituted imidazole group;
either:
   (i) R⁴ is O, R⁵ is N, R⁶ is N, and R⁵ and R⁶ are joined by a

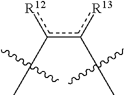

group to form a substituted imidazole group; or
(ii) R⁶ is O, R⁵ is N, R⁴ is N, and R⁴ and R⁵ are joined by a

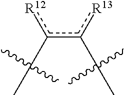

group to form a substituted imidazole group;
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

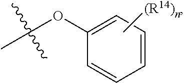

chlorine or bromine, with the proviso that one of R⁷ or R⁸ is

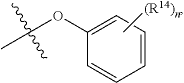

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.
   5. The article of any one or example embodiments 1 to 3, wherein the at least one dye is: at least one dye of Formula (I) as defined in example embodiment 3; at least one dye of Formula (II) as defined in example embodiment 4; or a mixture thereof.
   6. The article of example embodiment 3 or example embodiment 4, wherein at least one dye which targets at least one phytochrome in a plant.
   7. The article of any one of example embodiments 1 to 6, wherein the article comprises at least one dye, wherein the at least one dye emits light at a wave length:
in a range of about 640 nm to about 680 nm; or
in a range of about 710 nm to about 750 nm.
   8. The article according to any one of example embodiments 1 to 7, wherein the article comprises at least one dye that absorbs light:
in a range of about 250 nm to about 600 nm; or
in a range of about 250 nm to about 730 nm.
   9. The article according to any one of example embodiments 1 to 8, wherein the article stimulates at least one of:
P660; and
P730,
   in an organism.
   10. The article according to any one of example embodiments 1 to 9, wherein the article is in the form of a film, fabric or a sheet.
   11. The article according to any one of example embodiments 1 to 10, wherein at least two dyes are present.
   12. The article according to any one of example embodiments 1 to 11, wherein the article is or comprises a resin.
   13. The article according to any one of example embodiments 1 to 12, wherein the article is or comprises a transparent resin.
   14. The article according to any one of example embodiments 1 to 13, wherein the article is composed of or comprises at least one material selected from the group consisting of: polycarbonate, polymethylmethacrylate, polypropylene, polyethylene, polyamide, polyacrylamide, polyvinylchloride or copolymers or any combinations thereof.
   15. An array for enhancing plant growth, the array comprising one or more articles according to any one of example embodiments 1 to 14.
   16. The array according to example embodiment 15, wherein the one or more articles are in the form of strips.
   18. A device comprising one or more articles according to any one of example embodiments 1 to 14.
   19. A greenhouse comprising one or more of the articles according to any one of example embodiments 1 to 14, an array according to example embodiment 15 or example embodiment 16, or a device according to example embodiment 18.
   20. Use of an article according to any one of example embodiments 1 to 14, or an array according to example embodiment 15 or example embodiment 16, a device according to example embodiment 18, or a greenhouse according to example embodiment 19, for targeting phytochrome in plants.
   21. A method for enhancing plant growth, the method comprising a step of exposing one or more plants to light emitted from an article according to any one of example embodiments 1 to 12, an array according to example embodiment 13 or example embodiment 14, a device according to example embodiment 18, or a greenhouse according to example embodiment 19.
   22. A device for delivering filtered light in a predetermined direction, the device comprising:
(a) a body comprising a sheet and a set of light directors coupled to the sheet, wherein:
   (i) each light director extends away from the sheet;
   (ii) the body is transparent to transmit light there through and configured to filter a predetermined range of frequencies from the transmitted light; and
   (iii) the set of light directors is configured to receive light and deliver a majority of the filtered light from the received light in the predetermined direction, and the predetermined direction is normal to a side of the sheet; and
(b) at least one dye which targets at least one phytochrome in a plant.
   23. A device for filtering light and delivering the filtered light, the device comprising:
(a) a set of projecting portions and a sheet portion connecting the set of projecting portions, wherein:
   (i) the set of projecting portions and the sheet portion are transparent and comprise a dye to filter light travelling through the projecting portions;
   (ii) the sheet portion is configured to receive ambient incident light and deliver filtered light to the set of projecting portions; and
   (iii) each of the set of projecting portions comprise an angular offset with respect to the sheet portion to deliver a majority of the filtered light from the set of projecting portions in a predetermined direction, and
(b) at least one dye which targets at least one phytochrome in a plant.
   24. The device according to example embodiment 22 or example embodiment 23, wherein the body, sheet and/or protecting portions comprises at least one dye to filter the predetermined range of frequencies.
   25. The device according to any one of example embodiments 22 to 24, wherein the body, sheet and/or protecting portions comprises at least one dye that emits fluorescence at a wave length:
in a range of about 640 nm to about 680 nm; or
in a range of about 710 nm to about 750 nm.
   26. The device according to any one of example embodiments 22 to 25, wherein the device comprises at least one dye that absorbs light:
in a range of about 250 nm to about 600 nm; or
in a range of about 250 nm to about 730 nm.
   27. The device according to any one of example embodiments 22 to 26, wherein the device stimulates at least one of:
P660; and
P730,
   in an organism.
   28. The device according to any one of example embodiments 22 to 27, wherein the device comprises at least one florescent perylene type dye.
   29. The device according to any one of example embodiments 22 to 28, wherein the device comprises a compound of Formula (I):

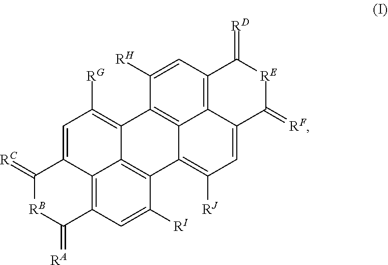

or a salt thereof, wherein:
either:
   (i) R^{A} is O, R^{B} is N, R^{C} is N, and R^{B} and R^{C} are joined by a

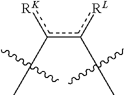

group to form a substituted imidazole group; or
(ii) R^{C} is O, R^{A} is N, R^{B} is N, and R^{A} and R^{B} are joined by a

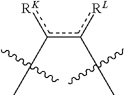

group to form a substituted imidazole group;
either:
   (i) R^{D} is O, R^{E} is N, R^{F} is N, and R^{E} and R^{F} are joined by a

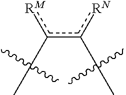

group to form a substituted imidazole group; or
(ii) R^{F} is O, R^{E} is N, R^{D} is N, and R^{D} and R^{E} are joined by a

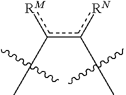

group to form a substituted imidazole group;
R^{K} and R^{L}:
   (i) are joined to form an optionally substituted monocyclic aromatic ring; or
   (ii) are joined to form an optionally substituted polycyclic aromatic group;
R^{M} and R^{N}:
   (i) are joined to form an optionally substituted monocyclic aromatic ring; or
   (ii) are joined to form an optionally substituted polycyclic aromatic group;
at least one of R^{G}, R^{H}, R^{I} and R^{J} is

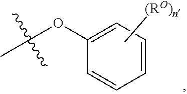

bromine, or chlorine, with the other substituents being hydrogen;
each R^{O} is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.
   30. The device according to any one of example embodiments 22 to 29, wherein the device comprises a compound of Formula (II):

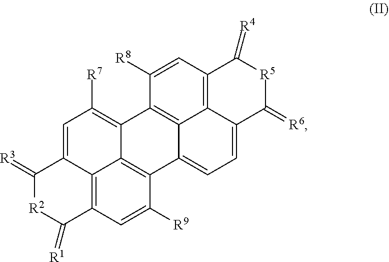

or a salt thereof, wherein:
either:
   (i) R¹ is O, R² is N, R³ is N, and R² and R³ are joined by a

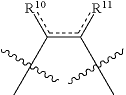

group to form a substituted imidazole group; or
(ii) R³ is O, R² is N, R¹ is N, and R¹ and R² are joined by a

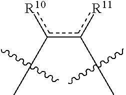

group to form a substituted imidazole group;
either:
   (i) R⁴ is O, R⁵ is N, R⁶ is N, and R⁵ and R⁶ are joined by a

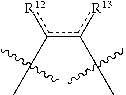

group to form a substituted imidazole group; or
(ii) R⁶ is O, R⁵ is N, R⁴ is N, and R⁴ and R⁵ are joined by a

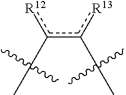

group to form a substituted imidazole group;
R¹⁰ and R¹¹:
   (i) are joined to form an optionally substituted monocyclic aromatic ring; or
   (ii) are joined to form an optionally substituted polycyclic aromatic group;
R¹² and R¹³:
   (i) are joined to form an optionally substituted monocyclic aromatic ring; or
   (ii) are joined to form an optionally substituted polycyclic aromatic group;
R⁹ is:

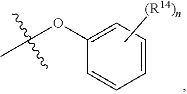

chlorine or bromine, with the proviso that one of R⁷ or R⁸ is

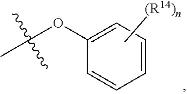

chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.
   31. The device according to any one of example embodiments 22 to 30, wherein each light director and the sheet are integrally formed from a flat sheet.
   32. The device according to any one of example embodiments 22 to 31, wherein the sheet is convex towards the predetermined direction.
   33. The device according to any one of example embodiments 22 to 32, wherein the mean thickness of each light director is smaller than the thickness of the sheet.
   34. The device according to any one of example embodiments 22 to 33, wherein the thickness of each light director decreases in the predetermined direction to progressively increase angles of incidence within the light director in the predetermined direction.
   35. The device according to any one of example embodiments 22 to 34, wherein the set of light directors further comprising a plurality of frustoconical protrusions.
   36. The device according to any one of example embodiments 22 to 35, wherein each of the set of light directors are identically shaped.
   37. The device according to any one of example embodiments 22 to 36, wherein the set of light directors are arranged in rows and/or columns.
   38. The device according to any one of example embodiments 22 to 37, wherein at least one light director comprises an opening at a distal end of the light director.
   39. The device according to any one of example embodiments 22 to 38, wherein the set of light directors are arranged in a periodic pattern along a length of the device.
   40. A system comprising a plurality of devices of any one of the preceding example embodiments.
   41. The system of example embodiment 40, wherein each of the plurality of devices are configured to deliver filtered light in the predetermined direction towards one or more plants located in the predetermined direction.
   42. The article, array, device, greenhouse, use, method and/or system according to any one of the preceding example embodiments, wherein at least one dye is selected from:

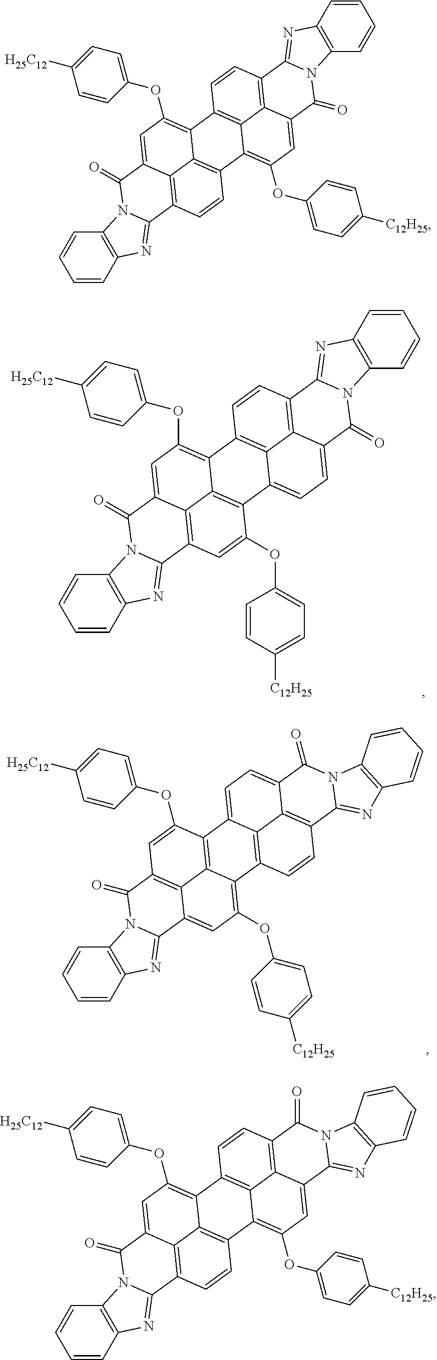

and mixtures thereof.
43. The article, array, device, greenhouse, use, method and/or system according to any one of the preceding example embodiments, wherein at least one dye is selected from:

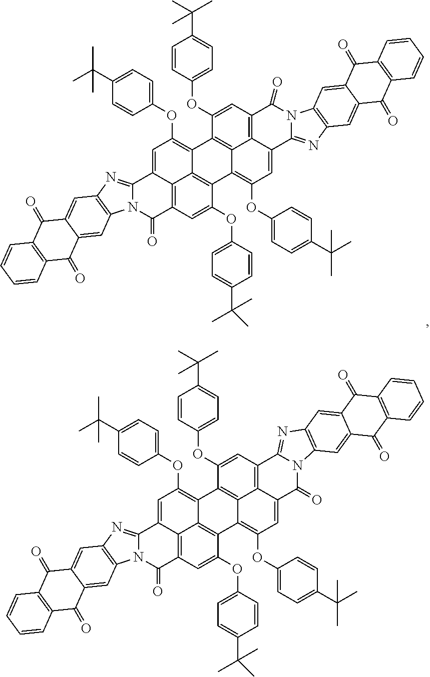

and mixtures thereof.
44. The article, array, device, greenhouse, use, method and/or system according to any one of the preceding example embodiments, wherein at least one dye of Formula (IVa), Formula (IVb) and/or Formula (V), as defined herein, is present.

### Examples

### Equipment:

Unless stated otherwise, UV-Vis spectra were recorded using an Agilent Technologies Cary 60 UV-Vis spectrophotometer using a quartz UV-Vis cuvette with 1 cm path length and fluorescence recorded using a Cary Eclipse fluorescence spectrophotometer using a quartz 1 cm path length fluorescence cuvette.

Unless stated otherwise, low resolution mass spectra were recorded on a Bruker UltrafleXtreme MALDI-TOF/TOF using trans-2-[3-(4-tbutylphenyl)-2-propyenylidene]malonitrile as the ionising matrix.

### Dye Synthesis—Synthesis of Perylene Type Compounds:

Materials used in the synthesis of the exemplified perylene type compounds includes: 1,6,7,12 tetrachloroperylene 3,4:9,10 tetracarboxylic bis anhydride (CAS:156028-26-1), 4-tertbutyl phenol (CAS: 98-54-4), 4-dodecyl phenol (mixture of isomers CAS: 27193-86-8), 2,3 diamino naphthalene (CAS: 771-97-1), 1,2 diamino anthraquinone (CAS: 1758-68-5), quinoline, phenol and zinc acetate hydrate. These were purchased from commercial sources and used without further purification.

### 1,6,7,12-Tetrachloro3,4 9,10-tetracarboxylic dianhydride perylenes (Compound I)

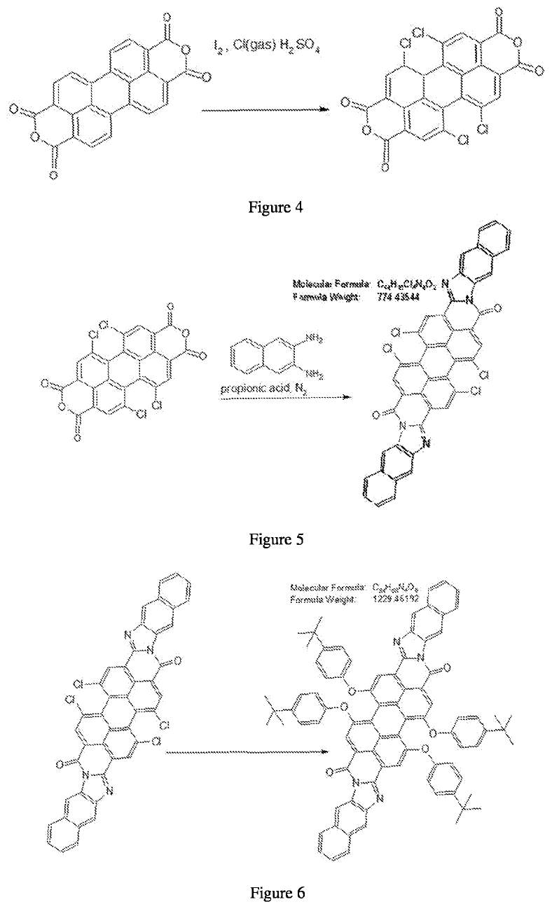

1,6,7,12 tetrachloro 3,4 9,10 tetracarboxylic dianhydride perylene was purchased from commercial sources. It is generally prepared by chlorination of the parent compound, 3,4 9,10 tetracarboxylic perylene dianhydride (PDA), see for example FIG. 4.

### Synthesis of Compound II

The exemplified synthesis of Compound II is shown in FIG. 5. 1.5 g of Compound I (2.8 mmol) was dispersed in 20 mL of propionic acid. 1.5 g of 2, 3 diaminonaphthalene (DAN) was added and the reaction was brought to reflux under nitrogen. The reaction was allowed to continue for 6 hours and was then allowed to cool to room temperature. The resulting slurry was filtered directly, then washed with 100 mL of a 9:1 MeOH:water (v/v) mixture. The solid cake was then washed with multiple portions of hot water, followed by 1% 2M HCl in acetone washings (3×50 mL) that extracted light brown fractions of residual DAN. Finally, 2 more washings with MeOH:water mixture followed by, diethyl ether wash and drying under vacuum afforded 1.9 g of a black/blue powder, with a crude yield of 86%. The product was insoluble and was used without further purification or characterisation.

### Synthesis of Dye 1-3,4:9,10-Bis(2′,3′-naphthyl imidazole)-1,6,7,12 tetra (4′-tertbuytl) phenoxy perylene

An exemplified synthesis of Dye 1, along with the structure of Dye 1 is shown in FIG. 6.

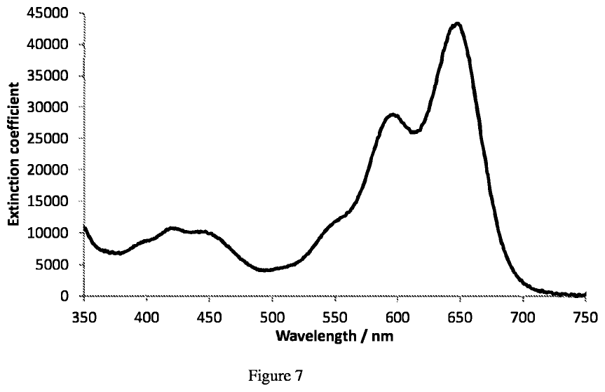

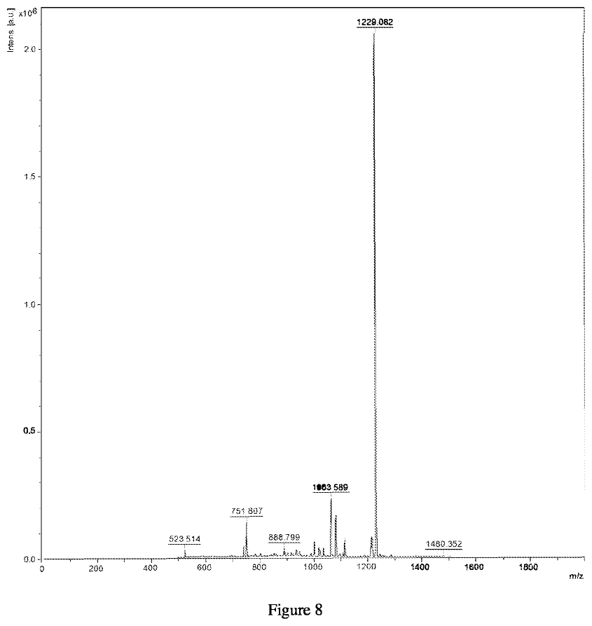

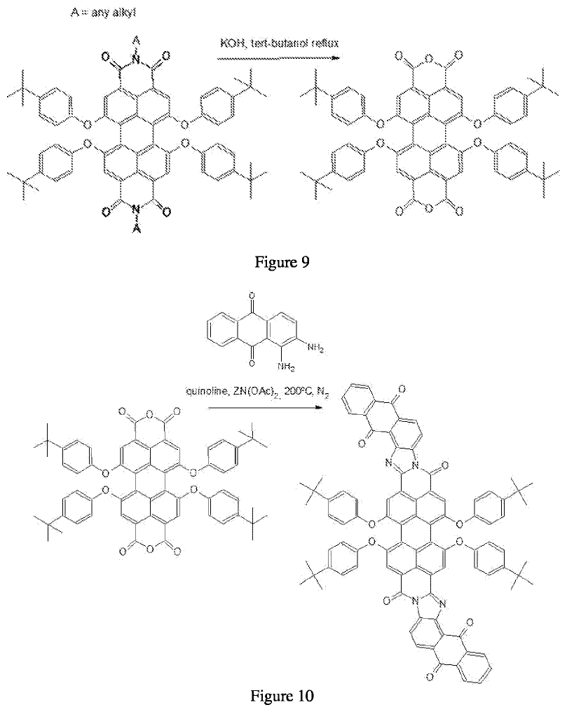

138 mg of Compound II (0.18 mmol) and 270 mg of 4-tertbuytl phenol were dispersed in 5 mL of dimethyl formamide (DMF). 250 mg of K₂CO₃ was added and the mixture was heated to 110° C. under nitrogen for 48 hours and allowed to cool to room temperature. 10 mL of methanol was added and the mixture was filtered. This was followed by another 2×5 mL of methanol washings. The solid cake was then extracted with 15 mL of hot water. Finally, 3×5 mL washings with acetone removed some side materials. The remaining solid was extracted by Sohxlet in toluene and dried under vacuum to afford 20 mg of product, 9% yield. MALDI calculated C₈₄H₆₈N₄O₆ 1229.46, found 1229.082 (FIG. 8) UV/vis in CHCl₃, nm (log 10 ε): 646 (4.63), 595 nm (4.45), 446 nm (4.00) (FIG. 7), Fluorescence max in CHCl₃: 681 nm.

### Synthesis of Compound III

Compound III (1,6,7,12-tetra (4′-tertbutyl) phenoxy 3,4, 9,10 tetra carboxylic perylene dianhydrides) were prepared according to literature methods, see for example: Webb, J. E. A.; Chen, K.; Prasad, S. K. K.; Wojciechowski, J. P.; Falber, A.; Thordarson, P.; Hodgkiss, J. M., Quantifying highly efficient incoherent energy transfer in perylene-based multichromophore arrays. Physical Chemistry Chemical Physics 2016, 18 (3), 1712-1719. An exemplary synthetic method is shown in FIG. 9.

### Dye 2—Tetra (4′-tertbutyl) phenoxy 3,4, 9,10 tetra carboxylic perylene bis (1′,2′ anthraquinone imidazole

An exemplified synthetic pathway for Dye 2 is shown in FIG. 10.

Method 1—In a typical reaction: 3 g of Compound III, 2.4 g of 1,2 diamino anthraquinone and 0.5 g of zinc acetate hydrate were combined in 35 mL of dry quinoline and stirred at 220° C. for 6 hours under nitrogen. The reaction was allowed to cool to room temperature, diluted with 100 mL of methanol and filtered. The remaining solid was extracted repeatedly with 2M aq HCl, followed by acetone until a clear filtrate was obtained. The crude solid was then subjected to Sohxlet extraction in toluene to yield 2.7 g (63%) of the desired compound. ¹H 300 Mz NMR (CDCl₃) δ=9.16-9.41 br (2H perylene), 7.97-8.44 br (4H perylene, 2H benzimidazole), 7.78-7.81 (4H perylene), 7.29-7.34 (8H phenoxy overlap with CHCl₃), 6.81-6.99 (8H phenoxy), 1.25-1.37 (36H, tertbutyl) MS (MALDI) calc. for 1389.55, found 1389.18. UV/vis in CHCl₃, nm (log 10 ε): 657 (4.64), 614 nm (4.54), 468 nm (4.16), Fluorescence max in CHCl₃: 696 nm.

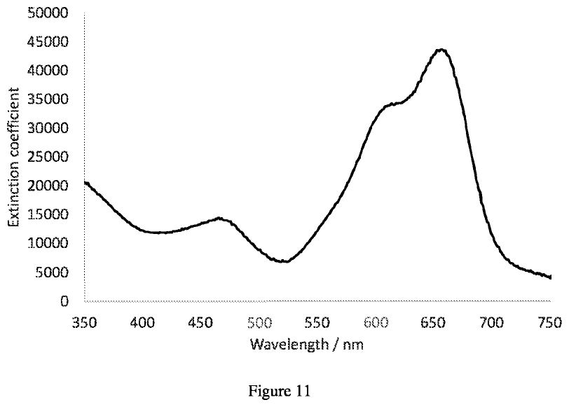

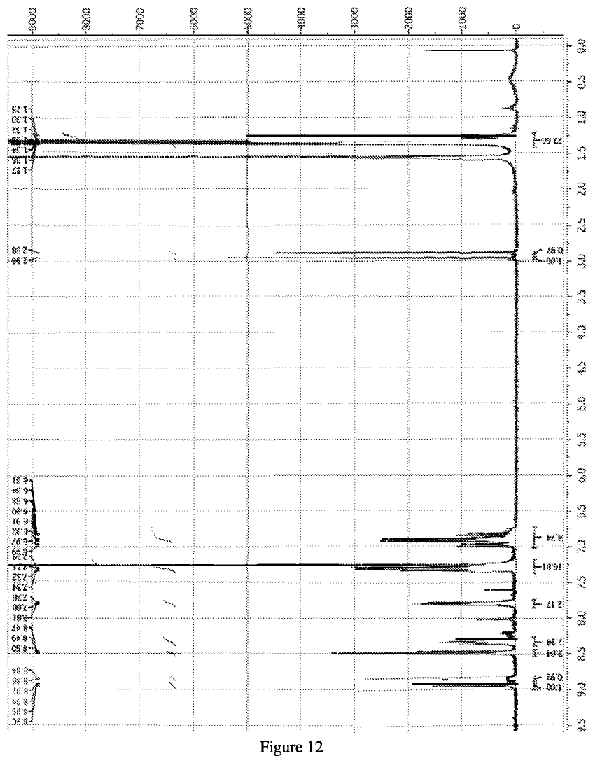

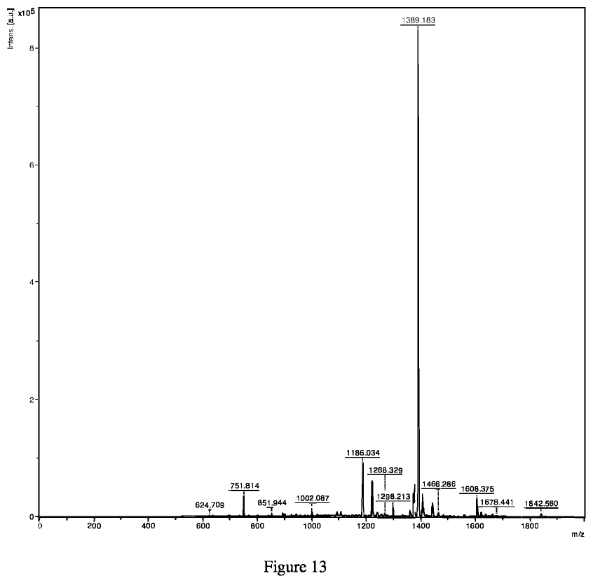

A UV/Vis spectrum is shown in FIG. 11, an ¹H NMR spectrum is shown in FIG. 12, and a MALDI-TOF MS spectrum is shown in FIG. 13.

Method 2—The same procedure as Method 1 was used but with phenol as the solvent. A similar yield was obtained.

### Dye 3—Isomeric Mixture of 3,4:9,10-Bis(1′,2′-benzimidazole)-1,7 bis(4-dodecyl) phenoxy and 3,4:9,10-bis(1′,2′-benzimidazole)-1,6 bis(4-dodecyl) phenoxy perylenes

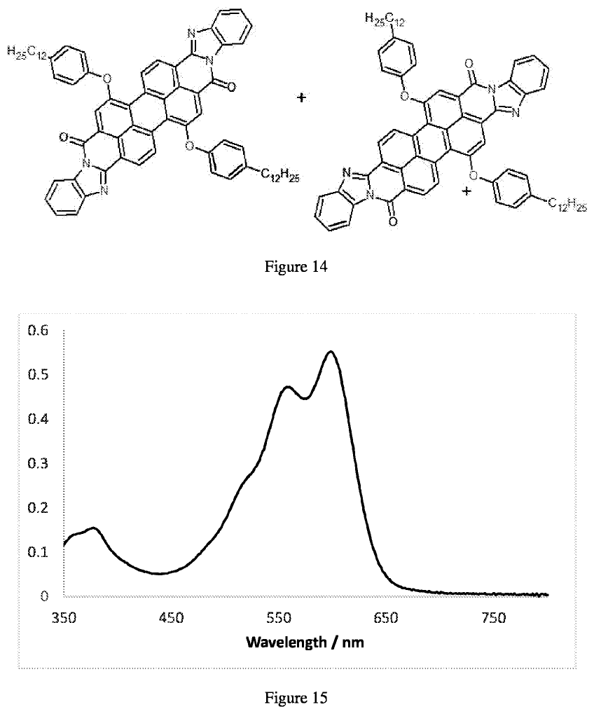

The structures of the mixture is shown in FIG. 14.

### 1,7 & 1,6 Dibromoperylene-3,4:9,10-tetracarboxylic Acid Bisanhydride

A mixture of 1,7 and 1,6 dibromoperylene-3,4:9,10-tetracarboxylic acid bisanhydride (Scheme 1), was generated by bromination of perylene 3,4:9,10 tetracarboxylic bis anhydride according to a literature procedure (J. Org. Chem. 2004, 69, 7933-7939, the contents of which are incorporated by reference).

A mixture of 100 g of perylene-3,4:9,10-tetracarboxylic acid bisanhydride (Compound 1A) and 1.5 kg of 100 wt % sulfuric acid was stirred for 12 hours at room temperature, and subsequently I₂ (2.5 g) was added. The reaction mixture was heated to 85° C., and 90 g of bromine was added dropwise over a time period of 8 hours down a large, water-cooled condenser. After bromine addition, the reaction mixture was heated for an additional 10 hours at 85° C. HBr gas formed during the reaction was vented from the top of the condenser by a gentle stream of nitrogen gas into a 500 mL aqueous quenching solution of w/w 5% NaOH, 0.05% Na₂S₂O₅. The reaction was cooled to room temperature and excess bromine was removed by bubbling the reaction with nitrogen gas into the quenching solution. 65 mL of water was added carefully to precipitate the product. The resulting precipitate was separated by filtration through a G4 funnel, washed with 3×300 g of 86% sulfuric acid followed by a large amount of water. The product was dried in a vacuum to give 135 g (96%) of an isomeric mixture of 1,7 & 1,6 dibromoperylene-3,4:9,10-tetracarboxylic acid bisanhydride as a red powder. The crude product could not be purified since it is insoluble in organic solvents and was used without further purification.

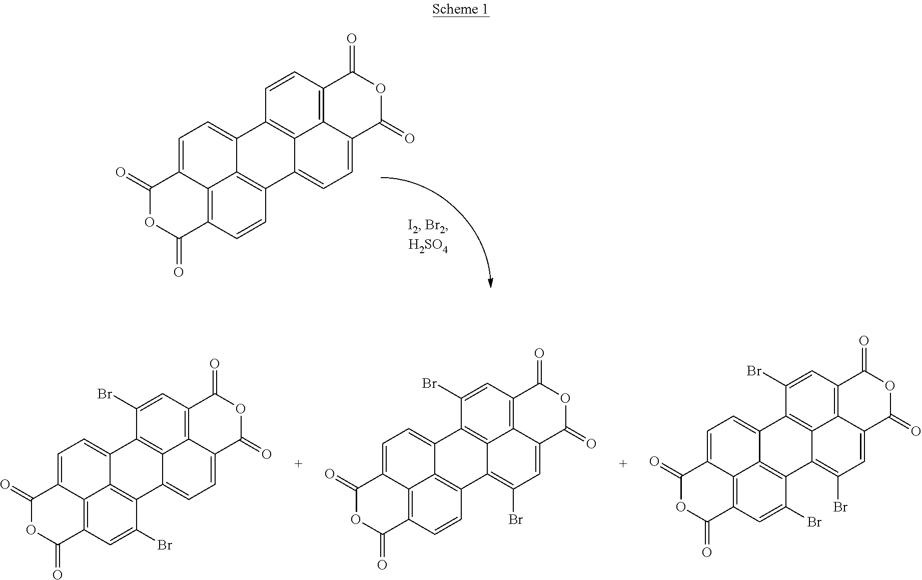 [SMILES: O=C1OC(=O)c2ccc3c4ccc5c6c(ccc(c7ccc1c2c73)c64)C(=O)OC5=O ; O=C1OC(=O)c2cc(Br)c3c4ccc5c6c(cc(Br)c(c7ccc1c2c73)c64)C(=O)OC5=O ; O=C1OC(=O)c2ccc3c4c(Br)cc5c6c(cc(Br)c(c7ccc1c2c73)c64)C(=O)OC5=O ; O=C1OC(=O)c2cc(Br)c3c4c(Br)cc5c6c(cc(Br)c(c7ccc1c2c73)c64)C(=O)OC5=O]

The literature has shown that the trans and cis isomers, typically in an 8:2 ratio, along with trace amounts of 1,6,7 tribromoperylene-3,4:9,10-tetracarboxylic acid bisanhydride (>2%) are formed in this procedure. These isomers may persist in the same ratios in the dyes derived from them described herein.

### 3,4:9,10-Bis(1′,2′-benzimidazole)-1,7 & 1,6 Dibromoperylene

3,4:9,10-bis(1′,2′-benzimidazole)-1,7 and 1,6 dibromoperylene (Compound 2A) was formed by taking 40 g of Compound 1A (36 mmol) and 16 grams of Zn(OAc)₂•H₂O were dispersed in 350 mL of a stirring 1:1 v/v mixture of n-butanol and propionic acid. 10 g of o-phenylene diamine was added and the reaction was brought to reflux under nitrogen. The reaction continued for 6 hours and was then allowed to cool to room temperature. The resulting slurry was filtered directly, then washed with 300 mL of a 9:1 MeOH:water (v/v) mixture. The solid cake was then washed with multiple portions of hot water, followed by 1% 2M HCl in acetone washings (3×200 mL) that extracted light brown fractions of excess o-phenylene diamine. Finally, two more washings with MeOH:water mixture followed by drying under vacuum afforded 43 g of a dark purple powder, with a yield of 86%. MS (MALDI) calc. for C₃₆Br₂H₁₄N₄O₂ 694.33, found 694.27 UV/vis in CHCl₃, nm (log 10 ε): 598 (5.68), 558 nm (5.61), 378 nm (5.13), Fluorescence max in CHCl₃: 646 nm.

Scheme 2 shows the trans isomer. Trans and cis dibromo species are formed along with the possible anti and syn isomers for the benzimidazole groups. In total there are four possible isomers, as well as trace amounts of the tribromo species.

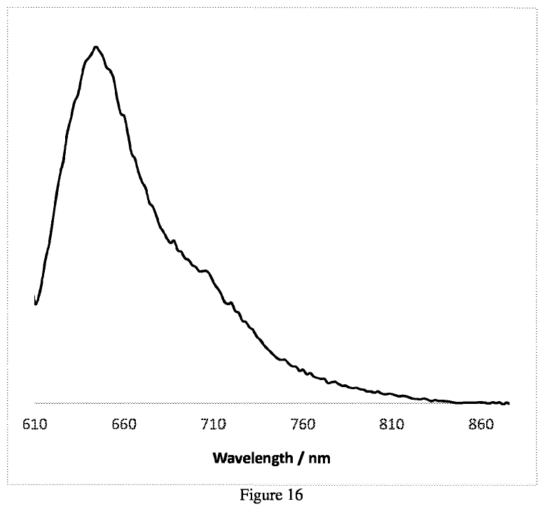

The UV/vis absorbance and florescence spectra for Compound 2A are shown in FIG. 15 and FIG. 16, respectively.

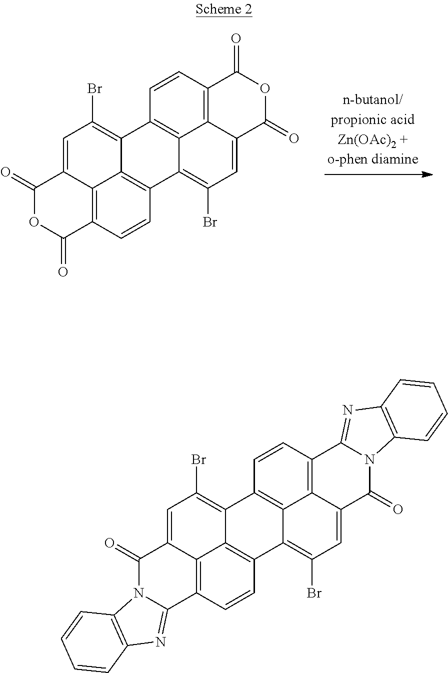 [SMILES: O=C1OC(=O)c2cc(Br)c3c4ccc5c6c(cc(Br)c(c7ccc1c2c73)c64)C(=O)OC5=O ; O=c1c2cc(Br)c3c4ccc5c6c(cc(Br)c(c7ccc(c2c73)c2nc3ccccc3n12)c46)c(=O)n1c2ccccc2nc51]

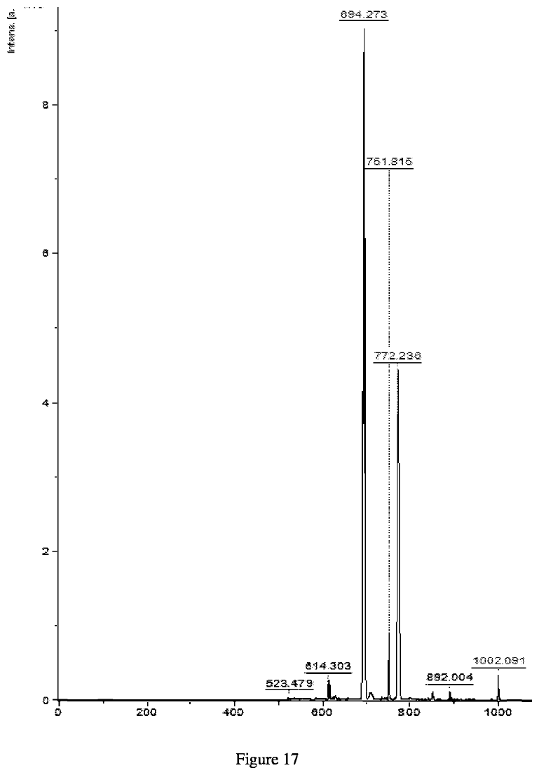

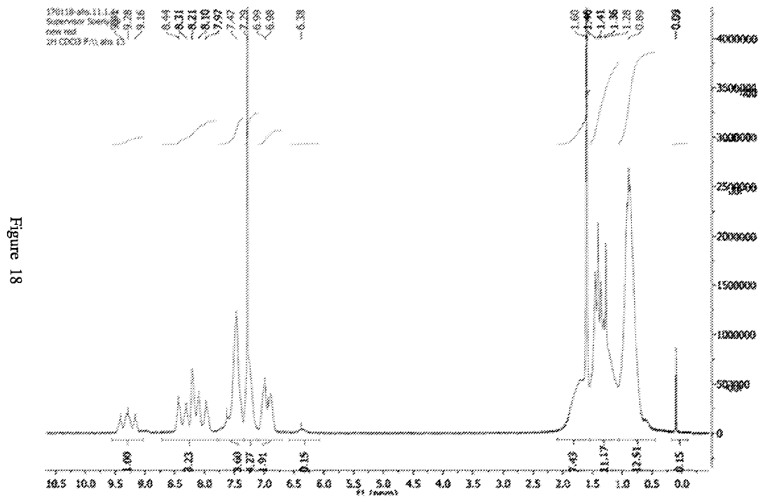

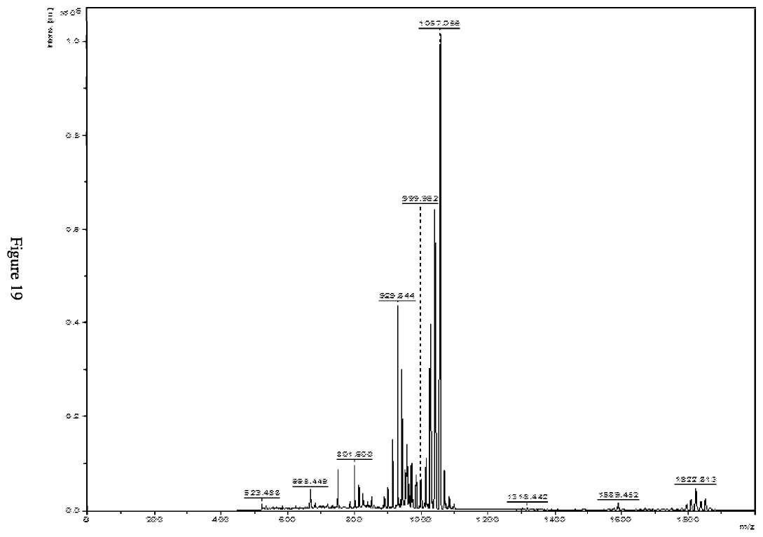

FIG. 17 shows a MALDI-TOF MS spectrum of Compound 2A. The peak at 772.236 shows the tribromo species that was not isolated.

### 3,4:9,10-Bis(1′,2′-benzimidazole)-1,7 and 1,6 bis (4″-dodecyl) phenoxy perylenes

3,4:9,10-Bis(1′,2′-benzimidazole)-1,7 and 1,6 bis (4″-dodecyl) phenoxy perylenes (Compound 3A) was formed by taking 56.6 g of 4-dodecyl phenol (mixture of isomers) was poured into a 1 L round bottomed vessel and diluted with 600 mL of DMF. 30 g of Compound 2A (43.2 mmol) was added by funnel along with 30 g of K₂CO₃. The mixture was heated to 110° C. under nitrogen for 6 hours and allowed to cool to room temperature. 600 mL of methanol was added and the mixture was filtered in a 500 mL Buchner funnel. The dark filtrate, composed largely of side products, was discarded. This was followed by another 2×200 mL of fresh methanol washings. The solid cake was then extracted with 1.5 L of boiling, distilled water. Finally, 3×200 mL washings with acetone removed some side materials. The remaining solid was dried under vacuum to afford 39.90 g of product, 88% yield. ¹H 300 Mz NMR (CDCl₃) δ=9.16-9.41 br (2H-perylene), 7.97-8.44 br (4H-perylene, 2H benzimidazole), 7.47 br (4H-benzimidazole). 7.29 br (4H phenoxy overlap with CHCl₃) 6.98-6.99 (4H-phenoxy). 0.89-1.41 br (50H, dodecyl) MS (MALDI) calc. for C₇₂H₇₂N₄O₄ 1057.37, found 1057.06 UV/vis in CHCl₃, nm (log 10 ε): 606 (4.77), 567 nm (4.64), 378 nm (4.04), Fluorescence max in CHCl₃: 634 nm.

Scheme 3 only shows the anti, trans isomer.

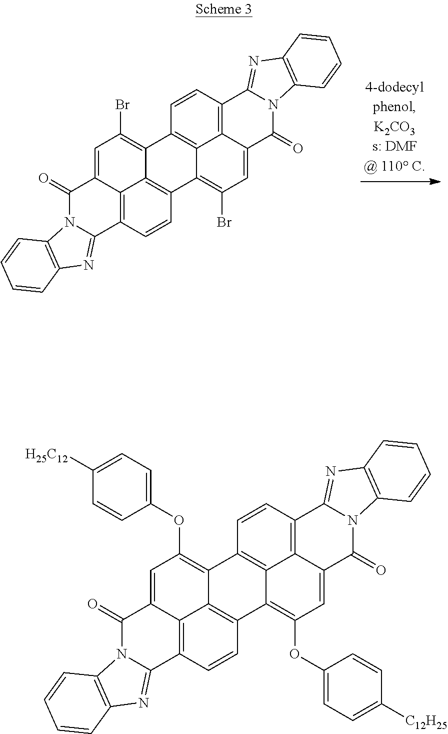

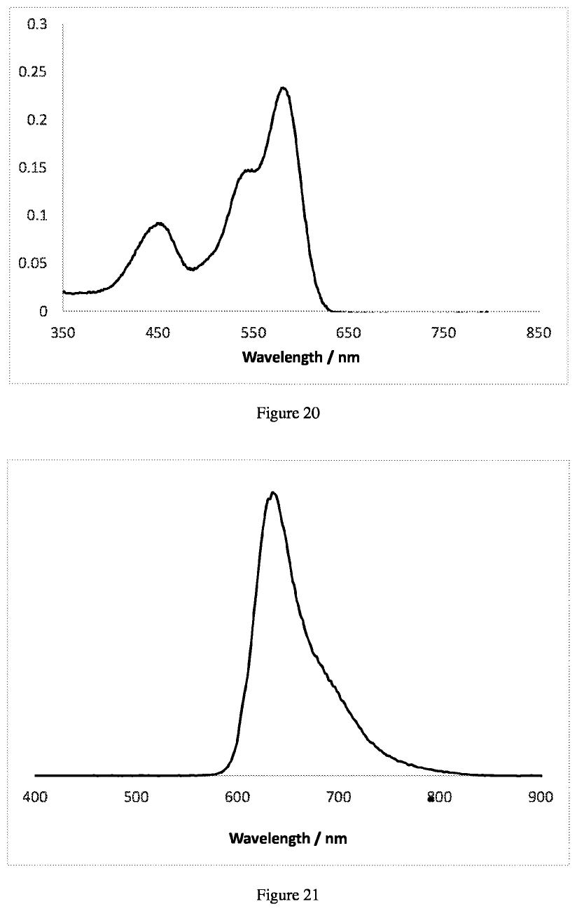

¹H NMR, MALDI, UV/vis absorbance and fluorescence characterisation of Compound 3A (Dye 3) are shown in FIG. 18, FIG. 19, FIG. 20 and FIG. 21, respectively.

### Dye 4—Mixture of 1,7 bis (4′ tertbutyl) phenoxy 3,4, 9,10 bis cyclohexyl imide and 1,6 bis (4′ tertbutyl) phenoxy 3,4, 9,10 bis cyclohexyl imide

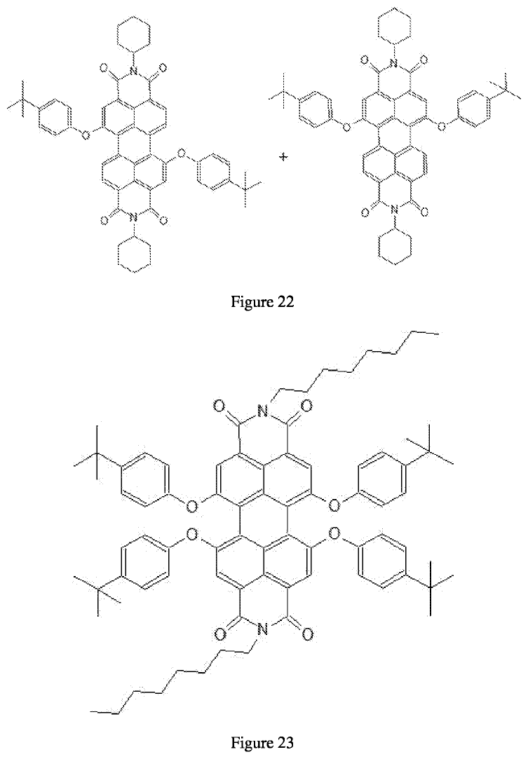

The structure of Dye 4 is shown in FIG. 22.

This dye was prepared according to reported methods in Webb, J. E. A.; Chen, K.; Prasad, S. K. K.; Wojciechowski, J. P.; Falber, A.; Thordarson, P.; Hodgkiss, J. M., Quantifying highly efficient incoherent energy transfer in perylene-based multichromophore arrays. Physical Chemistry Chemical Physics 2016, 18 (3), 1712-1719.

### Dye 5—1,6,7,12-Tetra (4-tertbutyl) phenoxy dioctyl imide perylene

The structure of Dye 5 is shown in FIG. 23. This dye, CAS number 872005-48-6 may be purchased from a commercial source, for example SAGECHEM or Aurum Pharmatech LLC.

Dye 1 and Dye 2 have extremely similar absorbance and fluorescence spectra. However, Dye 2 proved to be cheaper to produce as the diamino anthraquinone is far less costly than the diamino naphthylene.

Resin Compounding and Extrusion into Sheet

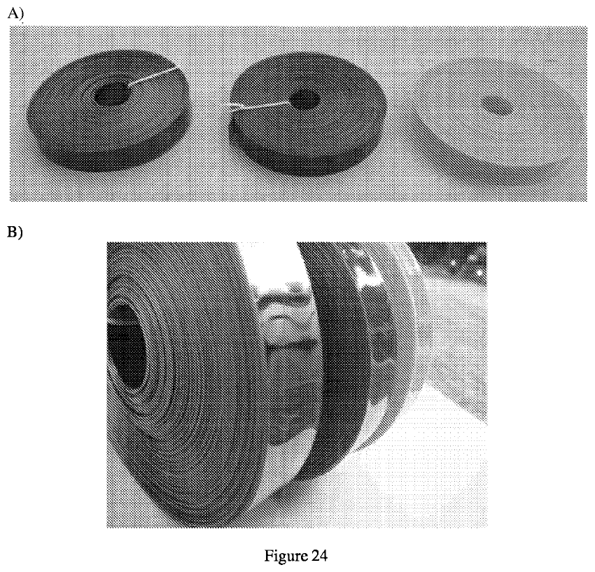

Dyes 1, 3 and 4 were compounded into polycarbonate and extruded into sheets 4.5 cm wide, to form strips with a thickness of 500 microns (0.5 mm). The dye is first dry coated onto clear pellets of resin. The coated pellets are then melted under heat and pressure near 180° C. and extruded into thin strands that are cut to form new pellets. This can then be used as a raw material for extrusion. Extrusion involves the melting of resin and pressurised ejection through a designed outlet to give the resin a shape, i.e. a slit for a sheet or a circle for a tube. These sheets are shown in FIG. 24.

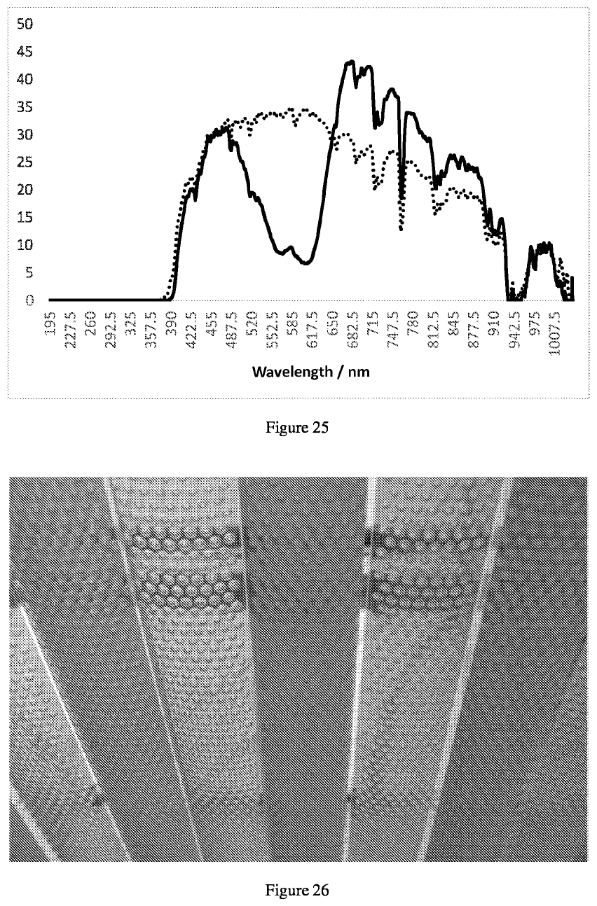

The spectral measurement for Dye in plastic film (0.5 mm polycarbonate) is shown in FIG. 25 as a solid line, showing a filtering of light by the dye between 500-600 nm and an enhanced amount of light near 660 nm. The normal solar spectrum is shown as a dashed line.

Alternating Dye 3 plastics with Dye 4 plastics overlaid on top of Dye 3 plastics for additive “donor/acceptor” enhanced effect are shown in FIG. 26.

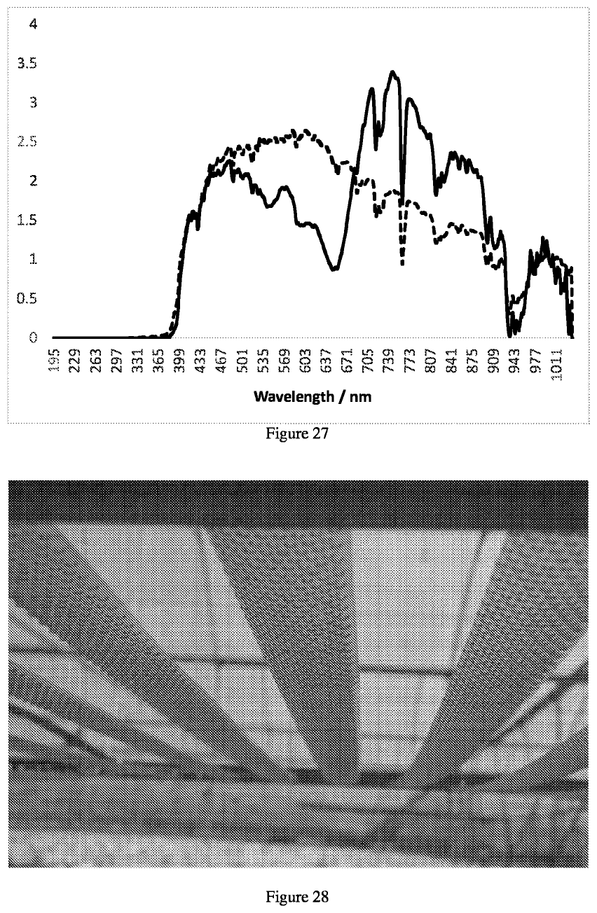

FIG. 27 shows a spectral measurement under Dye 1 plastic film (solid line) showing a filtering of light by the dye between 550-650 nm and an enhanced amount of light near 730 nm (dashed line).

FIG. 28 is an image of Dye 1 plastics in polycarbonate. The luminescence cannot be seen as the emissions occur beyond the red wavelength limits of the human eye. The solar spectrum of the plastics shows a combined effect of the transmission resulting from the absorbance of the dye as well as the enhanced intensity if wavelengths.

Surface Modification of the Sheet to Extract the Fluorescence Towards the Plants by Disruption of Total Internal Reflection (TIR) Occurring within the Sheet

Extruded sheets were further subjected to surface modifications to extract fluorescence by disruption of TIR. This was done by designing an effective geometry on a surface moulding process that extracts luminescence one face of the sheet.

Etching the plastic (scratching, scoring, sanding) or inclusion of light dispersive particles extracts luminescence isotropically where 50% of the luminescence is released towards the sky rather than the plants below. The current invention describes a luminescent sheet that undergoes a moulding process to create a plurality of the geometric extractors across the face of sheet that is unique in comparison to prior art as it extracts luminescence more out of one face of the sheet than other.

Completely exclusive extraction from one face is not reasonably possible to achieve as principles of TIR describe an “escape cone” of luminescence that is perpendicular, or close to perpendicular, to the sheet will not be trapped by TIR. This is generally 12.5% of the total luminescence from each of the 2 faces (25% total) for most resins having a refractive index of approximately 1.5.

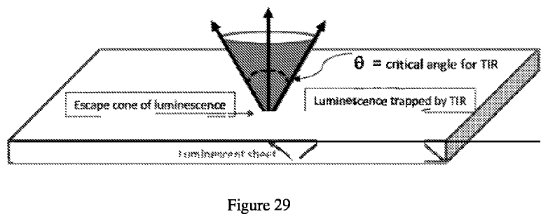

FIG. 29 shows a simple luminescent sheet with no extraction features has an escape cone of luminescence from each face that is perpendicular (0 degrees to normal) up to the critical angle for TIR.

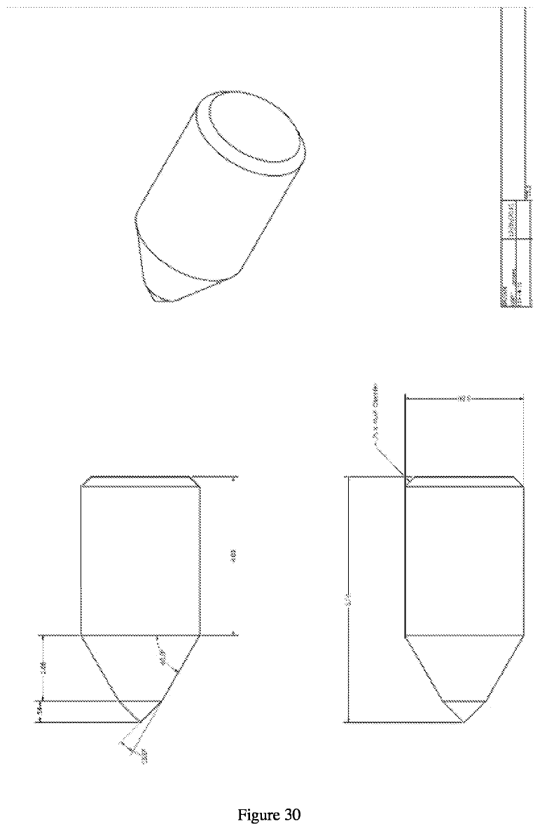

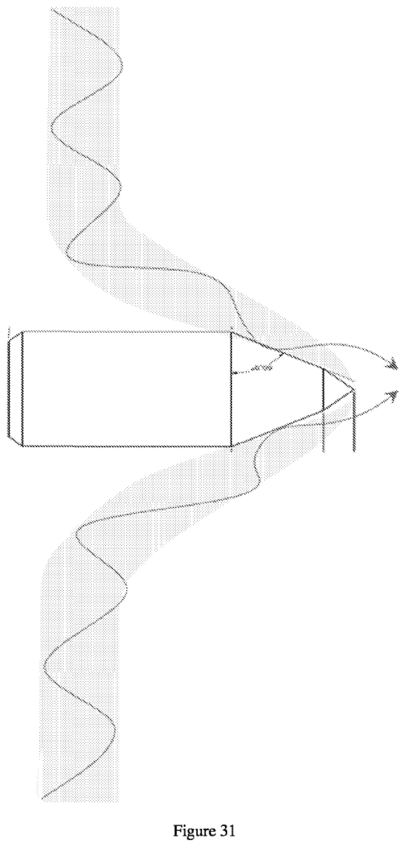

A continuous moulding machine was developed for this purpose. A cold forming machine was designed to have two rollers with matching male and female heads to interlock, as they turn in opposite directions, where the male head has an array of sharp protrusions and the female head has holes that match the size and depth of the male head protrusions. FIG. 30 shows an example of the protrusions. The gap between the rollers is set to the thickness of sheet. As the rollers turn, the sheet is pulled between the rollers and ejected out the other end. The protrusions on the male head press downwards on the sheet causing a punch in the sheet that gets pushed downwards into the female roller head as it forms and is quickly released as it comes out from between the rollers. The result is a sheet with an array of punctures that have close to nil thickness at the centre of puncture. In some cases, the plastic may actually break through or it may be reduced to a thickness that is less than 10% of the unformed sheet. The thinner, the material becomes, the better the extraction of luminescence.

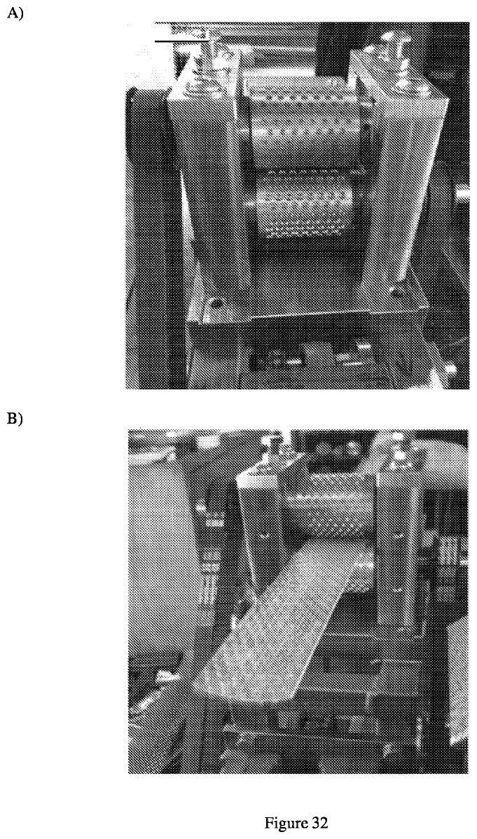

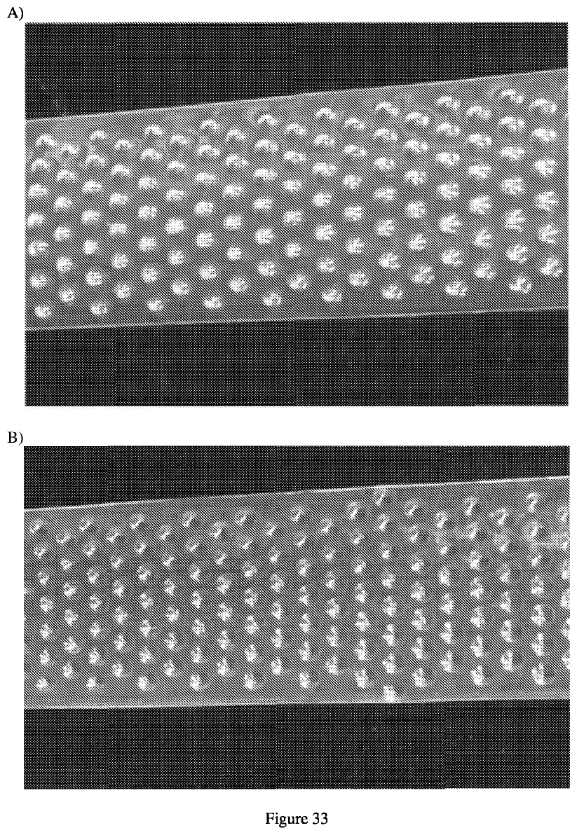

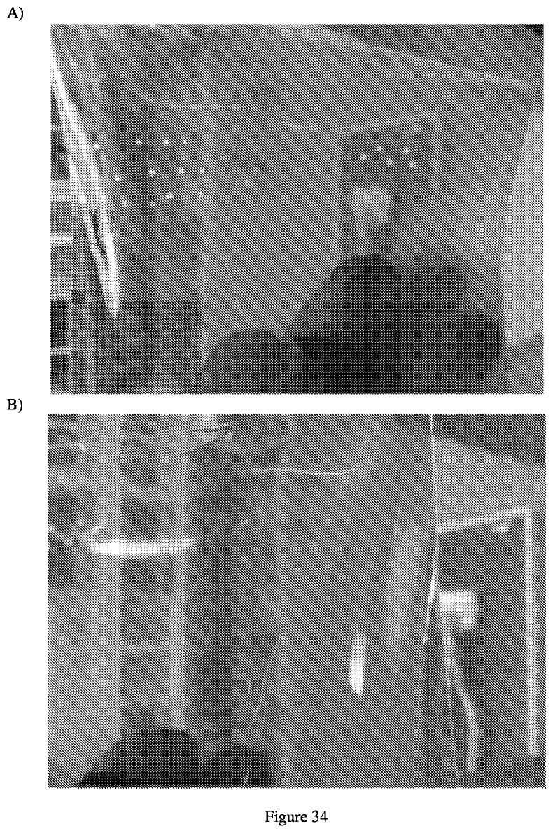

The extractor geometry shown in FIG. 31 depicts a luminescent sheet having a deformation where a puncture shape is created through a moulding process. The moulding process and machine are shown in FIG. 32. The polymer is deformed and is thinned as the material stretches to create the new shape having a larger surface area. This localised stretching of the plastic causes the thickness to decrease to 0 (or near 0) at the bottom of the depression and then increase again up the other side. Luminescent light that is normally trapped within the sheet following the laws of TIR will having different reactions to this geometrical shape depending on its direction of travel either towards the depression or away from it.

TIR light that is travelling toward the depression will be coming from the thicker material at the top and travelling down into the depression experiencing a thinning of the material. This causes increasing angles of incidence for reflected luminescent photons which, in turn, will cause the luminescent to be extracted out of the sheet. All such photons being extracted this way will have a downward vector of travel and will be found to be traveling below the plane of the sheet in the desired direction towards the plants.

TIR light travelling away from the depression, having been generated by luminescence somewhere within the depression, will have a direction of travel where the photons experience the polymer becoming thicker and therefore the degree of TIR will increase, ensuring the light remains trapped. This light has a general upward direction of travel towards the plane above the sheet, and does not become extracted. Rather the light will continue to travel within the sheet until it encounters the next extractor where is will have a downward vector and then become extracted.

By this design a luminescent extractor sheet has been developed where the luminescence is selectively extracted out of one face of the sheet rather than isotropically as found with other extraction techniques known in the art.

FIG. 33 image A) shows the extraction face of a processed sheet as defined herein showing bright yellow fluorescence emitted from each extractor point. Image B shows back side of the same plastic strip showing a lack of fluorescent light. This proves selectivity of extraction face.

The use of the geometry is shown in FIG. 34. Protrusions formed by a sharp implement in a flat sheet of 0.5 mm thickness containing a fluorescent dye (Dye 4 in 0.5 mm polycarbonate). In image A) the fluorescence is very clearly extracted. In image B), the backside of the protrusion shows no fluorescence. Thus, a one-sided extraction technique is displayed.

### Field Applications

Formed sheets were suspended above the plant growth to filter and alter the spectrum for the desired photoperiodic effect

The three compounded sheets of Dye 1, Dye 3 and Dye 4 were moulded with the extraction features described above and installed for field trials.

Cannabis Trial: Location: Buddy Boy Farms LLC, Spokane, Wash. USA

In the indoor nursery, vegetative growth was tested. An apparatus was constructed to isolate 3 plants for each treatment: Control, Dye3+Dye4, long day effect film), and Dye 1+Dye 3(short day effect film). Each treatment was enclosed in an isolated chamber with white walls for maximum reflection and a window at the top where light enters. Each chamber had its own light fixture (with coloured plastics for Dye 3+Dye 4) resting on the window and was ventilated with a small exhaust fan.

Dye 3+Dye 4 had a growth increase from day 3-day 19 that was 67% higher than Control. Dye 1+Dye 4 also had a notably increased growth rate and final height. Maximum height achieved was significantly higher for experimental plants over Control.

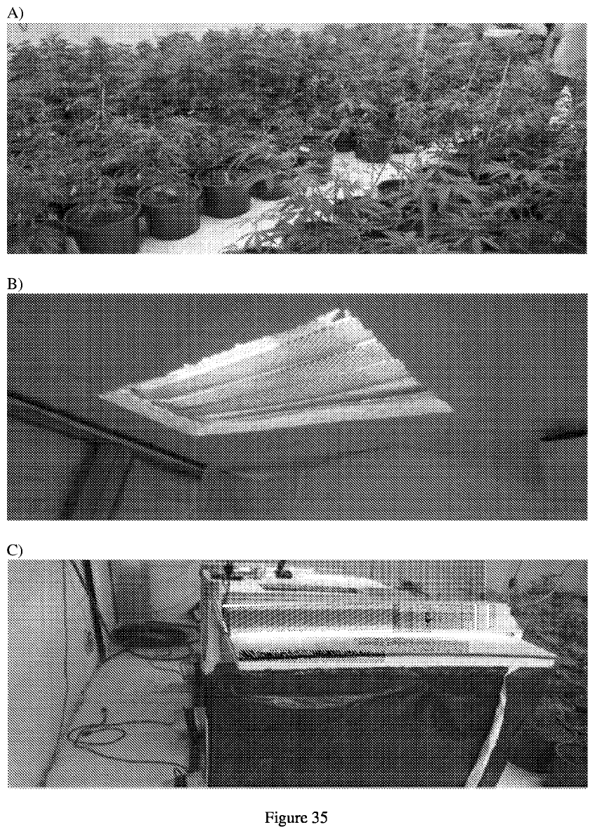

FIG. 35 image A) shows the cannabis indoor nursery. Image B shows inside the trial apparatus looking up at the light source shining downward through the films into the trial chamber. Image C) shows trial apparatus from the outside showing light source shining exclusively into individual chambers.

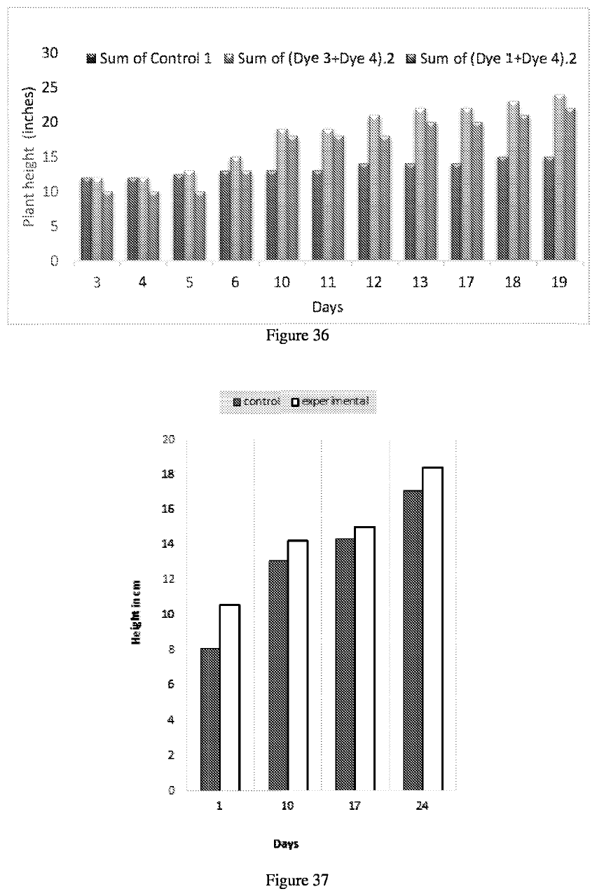

A graph of the results is shown in FIG. 36. Specific values for the results are shown in Table 5.

TABLE 5
Results for cannabis growth - height in inches
for various groups on selected days.

| Day | Control 1 | (Dye 3 + Dye 4).2 | (Dye 1 + Dye 4).2 |
|---|---|---|---|
| 3 | 12 | 12 | 10 |
| 4 | 12 | 12 | 10 |
| 5 | 12.5 | 13 | 10 |
| 6 | 13 | 15 | 13 |
| 10 | 13 | 19 | 18 |
| 11 | 13 | 19 | 18 |
| 12 | 14 | 21 | 18 |
| 13 | 14 | 22 | 20 |
| 17 | 14 | 22 | 20 |
| 18 | 15 | 23 | 21 |
| 19 | 15 | 24 | 22 |

### Leafy Vegetable Trial, Location: Private Greenhouse Near Sydney, Australia

In a domestic greenhouse, Bok Choy and Choy Sum were randomly co-seeded (50:50) in a hydroponic system. One tray for each Control and the Dye 4+Dye 5 (4/5) treatment.

The 4/5 treatment displayed an increase in leaf height, root length, leaf biomass and root biomass:
36% overall increased biomass including roots.
37% increased yield of vegetative biomass

Root length was the same indicating that the hydroponic system fed supplied sufficient nutrients. Results of this trail are shown in Table 6 and FIG. 37.

TABLE 6
Tabulated results of bok choy trial.

| Characteristic | Control | D4/5 |
|---|---|---|
| Average weight without root (g) | 43.15 | 59.17 |
| Average length of the root (cm) | 18.4 | 18.4 |
| Average weight of the root (g) | 3.29 | 4.28 |
| Total weight (g) | 46.44 | 63.44 |

### Strawberry Trial, Location: PT Strawberindo Lestari, Near Jakarta, Indonesia

Starting September 2016, a 36 m² trial was established in a greenhouse with June-bearing strawberry seedling freshly imported from Europe to Indonesia. June bearing plants typically cycle between vegetative and fruiting stages that last 1-3 months.

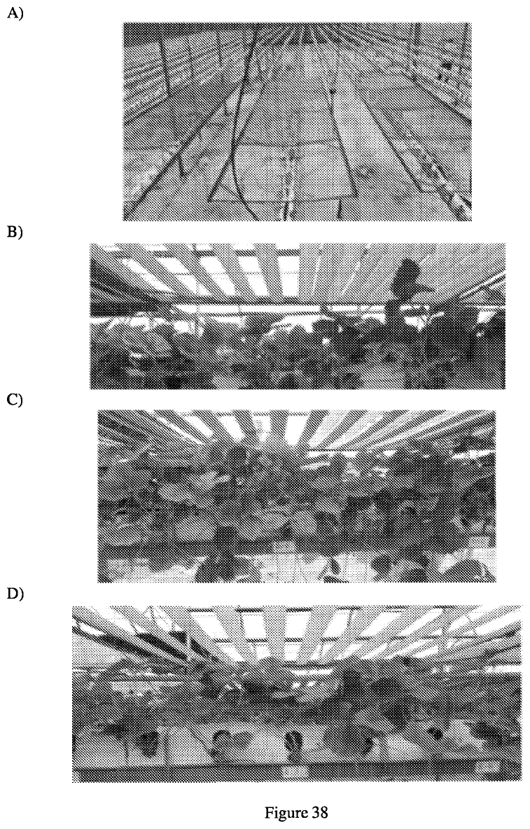

The plants were treated with Dye 3 (3), Dye 3+Dye 4 (3/4), Dye 1(1) and Dye 1++Dye 4 (1/4) plastics by hanging constructed panels over the plants trays. In some cases, the plastics were spaced apart to cover only 50% of the air space above the plant to test partial vs full coverage. FIG. 38 shows: the entire trial in image A). Each section tests a different colour treatment with 0% (clear plastic), 50% (coloured film with gaps) and 100% coverage; treatment (3) showing the 50% and 100% coverage in image B; Dye 3 layered with Dye 4 (3/4) treatment showing the 50% and 100% coverage in image C); and Dye 1 (1) treatment of 50% in image D).

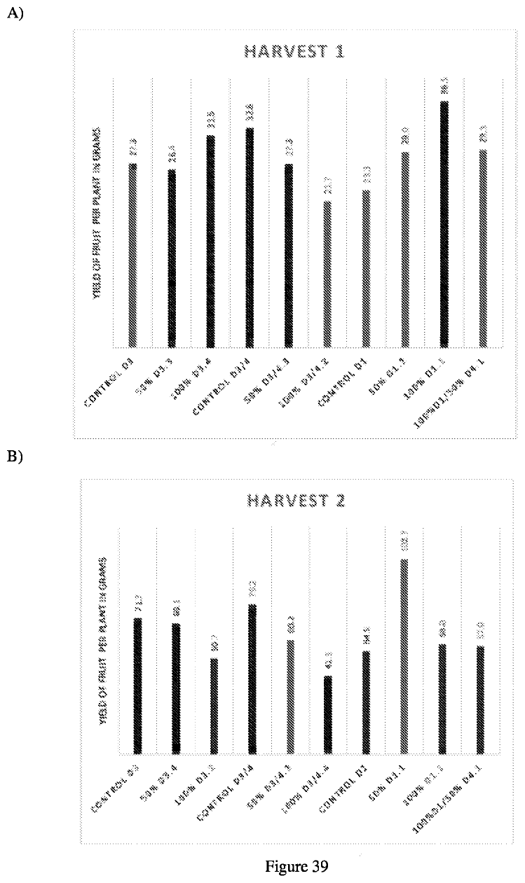

The data in FIG. 39 shows the weight of fruit harvested per plant from two consecutive harvest cycles, Harvest 1 and Harvest 2.

Harvest 1 occurred very soon after planting as is typical of imported plants behaviour. This harvest showed the effect of the plastics on the conversion of already developed flowers into fruit. The overall yield for all plants was smaller for Harvest 1 than Harvest 2.

Over Both Harvests we Observe:
The (D1) fruiting frequency treatment (P730 stimulation) had strong impact yield of fruit harvested, much more so for Harvest 2 than Harvest 1.
The (3) and (3/4) vegetative frequency treatment showed a reduced fruit production, but a positive effect on observed vegetative growth.

In conclusion the films as defined herein can enhance green vegetable growth by very significant margins, representing a viable market for the technology.

All dyes positively impacted vegetative growth under 24 hr/day fluorescent lighting by improving the quality of the generally poor light source, as shown in the cannabis trial. The Dye 3/4 treatment, designed for vegetative or long day growth, had the highest growth impact, and can be used for commercial growth. Next step will be to deploy trials in the flowering/budding growth stages with a focus on the B treatment for enhanced flowering and fruiting.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Dye 6: 3, 4, 9, 10 Bis (phenazine 2′,3′ imidazole) 1,6,7,12 tetra (4′-dodecyl phenoxy) perylene

Dye 6 (3, 4, 9, 10 Bis (phenazine 2′,3′ imidazole) 1,6,7,12 tetra (4′-dodecyl phenoxy) perylene was prepared in a similar manner to Dye 2. In a typical reaction 1.43 (1 mmol) grams of is tetra(4-dodecyl phenoxy) perylene 1 g (4 mmol) of 2,3 phenazine diamine and 0.18 grams of zinc acetate in was reacted with 0.8415 grams of dry quinoline or phenol to afford the target compound. MS (MALDI) calc. for 1782.382 g/mol, found 1782.192 g/mol UV/vis max in CHCl₃ 663 nm Fluorescence max in CHCl₃: 707 nm.

Scheme 4 only shows the anti-isomer for the formation of Dye 6.

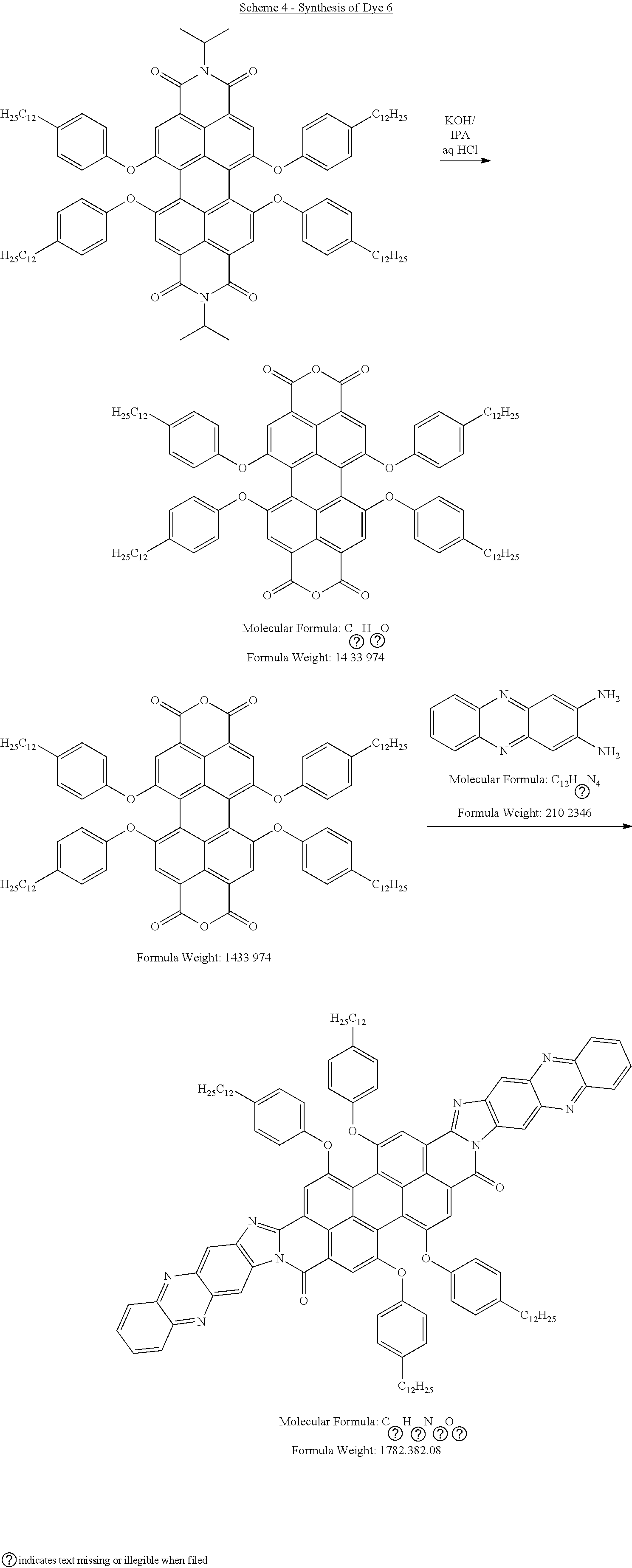

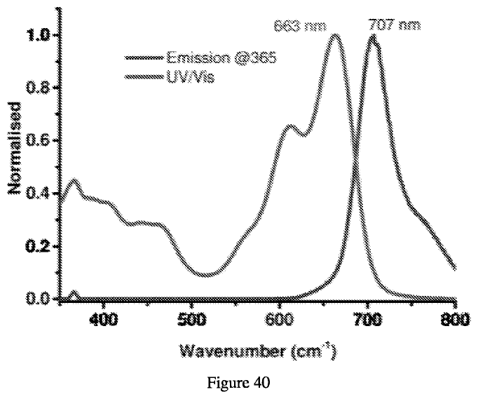

The spectroscopic analysis of Dye 6 is shown in FIG. 40.

The steps, features, integers, compositions and/or compounds disclosed herein or indicated in the specification of this application individually or collectively, and any and all combinations of two or more of said steps or features.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An article capable of targeting at least one phytochrome in a plant, the article comprising at least one dye of Formula (I): 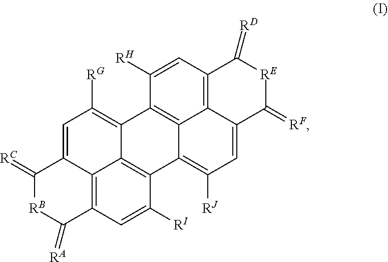
or a salt thereof, wherein:
either:
(i) R^{A} is O, R^{B} is N, R^{C} is N, and R^{B} and R^{C} are joined by a 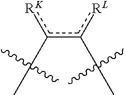
group to form a substituted imidazole group; or
(ii) R^{C} is O, R^{A} is N, R^{B} is N, and R^{A} and R^{B} are joined by a 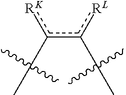
group to form a substituted imidazole group;
either:
(i) R^{D} is O, R^{E} is N, R^{F} is N, and R^{E} and R^{F} are joined by a 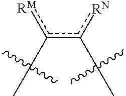
group to form a substituted imidazole group; or
(ii) R^{F} is O, R^{E} is N, R^{D} is N, and R^{D} and R^{E} are joined by a 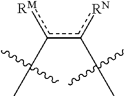
group to form a substituted imidazole group;
R^{K} and R^{L}:
(i) are joined to form an optionally substituted monocyclic aromatic ring; or
(ii) are joined to form an optionally substituted polycyclic aromatic group;
R^{M} and R^{N}:
(i) are joined to form an optionally substituted monocyclic aromatic ring; or
(ii) are joined to form an optionally substituted polycyclic aromatic group;
at least one of R^{G}, R^{H}, R^{I} and R^{J} is 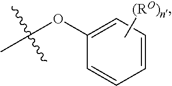
bromine, or chlorine, with the other substituents being hydrogen;
each R^{O} is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.

2. The article according to claim 1, wherein the article comprises at least one dye of Formula (II): 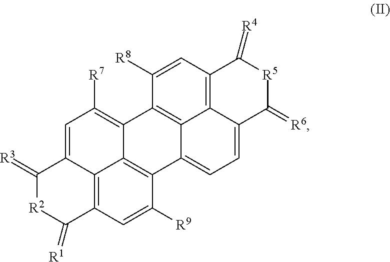
or a salt thereof, wherein:
either:
(i) R¹ is O, R² is N, R³ is N, and R² and R³ are joined by a 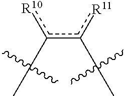
group to form a substituted imidazole group; or
(ii) R³ is O, R² is N, R¹ is N, and R¹ and R² are joined by a 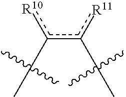
group to form a substituted imidazole group;
either:
(i) R⁴ is O, R⁵ is N, R⁶ is N, and R⁵ and R⁶ are joined by a 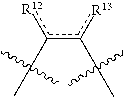
group to form a substituted imidazole group; or
(ii) R⁶ is O, R⁴ is N, R⁴ is N, and R⁴ and R⁵ are joined by a 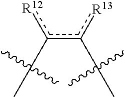
group to form a substituted imidazole group;
R¹⁰ and R¹¹:
(i) are joined to form an optionally substituted monocyclic aromatic ring; or
(ii) are joined to form an optionally substituted polycyclic aromatic group;
R¹² and R¹³:
(i) are joined to form an optionally substituted monocyclic aromatic ring; or
(ii) are joined to form an optionally substituted polycyclic aromatic group;
R⁹ is: 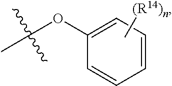
chlorine or bromine, with the proviso that one of R⁷ or R⁸ is 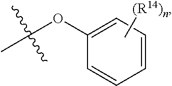
chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

3. The article according to claim 1, wherein the article comprises;
at least one dye, wherein the at least one dye emits light at a wave length:
in a range of 640 nm to 680 nm; or
in a range of 710 nm to 750 nm, or
at least one dye that absorbs light:
in a range of about 250 nm to about 600 nm: or
in a range of about 250 nm to about 730 nm.

4. (canceled)

5. The article according to claim 1, wherein the article stimulates at least one of:
P660; and
P730,
in a plant.

6. The article according to claim 1, wherein the article is in the form of a film, fabric or a sheet.

7. The article according to claim 1, wherein at least two dyes are present.

8. The article according to claim 1, wherein the article comprises a resin, optionally a transparent resin.

9. (canceled)

10. The article according to claim 1, wherein the article is composed of or comprises materials selected from the group consisting of: polycarbonate, polymethylmethacrylate, polypropylene, polyethylene, polyamide, polyacrylamide, polyvinylchloride or copolymers or any combinations thereof.

11. An array for enhancing plant growth, the array comprising one or more articles according to claim 1.

12. The array according to claim 11, wherein the one or more articles are in the form of strips.

13. A device comprising one or more articles according to claim 1, for delivering filtered light in a predetermined direction, the device further comprising:
(a) a body comprising a sheet and a set of light directors coupled to the sheet, wherein each light director extends away from the sheet, wherein:
(i) the body is transparent to transmit light there through and configured to filter a predetermined range of frequencies from the transmitted light;
(ii) the set of light directors is configured to receive light and deliver a majority of the filtered light from the received light in the predetermined direction;
(iii) the predetermined direction is normal to a side of the sheet; and
(b) at least one dye which targets at least one phytochrome in a plant, wherein at least one dye is a compound of Formula (I): 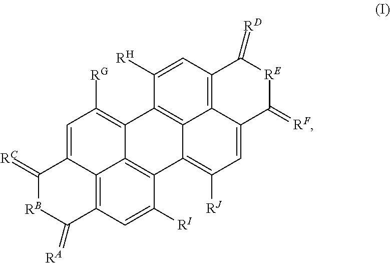
or a salt thereof, wherein:
either:
(i) R^{A} is O, R^{B} is N, R^{C} is N, and R^{B} and R^{C} are joined by a 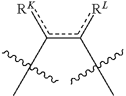
group to form a substituted imidazole group; or
(ii) R^{C} is O, R^{A} is N, R^{B} is N, and R^{A} and R^{B} are joined by a 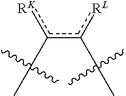
group to form a substituted imidazole group;
either:
(i) R^{D} is O, R^{E} is N, R^{F} is N, and R^{E} and R^{F} are joined by a 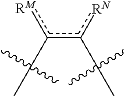
group to form a substituted imidazole group; or
(ii) R^{F} is O, R^{E} is N, R^{D} is N, and R^{D} and R^{E} are joined by a 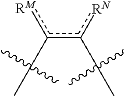
group to form a substituted imidazole group;
R^{K} and R^{L}:
(i) are joined to form an optionally substituted monocyclic aromatic ring; or
(ii) are joined to form an optionally substituted polycyclic aromatic group;
R^{M} and R^{N}:
(i) are joined to form an optionally substituted monocyclic aromatic ring; or
(ii) are joined to form an optionally substituted polycyclic aromatic group;
at least one of R^{G}, R^{H}, R^{I} and R^{J} is 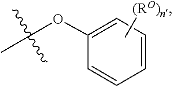
bromine, or chlorine, with the other substituents being hydrogen;
each R^{O} is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n′ is an integer selected from 0, 1, 2, 3, 4 or 5.

14. The device of claim 13, wherein at least one dye is a compound of Formula (II): 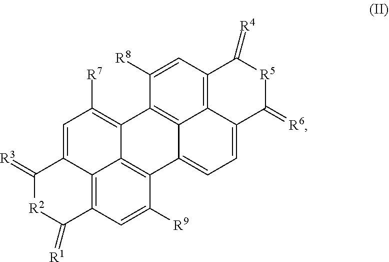
or a salt thereof, wherein:
either:
(i) R¹ is O, R² is N, R³ is N, and R² and R³ are joined by a 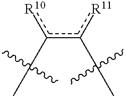
group to form a substituted imidazole group; or
(ii) R³ is O, R² is N, R¹ is N, and R¹ and R² are joined by a 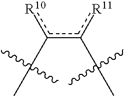
group to form a substituted imidazole group;
either:
(i) R⁴ is O, R⁵ is N, R⁶ is N, and R⁵ and R⁶ are joined by a 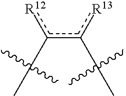
group to form a substituted imidazole group; or
(ii) R⁶ is O, R⁵ is N, R⁴ is N, and R⁴ and R⁵ are joined by a 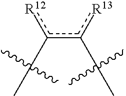
group to form a substituted imidazole group;
R¹⁰ and R¹¹:
(i) are joined to form an optionally substituted monocyclic aromatic ring; or
(ii) are joined to form an optionally substituted polycyclic aromatic group;
R¹² and R¹³:
(i) are joined to form an optionally substituted monocyclic aromatic ring; or
(ii) are joined to form an optionally substituted polycyclic aromatic group;
R⁹ is: 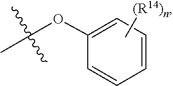
chlorine or bromine, with the proviso that one of R⁷ or R⁸ is 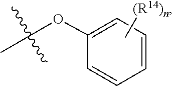
chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

15-18. (canceled)

19. The device according to claim 13, wherein: the device meets at least one of the following conditions
each light director and the sheet are integrally formed from a flat sheet;
the sheet is convex towards the predetermined direction;
the mean thickness of each light director is smaller than the thickness of the sheet;
the thickness of each light director decreases in the predetermined direction to progressively increase angles of incidence within the light director in the predetermined direction;
the set of light directors further comprising a plurality of frustoconical protrusions;
each of the set of light directors are identically shaped;
the set of light directors are arranged in rows and/or columns;
at least one light director comprises an opening at a distal end of the light director; and/or
the set of light directors are arranged in a periodic pattern along at least a portion of a length of the device.

20-28. (canceled)

29. A greenhouse comprising one or more of the articles according to claim 1.

30. (canceled)

31. A method for enhancing plant growth, the method comprising a step of exposing one or more plants to light emitted from an article according to claim 1.

32-33. (canceled)

34. The method according to claim 31, wherein the article comprises at least one dye of Formula (II): 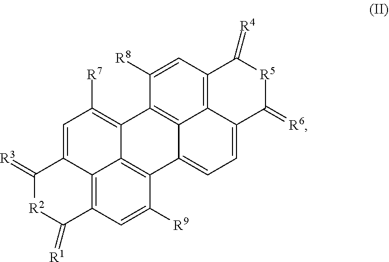
or a salt thereof, wherein:
either:
(i) R¹ is O, R² is N, R³ is N, and R² and R³ are joined by a 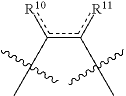
group to form a substituted imidazole group; or
(ii) R³ is O, R² is N, R¹ is N, and R¹ and R² are joined by a 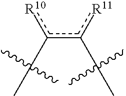
group to form a substituted imidazole group;
either:
(i) R⁴ is O, R⁵ is N, R⁶ is N, and R⁵ and R⁶ are joined by a 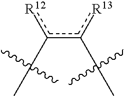
group to form a substituted imidazole group; or
(ii) R⁶ is O, R⁵ is N, R⁴ is N, and R⁴ and R⁵ are joined by a 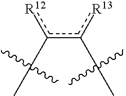
group to form a substituted imidazole group;
R¹⁰ and R¹¹:
(i) are joined to form an optionally substituted monocyclic aromatic ring; or
(ii) are joined to form an optionally substituted polycyclic aromatic group;
R¹² and R¹³:
(i) are joined to form an optionally substituted monocyclic aromatic ring; or
(ii) are joined to form an optionally substituted polycyclic aromatic group;
R⁹ is: 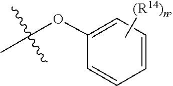
chlorine or bromine, with the proviso that one of R⁷ or R⁸ is 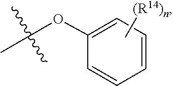
chlorine or bromine and the other is hydrogen;
each R¹⁴ is independently selected from: alkyl, alkenyl, alkynyl, halogen, nitro, cyano, hydroxy, sulfonic, thiol, ether, amino, alkylamino, dialkylamino, haloalkyl, hydroxyalkyl, alkoxy, haloalkoxy, aryloxy, heteroaryloxy, aralkyloxy, alkylthio, carboxamido, sulfonamido, alkylcarbonyl, arylcarbonyl, alkylsulfonyl, arylsulfonyl, carboxy, carboxyalkyl, cycloalkyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (cycloalkylamino)alkyl, (C₁-C₄ haloalkoxy)alkyl, (heteroaryl)alkyl, or perylene, each of which optionally comprises one or more substituents; and
n is an integer selected from 0, 1, 2, 3, 4 or 5.

35. The method according to claim 31, wherein:
the article comprises:
at least one dye, wherein the at least one dye emits light at a wave length: in a range of 640 nm to 680 nm; or in a range of 710 nm to 750 nm; or
at least one dye that absorbs light: in a range of about 250 nm to about 600 nm; or in a range of about 250 nm to about 730 nm; or
the article stimulates at least one of:
P660; and
P730,
in a plant.

36. The method according to claim 31, wherein the article is in the form of a film, fabric or a sheet.

37. The method according to claim 31, wherein at least two dyes are present.

38. The method according to claim 31, wherein the article comprises a resin, optionally a transparent resin.
